(19) United States
(12) Patent Application Publication
(10) Pub. No.: US 2019/0097241 A1
(43) Pub. Date: Mar. 28, 2019

(54) ELECTRODE ASSEMBLIES, MEMBRANE-ELECTRODE ASSEMBLIES AND ELECTROCHEMICAL CELLS AND LIQUID FLOW BATTERIES THEREFROM

(71) Applicant: 3M INNOVATIVE PROPERTIES COMPANY, St. Paul, MN (US)

(72) Inventors: Brian T. Weber, Maplewood, MN (US); Brandon A. Bartling, Woodbury, MN (US); Onur S. Yordem, St. Paul, MN (US); Raymond P. Johnston, Lake Elmo, MN (US); Andrew T. Haug, Woodbury, MN (US); John E. Abulu, Woodbury, MN (US); Gregory M. Haugen, Edina, MN (US); Kazuki Noda, Tokyo (JP); Shunsuke Suzuki, Tokyo (JP); Jimmy M. Le, St. Paul, MN (US); Blake R. Griffith, St. Paul, MN (US); Daniel E. Johnson, Marine On St. Croix, MN (US); Bharat R. Acharya, Woodbury, MN (US); Bradley W. Eaton, Woodbury, MN (US); Michael D. Romano, Circle Pines, MN (US); Daniel M. Pierpont, St. Paul, MN (US); David J. Miller, Menomonie, MN (US); Eric J. Iverson, Eau Claire, WI (US)

(21) Appl. No.: 16/085,712

(22) PCT Filed: Mar. 15, 2017
(86) PCT No.: PCT/US2017/022492

§ 371 Date: Sep. 17, 2018

Related U.S. Application Data
(60) Provisional application No. 62/309,721, filed on Mar. 17, 2016.
(60) Provisional application No. 62/373,628, filed on Aug. 11, 2016.

(51) Int. Cl. H01M 4/86; H01M 4/88; H01M 8/1004; H01M 8/18

(52) U.S. Cl. CPC H01M 4/8626; H01M 4/8657; H01M 8/188; H01M 8/1004; H01M 4/88

(57) ABSTRACT

The present disclosure relates to electrode assemblies, membrane-electrode assemblies and electrochemical cells and liquid flow batteries produced therefrom. The electrode and membrane-electrode assemblies include (i) a porous electrode having a first major surface with a first surface area, Ae, an opposed second major surface and a plurality of voids; (ii) a discontinuous transport protection layer, comprising polymer, disposed on the first major surface and having a cross-sectional area, Ap, substantially parallel to the first major surface; and (iii) an interfacial region wherein the interfacial region includes a portion of the polymer embedded in at least a portion of the plurality of voids, a portion of the porous electrode embedded in a portion of the polymer or a combination thereof; and wherein 0.02Ae≤Ap≤0.85Ae and the porous electrode and discontinuous transport protection layer form an integral structure. The disclosure further provides methods of making the electrode assemblies and membrane-electrode assemblies.

### FIELD

The present invention generally relates to assemblies useful in the fabrication of electrochemical cells and batteries. In particular, the present invention relates to electrode assemblies and membrane-electrode assemblies and electrochemical cells and liquid flow batteries produced therefrom. The disclosure further provides methods of making the electrode assemblies and membrane-electrode assemblies.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one embodiment, the present disclosure provides an electrode assembly including: a porous electrode having a first major surface with a first surface area, Ae, an opposed second major surface and a plurality of voids; a discontinuous transport protection layer, comprising polymer, disposed on the first major surface and having a cross-sectional area, Ap, substantially parallel to the first major surface; and an interfacial region wherein the interfacial region includes a portion of the polymer embedded in at least a portion of the plurality of voids, a portion of the porous electrode embedded in a portion of the polymer or a combination thereof; and wherein 0.02Ae≤Ap≤0.85Ae and the porous electrode and discontinuous transport protection layer form an integral structure.

In another embodiment, the present disclosure provides a method of making an electrode assembly including: providing a porous electrode having a first major surface with a first surface area, Ae, an opposed second major surface and a plurality of voids; disposing on the first major surface a discontinuous transport protection layer comprising polymer and having a cross-sectional area, Ap, substantially parallel to the first major surface; forming an interfacial region wherein a portion of the of the discontinuous transport protection layer is embedded in at least a portion of the plurality of voids, a portion of the porous electrode is embedded in a portion of the polymer or a combination thereof; and wherein 0.02Ae≤Ap≤0.85Ae and the porous electrode and polymer layer form an integral structure.

In yet another embodiment, the present disclosure provides a membrane-electrode assembly including: a first electrode assembly according to any one of the electrode assemblies of the present disclosure and an ion permeable membrane disposed adjacent to or on the major surface of the discontinuous transport protection layer opposite the interfacial region; and wherein the first electrode assembly and ion permeable membrane form an integral structure. In some embodiments, the membrane-electrode assembly may further include at least one adhesive layer and/or at least one gasket.

In another embodiment, the present disclosure provides an electrochemical cell including an electrode assembly according to any one of the electrode assemblies of the present disclosure.

In another embodiment, the present disclosure provides an electrochemical cell including a membrane-electrode assembly according to any one of the membrane-electrode assemblies of the present disclosure.

In another embodiment, the present disclosure provides liquid flow battery including an electrode assembly according to any one of electrode assemblies of the present disclosure. In another embodiment, the present disclosure provides liquid flow battery including a membrane-electrode assembly according to any one of the membrane-electrode assemblies of the present disclosure.

### BRIEF DESCRIPTION OF THE DRAWINGS

FIG. 1A is a schematic top view of an exemplary electrode assembly according to one exemplary embodiment of the present disclosure.

FIG. 1B is a schematic cross-sectional side view of the exemplary electrode assembly of FIG. 1A according to one exemplary embodiment of the present disclosure.

FIG. 1C is a schematic top view of an exemplary electrode assembly according to one exemplary embodiment of the present disclosure.

FIG. 1D is a schematic cross-sectional side view of the exemplary electrode assembly of FIG. 1C according to one exemplary embodiment of the present disclosure.

FIG. 1E is a schematic top view of an exemplary electrode assembly according to one exemplary embodiment of the present disclosure.

FIG. 1F is a schematic cross-sectional side view of the exemplary electrode assembly of FIG. 1E according to one exemplary embodiment of the present disclosure.

FIG. 1G is a schematic top view of an exemplary electrode assembly according to one exemplary embodiment of the present disclosure.

FIG. 1H is a schematic cross-sectional side view of the exemplary electrode assembly of FIG. 1G according to one exemplary embodiment of the present disclosure.

FIG. 1I is a schematic top view of an exemplary electrode assembly according to one exemplary embodiment of the present disclosure.

FIG. 1J is a schematic cross-sectional side view of the exemplary electrode assembly of FIG. 1I according to one exemplary embodiment of the present disclosure.

FIG. 1K is a schematic top view of an exemplary electrode assembly according to one exemplary embodiment of the present disclosure.

FIG. 1L is a schematic cross-sectional side view of the exemplary electrode assembly of FIG. 1K according to one exemplary embodiment of the present disclosure.

FIG. 1M is a schematic top view of an exemplary electrode assembly according to one exemplary embodiment of the present disclosure.

FIG. 1N is a schematic cross-sectional side view of the exemplary electrode assembly of FIG. 1M according to one exemplary embodiment of the present disclosure.

FIG. 2A is a schematic cross-sectional side view of an exemplary membrane electrode assembly according to one exemplary embodiment of the present disclosure.

FIG. 2B is a schematic cross-sectional side view of an exemplary membrane-electrode assembly according to one exemplary embodiment of the present disclosure.

FIG. 3 is a schematic cross-sectional side view of an exemplary electrochemical cell according to one exemplary embodiment of the present disclosure.

FIG. 4 is a schematic cross-sectional side view of an exemplary electrochemical cell stack according to one exemplary embodiment of the present disclosure.

FIG. 5 is a schematic view of an exemplary single cell, liquid flow battery according to one exemplary embodiment of the present disclosure.

FIG. 6 is an SEM image of a cross-sectional of an exemplary electrode assembly according to one exemplary embodiment of the present disclosure.

FIG. 7 is an SEM image of a cross-sectional of an exemplary electrode assembly according to one exemplary embodiment of the present disclosure.

FIG. 8 is an SEM image of a cross-sectional of an exemplary electrode assembly according to one exemplary embodiment of the present disclosure.

FIG. 9 is an SEM image of a cross-sectional of an exemplary electrode assembly according to one exemplary embodiment of the present disclosure.

FIG. 10 is an SEM image of a cross-sectional of an exemplary electrode assembly according to one exemplary embodiment of the present disclosure.

FIG. 11 is an SEM image of a cross-sectional of an exemplary electrode assembly according to one exemplary embodiment of the present disclosure.

FIG. 12A is a schematic cross-sectional side view, through line 12A of FIG. 12B, of an exemplary membrane-electrode assembly according to one exemplary embodiment of the present disclosure.

FIG. 12B is a schematic top view in the plane of the adhesive layer, of the exemplary membrane-electrode assembly of FIG. 12A, according to one exemplary embodiment of the present disclosure.

FIG. 12C is a schematic cross-sectional side view of an exemplary membrane-electrode assembly according to one exemplary embodiment of the present disclosure.

FIG. 12D is a schematic cross-sectional side view of an exemplary membrane-electrode assembly according to one exemplary embodiment of the present disclosure.

FIG. 12E is a schematic cross-sectional side view of an exemplary membrane-electrode assembly according to one exemplary embodiment of the present disclosure.

FIG. 12F is a schematic cross-sectional side view of an exemplary membrane-electrode assembly according to one exemplary embodiment of the present disclosure.

FIG. 12G is a schematic cross-sectional side view of an exemplary membrane-electrode assembly according to one exemplary embodiment of the present disclosure.

FIG. 12H is a schematic cross-sectional side view of an exemplary membrane-electrode assembly according to one exemplary embodiment of the present disclosure.

FIG. 13A is a schematic cross-sectional side view, through line 13A of FIG. 13B, of an exemplary membrane-electrode assembly according to one exemplary embodiment of the present disclosure.

FIG. 13B is a schematic top view in the plane of the adhesive layer of the exemplary membrane-electrode assembly of FIG. 13A according to one exemplary embodiment of the present disclosure.

FIG. 13C is a schematic cross-sectional side view of an exemplary membrane-electrode assembly according to one exemplary embodiment of the present disclosure.

FIG. 13D is a schematic cross-sectional side view of an exemplary membrane-electrode assembly according to one exemplary embodiment of the present disclosure.

FIG. 13E is a schematic cross-sectional side view of an exemplary membrane-electrode assembly according to one exemplary embodiment of the present disclosure.

FIG. 13F is a schematic cross-sectional side view of an exemplary membrane-electrode assembly according to one exemplary embodiment of the present disclosure.

FIG. 13G is a schematic cross-sectional side view of an exemplary membrane-electrode assembly according to one exemplary embodiment of the present disclosure.

FIG. 13H is a schematic cross-sectional side view of an exemplary membrane-electrode assembly according to one exemplary embodiment of the present disclosure.

FIG. 14A is a schematic cross-sectional side view, through line 14A of FIG. 14B, of an exemplary membrane-electrode assembly according to one exemplary embodiment of the present disclosure.

FIG. 14B is a schematic top view in the plane of the adhesive layer of the exemplary membrane-electrode assembly of FIG. 14A according to one exemplary embodiment of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure, when a surface of one substrate is in “contact” with the surface of another substrate, there are no intervening layer(s) between the two substrates and at least a portion of the surfaces of the two substrates are in physical contact.

Throughout this disclosure, if a substrate or a surface of a substrate is “adjacent” to a second substrate or a surface of a second substrate, the two nearest surfaces of the two substrates are considered to be facing one another. They may be in contact with one another or they may not be in contact with one another, an intervening third layer(s) or substrate(s) being disposed between them.

Throughout this disclosure the phrase “non-conductive” refers to a material or substrate that is non-electrically conductive, unless otherwise stated. In some embodiments, a material or substrate is non-electrically conductive if it has an electrical resistivity of greater than about 1000 ohm-m

Throughout this disclosure, an aqueous based solution is defined as a solution wherein the solvent includes at least 50% water by weight. A non-aqueous based solution is defined as a solution wherein the solvent contains less than 50% water by weight.

Throughout this disclosure, unless indicated otherwise, the word “fiber” is meant to include both the singular and plural forms.

Throughout this disclosure fluid communication between a first surface and a second surface of a substrate means that a fluid, e.g. gas and/or liquid, is capable of flowing from a first surface of the substrate, through the thickness of a substrate, to a second surface of the substrate. This inherently implies that there is a continuous void region extending from the first surface of the substrate, through the thickness of the substrate, to a second surface of the substrate.

Softening Temperature is the glass transition temperature and/or the melting temperature of a polymer.

Volume Porosity: the volume of the open region of the discontinuous transport protection layer divided by the total volume, i.e. bulk volume, of the discontinuous transport protection layer.

Open Area Porosity: with respect to a major surface of a woven, non-woven or mesh structure, the ratio of the total area of the open regions at the major surface to the total surface area of the major surface, i.e. the projected surface.

In some embodiments, an integral structure includes a structure that can be held in any orientation in space and does not separate into at least two components, due to the force of gravity.

### DETAILED DESCRIPTION

A single electrochemical cell, which may be used in the fabrication of a liquid flow battery (e.g. a redox flow battery), generally, includes two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The ion permeable membrane along with at least one of the anode and cathode will be referred to herein as a membrane-electrode assembly (MEA). In a redox flow battery containing a single electrochemical cell, for example, the cell would also include two current collectors, one adjacent to and in contact with the exterior surface of the anode flow plate and one adjacent to and in contact with the exterior surface of the cathode flow plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolylte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size and number of membrane-electrode assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (e.g. anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the ion permeable membrane. Thus, the material making up the ion permeable membrane may be an expensive specialty polymer. As hundreds of MEAs may be required per cell stack and battery, the ion permeable membrane may be a significant cost factor with respect to the overall cost of the MEA and the overall cost of a cell and battery. As it is desirable to minimize the cost of the MEAs, one approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff materials, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved membrane-electrode assemblies that can prevent this localized shorting while maintaining the required ion transport through the membrane without inhibiting the required oxidation/reduction reaction of the electrochemical cells and batteries fabricated therefrom.

The present disclosure provides electrode assemblies that include at least one discontinuous transport protection layer disposed on a major surface of the electrode. The discontinuous transport protection layer and electrode form an integral structure and will be referred to as an electrode assembly. The electrode assembly may be used in a membrane-electrode assembly, electrochemical cell and/or liquid flow battery. In use, the electrode assembly will be positioned such that the exterior surface of the discontinuous transport protection layer will be adjacent to the ion permeable membrane. The discontinuous transport protection layer protects the ion permeable membrane from puncture by the fibers of the electrode and thus prevents localized shorting that has been found to be an issue in other MEAs, electrochemical cell and liquid flow battery designs. The discontinuous transport protection layers of the present disclosure may also improve fluid flow within a membrane-electrode assembly and subsequently fluid flow within an electrochemical cell and/or battery. The term “transport” within the phrase “transport protection layer” refers to fluid transport within and/or through the protection layer. This may lead to improved, i.e. decreased, or at least not significantly altered cell resistance, contrary to what one might expect to occur with the inclusion of an additional layer within the membrane-electrode assembly and subsequently with the inclusion of an additional layer in an electrochemical cell and/or battery. The electrode assemblies with at least one discontinuous transport protection layer are useful in the fabrication of liquid flow, e.g. redox flow, electrochemical cells and batteries. Liquid flow electrochemical cells and batteries may include cells and batteries having a single half-cell being a liquid flow type or both half-cells being a liquid flow type. The discontinuous transport protection layer may be a component of a membrane-electrode assembly and/or an electrode assembly that is used to fabricate the MEAs. The present disclosure also includes liquid flow electrochemical cells and batteries containing electrode assemblies and/or MEAs that include at least one discontinuous transport protection layer. The present disclosure further provides methods of fabricating electrode assemblies and membrane-electrode assemblies useful in the fabrication of liquid flow electrochemical cells and batteries.

The present disclosure provides electrode assemblies comprising (i) a porous electrode having a first major surface with a first surface area, Ae, an opposed second major surface and a plurality of voids; (ii) a discontinuous transport protection layer, comprising polymer, disposed on the first major surface and having cross-sectional area, Ap, substantially parallel to the first major surface; and (iii) an interfacial region wherein the interfacial region includes a portion of the polymer embedded in at least a portion of the plurality of voids, a portion of the porous electrode embedded in a portion of the polymer or a combination thereof; and wherein 0.02Ae≤Ap≤0.85Ae and the porous electrode and discontinuous transport protection layer form an integral structure. In some embodiments, the plurality of voids of the porous electrode enable fluid communication between at least a portion of the first major surface and opposed second major surface of the porous electrode. The surface area of the porous electrode may be represented by the projected surface area. The interfacial region may have an area, AI, and AI may be the same as Ap or AI may be less than Ap. The porous electrodes of the present disclosure may include wherein 0.01Ae≤AI≤0.85Ae. The interfacial area AI may be equivalent to area Ap, if the surface of discontinuous transport protection layer disposed on the porous electrode all forms an interfacial region with the porous electrode. If only a portion of the major surface of discontinuous transport protection layer forms an interfacial region, then AI will be less than Ap, and AI will be the sum of the individual areas Ai of the portions of the discontinuous protection layer that have formed interfacial regions. The discontinuous transport protection layer has a major surface opposite the interfacial region.

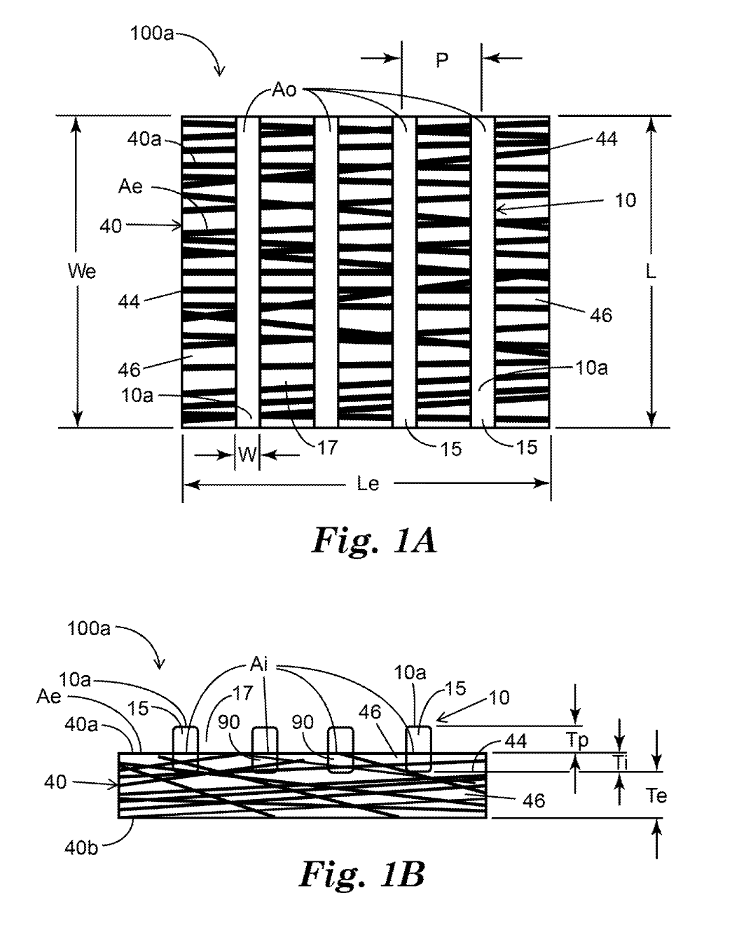

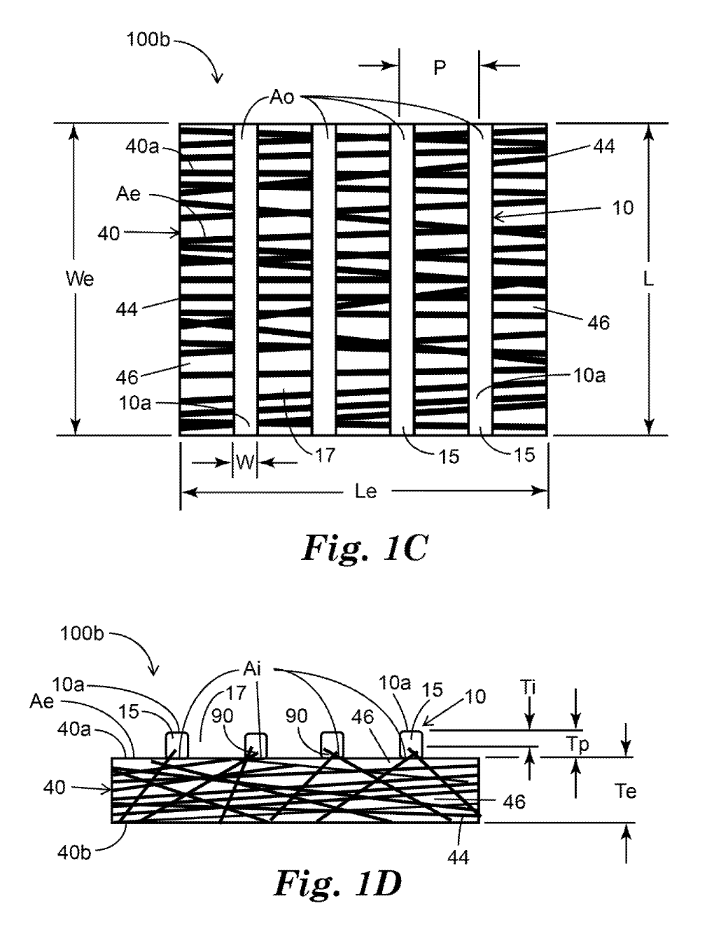

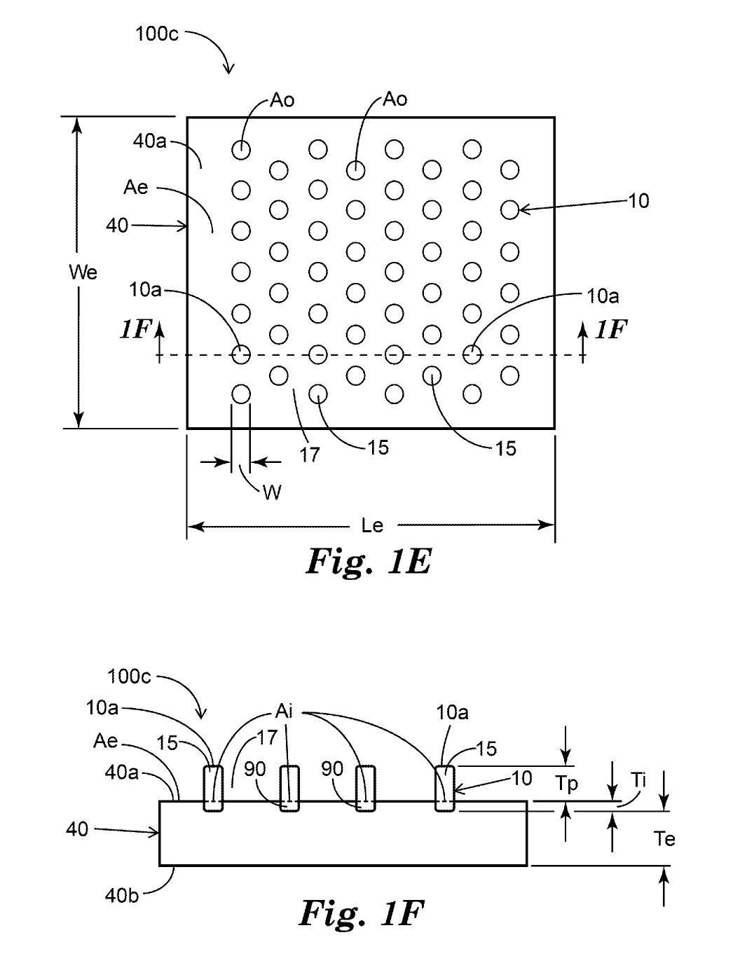

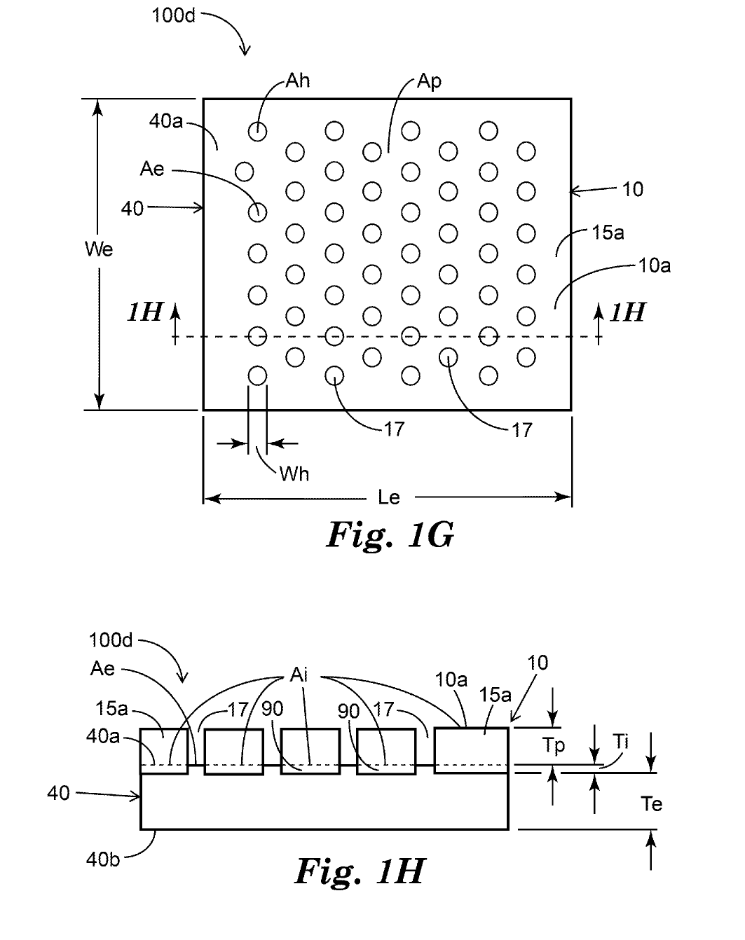

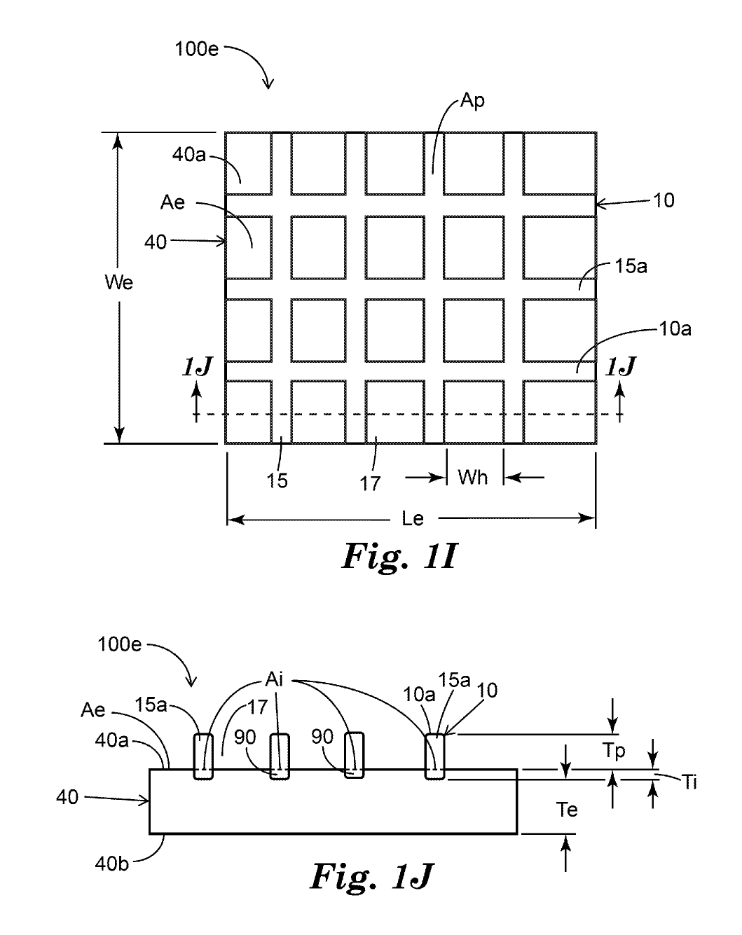

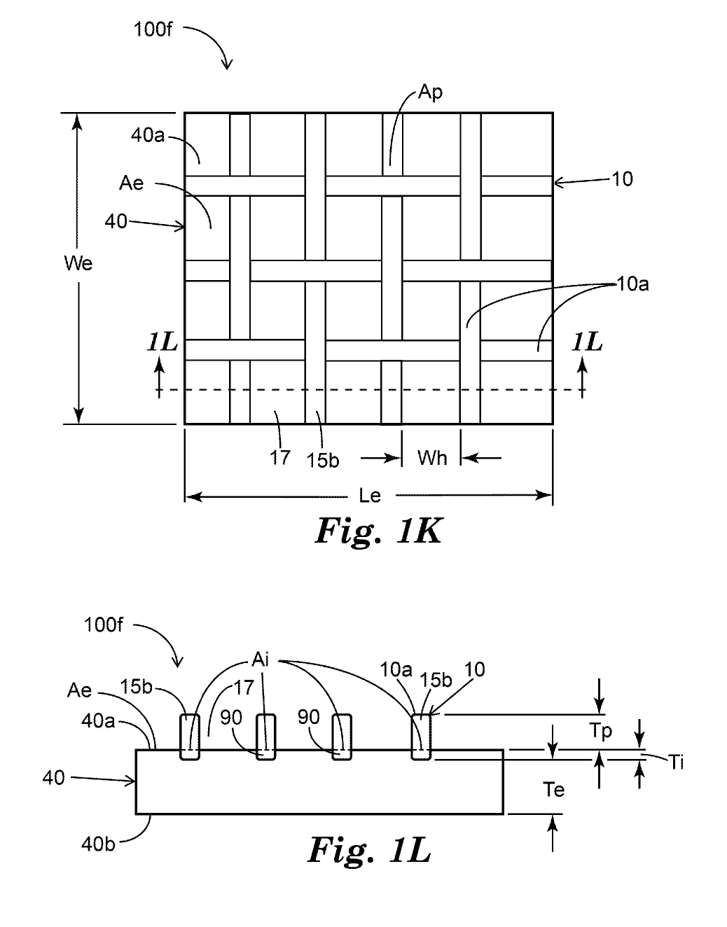

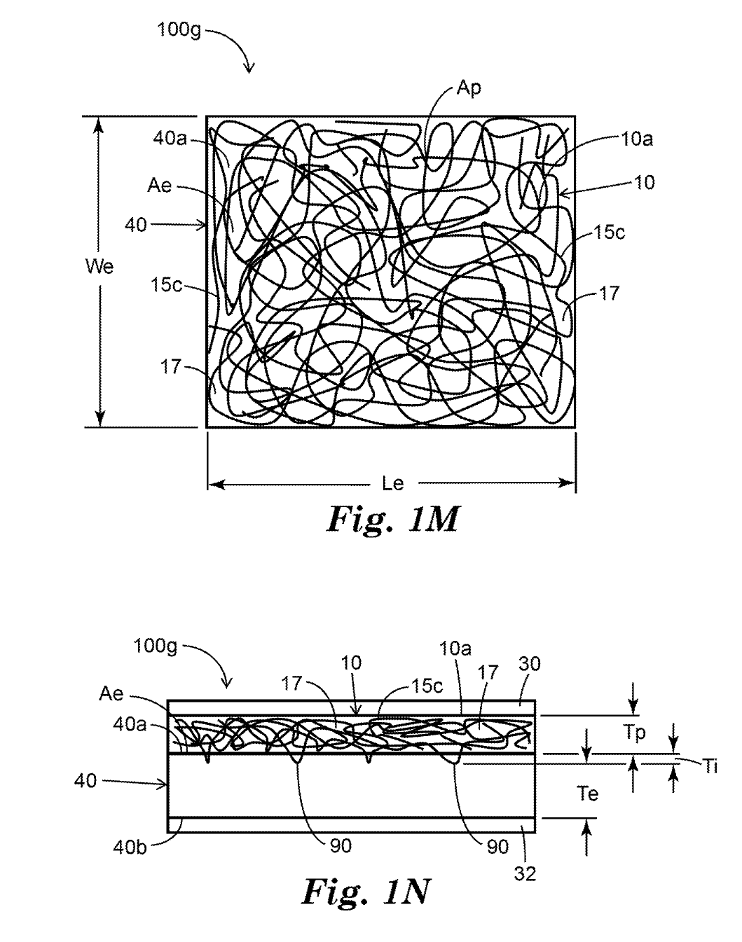

FIGS. 1A through 1N disclose various, non-limiting, embodiments of electrode assemblies of the present disclosure. FIG. 1A is a schematic top view and FIG. 1B is the corresponding schematic cross-sectional side view of an exemplary electrode assembly according to one embodiment of the present disclosure. Electrode assembly 100a includes a porous electrode 40 having a first major surface 40a with a first surface area, Ae, an opposed second major surface 40b and a plurality of voids 46. In this exemplary embodiment, the porous electrode 40 includes fibers 44, e.g. carbon fibers, and plurality of voids 46, i.e. the void regions between the fibers. The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having cross-sectional area, Ap, substantially parallel to the first major surface and a thickness Tp. Discontinuous transport protection layer 10 is disposed on the first major surface 40a of porous electrode 40. In this exemplary embodiment, discontinuous transport protection layer 10 includes a plurality of discrete structures 15 (e.g. discrete non-intersecting continuous lines, having a center-to-center distance between adjacent lines, i.e. a pitch, of P), having a width, W, and a length, L, separated by open regions 17. Each individual discrete structure has a cross-sectional area, Ao (equivalent to W×L in this exemplary embodiment), substantially parallel to the first major surface. Ao may also correspond to the projection of the discrete structure onto first major surface 40a of porous electrode 40. Cross-sectional area, Ap, of discontinuous transport protection layer 10 may be determined from the sum of the cross-sectional areas, Ao, of discrete structures 15. For any of the discontinuous transport protection layers of the present disclosure, if the cross-sectional area of their structure, e.g. discrete structures, varies through its thickness, then area Ap may be based on (i) the area at the intersection of the structure(s) of the discontinuous transport protection layer with the first major surface of the porous electrode or (ii) the largest cross-sectional area of the structure(s) in a plane substantially parallel to the first major surface of the porous electrode, e.g. largest cross-sectional area of each individual discrete structure. The determination of Ap may exclude the interfacial region. The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100a includes interfacial region 90. Interfacial region 90 includes a portion of the polymer of discontinuous transport protection layer 10 embedded in at least a portion of the plurality of voids 46 of porous electrode 40. Interfacial region 90 has a thickness, Ti. In some embodiments, in the interfacial region, a portion of the material comprising porous electrode 40, e.g. a portion of fiber 44, may be encapsulated by polymer of the discontinuous transport protection layer. Interfacial region 90 may have an area, AI, at the intersection with the first major surface 40a, which may be the sum of the interfacial region surface areas, Ai, associated with each discrete structure, e.g. discrete line. Discontinuous transport protection layer 10 has a major surface 10a opposite the interfacial region 90.

FIG. 1C is a schematic top view and FIG. 1D is the corresponding schematic cross-sectional side view of an exemplary electrode assembly according to one embodiment of the present disclosure. FIGS. 1C and 1D are identical to FIGS. 1A and 1B, respectively, except for the interfacial region. In FIGS. 1C and 1D, the interfacial region 90 of electrode assembly 100b includes a portion of porous electrode 40 embedded in a portion of the polymer of discontinuous transport protection layer 10, e.g. a portion of fibers 44 of porous electrode 40 embedded in a portion of the polymer of discontinuous transport protection layer 10 (FIG. 1D). In this exemplary embodiment, the thickness of the discontinuous transport protection layer, Tp includes the thickness of the interfacial region, Ti, as Tp is, generally, the height of the discontinuous transport protection layer above the first major surface of the porous electrode. Discontinuous transport protection layer 10 has a major surface 10a opposite the interfacial region 90.

FIGS. 1E through 1N disclose additional exemplary electrode assembly embodiments of the present disclosure. For simplification purposes in these figures, porous electrode 40 will be depicted as a block diagram, the fibers 44 of previous figures being removed.

FIG. 1E is a schematic top view and FIG. 1F is the corresponding schematic cross-sectional side view, through line 1F of FIG. 1E, of an exemplary electrode assembly according to one embodiment of the present disclosure. Electrode assembly 100c includes a porous electrode 40 having a first major surface 40a with a first surface area, Ae, an opposed second major surface 40b and a plurality of voids (not shown). The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having a cross-sectional area, Ap, substantially parallel to the first major surface, and a thickness Tp. Discontinuous transport protection layer 10 is disposed on the first major surface 40a of porous electrode 40. In this exemplary embodiment, discontinuous transport protection layer 10 includes a plurality of discrete structures 15 (cylinders with the axis of the cylinder substantially normal to first major surface 40a), having a width, W (e.g. diameter), and a thickness, Tp, separated by open regions 17. Each individual discrete structure has a cross-sectional area Ao, (equivalent to π[W/2]², in this exemplary embodiment) substantially parallel to the first major surface. Ao may correspond to the projection of the discrete structure onto first major surface 40a of porous electrode 40. Cross-sectional area, Ap, may be determined from the sum of the cross-sectional areas, Ao, of discrete structures 15. The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100c includes interfacial region 90. Interfacial region 90 has a thickness, Ti. Interfacial regions 90 includes a portion of the polymer of discontinuous transport protection layer 10 embedded in at least a portion of the plurality of voids of porous electrode 40. In some embodiments, in the interfacial region, a portion of the material comprising porous electrode 40 may be encapsulated by polymer of the discontinuous transport protection layer. Interfacial region 90 may have an area, AI, at the intersection with the first major surface 40a, which may be the sum of the interfacial region areas, Ai, associated with each discrete structure, e.g. cylinder. Discontinuous transport protection layer 10 has a major surface 10a opposite the interfacial region 90.

FIG. 1G is a schematic top view and FIG. 1H is the corresponding schematic cross-sectional side view, through line 1H of FIG. 1G, of an exemplary electrode assembly according to one embodiment of the present disclosure. Electrode assembly 100d includes a porous electrode 40 having a first major surface 40a with a first surface area, Ae, an opposed second major surface 40b and a plurality of voids (not shown). The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having an area Ap, substantially parallel to the first major surface, and a thickness Tp. Discontinuous transport protection layer 10 is disposed on the first major surface. In this exemplary embodiment, discontinuous transport protection layer 10 is a mesh structure 15a that includes open regions 17 (a plurality of through holes, circular shaped cylinders with the axis of the cylinders substantially normal to first major surface 40a, the cylinders being in a hexagonal array pattern), having a width, Wh (e.g. diameter), a thickness, Tp, and an area Ah (equivalent to π[Wh/2]²). The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100d includes interfacial regions 90. Interfacial regions 90 have a thickness, Ti, and open regions 17 (through-holes) of the discontinuous transport protection layer extend through interfacial region 90. Interfacial regions 90 includes a portion of the polymer of discontinuous transport protection layer 10 embedded in at least a portion of the plurality of voids of porous electrode 40. In some embodiments, in the interfacial region, a portion of the material comprising porous electrode 40 may be encapsulated by polymer of the discontinuous transport protection layer. Interfacial region 90 may have an area, AI, that may be equivalent to area Ap, if the major surface of discontinuous transport protection layer 10 adjacent to porous electrode 40 all forms an interfacial region with porous electrode 40. If only portions of the major surface of discontinuous transport protection layer 10 forms an interfacial region, then AI will be less than Ap, and AI will be the sum of the individual areas Ai of the portions of the transport protection layer that have formed interfacial regions. Discontinuous transport protection layer 10 has a major surface 10a opposite the interfacial region 90.

FIG. 1I is a schematic top view and FIG. 1J is the corresponding schematic cross-sectional side view, through line 1J of FIG. 1I, of an exemplary electrode assembly according to one embodiment of the present disclosure. Electrode assembly 100e includes a porous electrode 40 having a first major surface 40a with a first surface area, Ae, an opposed second major surface 40b and a plurality of voids (not shown). The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having a cross-sectional area, Ap, substantially parallel to the first major surface, and a thickness Tp. Discontinuous transport protection layer 10 is disposed on the first major surface 40a of porous electrode 40. In this exemplary embodiment, discontinuous transport protection layer 10 is a mesh structure 15a that includes a plurality of open regions 17 (e.g. a plurality of through-holes, square shaped cylinders with the axis of the cylinder substantially normal to first major surface 40a, the cylinders being in a square grid array pattern), having a width, Wh, and a thickness, Tp. The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100e includes interfacial regions 90. Interfacial regions 90 have a thickness, Ti, and the open regions 17 (through-holes) of the discontinuous transport protection layer extend through interfacial region 90. Interfacial regions 90 includes a portion of the polymer of discontinuous transport protection layer 10 embedded in at least a portion of the plurality of voids of porous electrode 40. In some embodiments, in the interfacial region, a portion of the material comprising porous electrode 40 may be encapsulated by polymer of the discontinuous transport protection layer. Interfacial region 90 may have an area, AI, that may be equivalent to area Ap, if the major surface of discontinuous transport protection layer 10 adjacent to porous electrode 40 all forms an interfacial region with porous electrode 40. If only portions of the major surface of discontinuous transport protection layer 10 forms an interfacial region, then AI will be less than Ap, and AI will be the sum of the individual areas Ai of the portions of the transport protection layer that have formed interfacial regions. Discontinuous transport protection layer 10 has a major surface 10a opposite the interfacial region 90.

FIG. 1K is a schematic top view and FIG. 1L is the corresponding schematic cross-sectional side view, through line 1L of FIG. 1K, of an exemplary electrode assembly according to one embodiment of the present disclosure. Electrode assembly 100f includes a porous electrode 40 having a first major surface 40a with a first surface area, Ae, an opposed second major surface 40b and a plurality of voids (not shown). The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having an area Ap, substantially parallel to the first major surface, and a thickness 2Tp. Discontinuous transport protection layer 10 is disposed on the first major surface 40a of porous electrode 40. In this exemplary embodiment, discontinuous transport protection layer 10 is a woven structure 15b that includes a plurality of open regions 17 (e.g. a plurality of through holes, square shaped cylinders with the axis of the cylinder substantially normal to first major surface 40a, the cylinders being in a square grid array pattern), having a width, Wh, and a thickness, 2Tp. Note that in this particular embodiments, the height of the open regions may be set equivalent to the sum of the thickness of the warp and weft fiber comprising woven structure 15b. In FIGS. 1K and 1L, it is assumed that the thickness of the warp and weft fibers are the same, but that is not a requirement. The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100f includes interfacial regions 90. Interfacial regions 90 have a thickness, Ti, and the open regions 17 (through-holes) of the discontinuous transport protection layer extend through interfacial region 90. Interfacial regions 90 includes a portion of the polymer of discontinuous transport protection layer 10 embedded in at least a portion of the plurality of voids of porous electrode 40. In some embodiments, in the interfacial region, a portion of the material comprising porous electrode 40 may be encapsulated by polymer of the discontinuous transport protection layer. Interfacial region 90 may have an area, AI, that may be equivalent to area Ap, if the major surface of discontinuous transport protection layer 10 adjacent to porous electrode 40 all forms an interfacial region with porous electrode 40. If only portions of the major surface of discontinuous transport protection layer 10 forms an interfacial region, then AI will be less than Ap, and AI will be the sum of the individual areas Ai of the portions of the transport protection layer that have formed interfacial regions. Discontinuous transport protection layer 10 has a major surface 10a opposite the interfacial region 90.

FIG. 1M is a schematic top view and FIG. 1N is the corresponding schematic cross-sectional side view of an exemplary electrode assembly according to one embodiment of the present disclosure. Electrode assembly 100g includes a porous electrode 40 having a first major surface 40a with a first surface area, Ae, an opposed second major surface 40b and a plurality of voids (not shown). The porous electrode has a length Le, a width We and a thickness Te. The first surface area, Ae, may be represented as the projected surface area of the porous electrode, i.e. Le×We. The electrode assembly further includes a discontinuous transport protection layer 10, comprising polymer and having an area Ap, substantially parallel to the first major surface, and a thickness Tp. Discontinuous transport protection layer 10 is disposed on the first major surface 40a of porous electrode 40. In this exemplary embodiment, discontinuous transport protection layer 10 is a nonwoven structure 15c that includes open regions 17. Due to its random structure, cross-sectional area, Ap, of a nonwoven is somewhat ambiguous to measure, subsequently, a calculated value may be used. An average value for the cross-sectional area, Ap, of a nonwoven may be calculated from the following equation:

Ap=Mp/(Dp×Tp)

where,

Mp is the mass of the polymer of the nonwoven (within the given area),

Dp is the density of the polymer used to form the nonwoven,

Tp is the thickness of the nonwoven (within the given area).

If the nonwoven includes multiple fiber types, the density Dp will be based on the average density of the fibers making up the nonwoven, adjusted for their mass fraction present in the nonwoven. Dp may also be measured using known techniques in the art. If the thickness, Tp, is not uniform, an average value for the thickness may be used.

The above equation may be generalized to calculate the average value of the cross-sectional area, Ap, of any discontinuous transport protection layer of the present disclosure with Mp being the mass of the polymer of the discontinuous transport protection layer, Dp being the density of the polymer of the discontinuous transport protection layer and Tp being the thickness of the discontinuous transport protection layer. Dp may be measured using known techniques in the art. If the thickness, Tp, is not uniform, an average value for the thickness may be used. In some embodiments, Ap may be the calculated average value for the cross-sectional area: Ap=Mp/(Dp×Tp), with the parameters as defined above.

The electrode assembly further includes an interfacial region wherein the interfacial region includes a portion of polymer embedded in at least a portion of the plurality of voids, a portion of the porous electrode embedded in a portion of the polymer or a combination thereof. In this exemplary embodiment, electrode assembly 100g includes interfacial regions 90. Interfacial regions 90 have a thickness, Ti. Interfacial regions 90 includes a portion of the polymer of discontinuous transport protection layer 10 embedded in at least a portion of the plurality of voids of porous electrode 40. In some embodiments, in the interfacial region, a portion of the material comprising porous electrode 40 may be surrounded by and/or in contact with polymer of the discontinuous transport protection layer. Interfacial region 90 may have a surface area, AI, that may be equivalent to area Ap, if the major surface of discontinuous transport protection layer 10 adjacent to porous electrode 40 all forms an interfacial region with porous electrode 40. If only portions of the major surface of discontinuous transport protection layer 10 forms an interfacial region, then AI will be less than Ap, and AI will be the sum of the individual areas Ai of the portions of the transport protection layer that have formed interfacial regions. Discontinuous transport protection layer 10 has a major surface 10a opposite the interfacial region 90.

As shown in FIG. 1N, electrode assembly 100g may further include one or more optional release liners 30, 32. The optional release liners 30 and 32 may remain with the electrode assembly until it is used to fabricate, for example, a membrane-electrode assembly, electrochemical cell or liquid flow battery, in order to protect the outer surfaces of the discontinuous transport protection layer and porous electrode from dust and debris. The release liners may also provide mechanical support and prevent tearing of the discontinuous transport protection layer and porous electrode and/or marring of their surfaces, prior to use. Conventional release liners known in the art may be used for optional release liners 30 and 32. Optional release liners 30 and 32 are not shown in FIG. 1M.

Any of the electrode assemblies of the present disclosure may include optional release liners, as described in FIG. 1N.

The electrode assemblies of the present disclosure include a discontinuous transport protection layer. By “discontinuous” it is meant that the transport protection layer includes at least one open region and/or a plurality of open regions which allow fluid communication between the first major surface and second major surface of the discontinuous transport protection layer. The discontinuous transport protection layer may include at least one of a plurality of discrete structures, e.g. discrete structures 15 of FIGS. 1A-1F, a mesh structure, e.g. mesh structure 15a of FIGS. 1G-1J, a woven structure, e.g. woven structure 15b of FIGS. 1K and 1L and a nonwoven structure, e.g. nonwoven structure 15c of FIGS. 1M and 1N. The discontinuous transport protection layer may include a combination of structures. The size and shape of the structures of the discontinuous transport protection layer are not particularly limited, except that the following relationship, with respect to the first surface area, Ae, of the porous electrode and cross-sectional area, Ap, of the discontinuous transport protection layer must be satisfied, 0.02Ae≤Ap≤0.85Ae. In some embodiments, the relationship between the first surface area, Ae, of the porous electrode and cross-sectional area, Ap, of the discontinuous transport protection layer may be 0.02Ae≤Ap≤0.85Ae, 0.02Ae≤Ap≤0.7Ae, 0.02Ae≤Ap≤0.6Ae, 0.02Ae≤Ap≤0.5Ae, 0.02Ae≤Ap≤0.3Ae, 0.05Ae≤Ap≤0.85Ae, 0.05Ae≤Ap≤0.7Ae, 0.05Ae≤Ap≤0.6Ae, 0.05Ae≤Ap≤0.5Ae, 0.05Ae≤Ap≤0.3Ae, 0.10Ae≤Ap≤0.85Ae, 0.10Ae≤Ap≤0.7Ae, 0.10Ae≤Ap≤0.6Ae, 0.10Ae≤Ap≤0.5Ae or even 0.10Ae≤Ap≤0.3Ae.

The discontinuous transport protection layer includes polymer. The polymer of the the discontinuous transport protection layer is not particularly limited. However, in order to ensure long term stability of the polymer in the anolyte and/or catholyte liquids it may be exposed to during use, the polymer of the discontinuous transport protection layer may be selected to have good chemical resistance to the anolyte and/or catholyte, including the associated solvent, oxidizing/reducing active species, salts and/or other additives included therein. In some embodiments, the polymer of the discontinuous transport protection layer may include at least one of a thermoplastic and thermoset. In some embodiments, the polymer of the discontinuous transport protection layer may include a thermoplastic. In some embodiments, the polymer of the discontinuous transport protection layer may include a thermoset. In some embodiments, the polymer of the discontinuous transport protection layer may consists essentially of a thermoplastic. In some embodiments, the polymer of the discontinuous transport protection layer may consists essentially of a thermoset. Thermoplastics may include thermoplastic elastomers. A thermoset may include a B-stage thermoset, e.g. a B-stage thermoset after final cure. In some embodiments, the polymer of the discontinuous transport protection layer may include at least one of a thermoplastic and a B-stage thermoset. In some embodiments, the polymer of the discontinuous transport protection layer may consist essentially of a B-stage thermoset, e.g. a B-stage thermoset after final cure. In some embodiments, polymer of the discontinuous transport protection layer includes, but is not limited to, at least one of epoxy resin, phenolic resin, ionic polymer, polyurethane, urea-formadehyde resin, melamine resin, polyesters, e.g. polyethylene terephthalate, polyamide, polyether, polycarbonate, polyimide, polysulphone, polyphenylene oxide, polyacrylates, polymethacylates, polyolefin, e.g. polyethylene and polypropylene, styrene and styrene based random and block copolymers, e.g. styrene-butadiene-styrene, polyvinyl chloride, and fluorinated polymer, e.g. polyvinylidene fluoride and polytetrafluoroethylene. In some embodiments, the polymer of the discontinuous transport protection layer may be at least one of polyurethane, polyester, polyamide, polyether, polycarbonate, polyimide, polysulphone, polyphenylene oxide, polyacrylate, polymethacylate, polyolefin, styrene and styrene based random and block copolymers, polyvinyl chloride, and fluorinated polymer. The polymer of the discontinuous transport protection layer may be a polymer blend or polymer composite. In some embodiments, the polymer blend and/or composite may include at least two polymers selected from the polymers of the present disclosure.

In some embodiments, the discontinuous transport protection layer, comprising polymer, may include inorganic material, e.g. and inorganic woven structure and/or inorganic nonwoven structure which includes inorganic fiber, for example glass fiber. In these embodiments, the inorganic woven structure and inorganic nonwoven structure may include a polymer coating. In some embodiments, the discontinuous transport protection layer includes from about 5 percent to about 100 percent, from about 10 percent to about 100 percent, from about 20 percent to about 100 percent, from about 30 percent to about 100 percent, from about 40 to about 100 percent, from about 50 to about 100 percent, from about 60 to about 100 percent, from about 70 percent to 100 percent or even from about 80 to about 100 percent by weight polymer. In some embodiments, it may be desirable for the discontinuous transport protection layer to include from at least about 70 percent to 100 percent by weight polymer, due to at least one of lower cost, lower weight and ease of processing.

In some embodiments, the polymer of the discontinuous transport protection layer has a softening temperature from about 50 degrees centigrade to about 400 degrees centigrade, from about 50 degrees centigrade to about 350 degrees centigrade, from about 50 degrees centigrade to about 300 degrees centigrade or even from about 50 degrees centigrade to about 250 degrees centigrade. In some embodiments, the discontinuous transport protection layer is non-tacky at 25 degrees centigrade, 30 degrees centigrade, 40 degree centigrade, or even 50 degrees centigrade. In some embodiments, the polymer of the discontinuous transport protection layer contains from about 0 percent to about 15 percent by weight, from about 0 percent to about 10 percent by weight, from about 0 percent to about 5 percent by weight, from about 0 percent to about 3 percent by weight, from about 0 percent to about 1 percent by weight or even substantially 0 percent by weight pressure sensitive adhesive in the form of a polymer blend. Low modulus and/or highly viscoelastic materials, such as a pressure sensitive adhesive, may flow during use, due to the compression forces within an electrochemical cell or liquid flow battery, and may make it difficult to obtain the desired separation between cell or battery components. In some embodiments, the electrode assembly and/or membrane-electrode assembly is substantially free of a pressure sensitive adhesive and/or a pressure sensitive adhesive layer. In some embodiments the modulus, e.g. Young's modulus, of the polymer of the discontinuous transport protection layer may be from about 0.010 GPa to about 10 GPa, from about 0.1 GPa to about 10 GPa, from about 0.5 GPa to about 10 GPa, from about 0.010 GPa to about 5 GPa, from about 0.1 GPa to about 5 GPa or even from about 0.5 GPa to about 5 GPa.

The polymer of the discontinuous transport protection layer may be ionic polymer. Ionic polymer include, but is not limited to, ion exchange resin, ionomer resin and combinations thereof. Ion exchange resins may be particularly useful. The ionic polymer of discontinuous transport protection layer may include polymer wherein a fraction of the repeat units are electrically neutral and a fraction of the repeat units have an ionic functional group, i.e. an ionic repeat unit. In some embodiments, the ionic polymer has a mole fraction of repeat units having an ionic functional group of between about 0.005 and about 1.

Ionic polymer may include conventional thermoplastics and thermosets that have been modified by conventional techniques to include at least one of type of ionic functional group, e.g. anionic and/or cationic. Useful thermoplastic resins that may be modified include, but are not limited to, at least one of polyethylene, e.g. high molecular weight polyethylene, high density polyethylene, ultra-high molecular weight polyethylene, polypropylene, e.g. high molecular weight polypropylene, polystyrene, poly(meth)acrylates, e.g. polyacrylates based on acrylic acid that may have the acid functional group exchanged for, for example, an alkali metal, chlorinated polyvinyl chloride, fluoropolymer, e.g. perfluorinated fluoropolymer and partially fluorinated fluoropolymer (for example polytetrafluoroethylene (PTFE) and polyvinylidene fluoride (PVDF) each of which may be semi-crystalline and/or amorphous, polyetherimides and polyketones. Useful thermoset resins include, but are not limited to, at least one of epoxy resin, phenolic resin, polyurethanes, urea-formadehyde resin and melamine resin. Ionic polymer includes, but are not limited to, ion exchange resins, ionomer resins and combinations thereof. Ion exchange resins may be particularly useful.

As defined herein, ionic polymer include polymer wherein a fraction of the repeat units are electrically neutral and a fraction of the repeat units have an ionic functional group. In some embodiments, the ionic polymer has a mole fraction of repeat units with ionic functional groups between about 0.005 and 1. In some embodiments, the ionic polymer is a cationic resin, i.e. its ionic functional groups are negatively charged and facilitate the transfer of cations, e.g. protons, optionally, wherein the cationic resin is a proton cationic resin. In some embodiments, the ionic polymer is an anionic exchange resin, i.e. its ionic functional groups are positively charged and facilitate the transfer of anions. The ionic functional group of the ionic polymer may include, but is not limited, to carboxylate, sulphonate, sulfonamide, quaternary ammonium, thiuronium, guanidinium, imidazolium and pyridinium groups. Combinations of ionic functional groups may be used in an ionic polymer.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.03 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolomer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane, e.g. ion exchange membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The ionic polymer may be a mixture of ionomer resin and ion exchange resin.

The polymer of the discontinuous transport protection layer may include a hydrophilic polymer, e.g. ionic polymer previously disclosed herein having a mole fraction of repeat units having ionic functional groups of between about 0.03 and about 1, between about 0.05 and about 1, between about 0.10 and 1, between about 0.03 and about 0.8, between about 0.05 and 0.80 or even between about 0.1 and 0.80. In some embodiments, the discontinuous transport protection layer comprises from about 5 percent to about 100 percent by weight, from about 10 percent to 100 percent by weight, from about 25 percent to about 100 percent by weight, from about 5 percent to about 80 percent by weight, from about 10 percent to 80 percent by weight, from about 25 percent to about 80 percent by weight, from about 5 percent to about 60 percent by weight, from about 10 percent to 60 percent by weight or even from about 25 percent to about 60 percent by weight of a hydrophilic polymer. In some embodiments, the hydrophilic polymer may be included in the polymer as a polymer blend or may be included as a polymer coating. In some embodiments the discontinuous transport protection layer includes a hydrophilic polymer coating. Hydrophilic polymers know in the art may be used, including but not limited to, polyacrylic acids, polymethacylic acids, polyvinyl alcohols, polyvinyl acetate, polyethylene glycol, polypropylene glycol, polyethylene oxide, polypropylene oxide, polyacrylamides, maleic anhydride polymers, cellulosic polymers, polyelectrolytes and polymers with amine groups in their main chain or side chains, e.g. nylon 6, 6, nylon 7, 7, and nylon 12, polysulfone, epoxies, polyester, and polycarbonate.

In some embodiments, the discontinuous transport protection layer includes a hydrophilic coating. The hydrophilic coating may be an organic material or inorganic material. The hydrophilic coating may include at least one of a high molecular weight molecular species (number average molecular weight greater than 10000 g/mol,), an oligomeric molecular species (number average molecular weight greater than 1000 g/mol and no greater than 10000 g/mol), a low molecular weight molecular species (number average molecular weight no greater than 1000 g/mol and no less than 20 g/mol) and combinations thereof. The hydrophilic coatings may include molecular species comprising one or more polar functional groups, e.g. acid, hydroxyl, ester, ether and/or amine. In some embodiments, the hydrophilic polymer and/or hydrophilic coating of the discontinuous transport protection layer may have a surface contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. The contact angle may be measured by known techniques in the art, including receding contact angle measurement and advancing contact angle measurements. In some embodiments, the hydrophilic polymer and/or hydrophilic coating of the discontinuous transport protection layer may have a receding contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the hydrophilic polymer and/or hydrophilic coating of the discontinuous transport protection layer may have an advancing contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the discontinuous transport protection layer may have an advancing contact angle and/or receding contact angle with water, catholyte and/or anolyte of between about 90 and 0 degrees, between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. Use of hydrophilic polymers and/or coatings for the discontinuous transport protection layer may improve liquid transport, e.g. anolyte and/or catholyte flow, through the layer and improve electrochemical cell and/or liquid flow battery performance.

The polymer of the discontinuous transport protection layer may be a solid, being substantially free of any voids or porosity. For example, the discrete structures 15 of FIGS. 1A and 1B may each be formed from a polymer and the polymer may be a solid, substantially free of any voids or porosity. In some embodiments, the polymer of the discontinuous transport protection layer has between about 0 and about 5 percent porosity by volume, between about 0 percent and about 3 percent porosity by volume or even between about 0 percent and about 1 percent porosity by volume. In some embodiments, it may be desired to maintain a low porosity within the polymer of the discontinuous transport protection layer, in order to provide a higher modulus material that can better resist compression forces that are present when used in an electrochemical cell or liquid flow battery and/or to maintain the desired spacing between components, e.g. the desired spacing between the porous electrode and ion permeable membrane.

In some embodiments, the discontinuous transport protection layer is non-conductive. The discontinuous transport protection layer may contain small amounts of electrically conductive material or other fillers, e.g. non-electrically conductive particulate. In some embodiments, the discontinuous transport protection layer contains between about 0 percent and about 5 percent by weight, between about 0 and about 3 percent by weight, between about 0 and about 1 percent or even substantially 0% by weight of at least one of an electrically conductive particulate and a non-electrically conductive particulate.

The thickness, Tp, of the discontinuous transport protection layer is not particularly limited. In some embodiments, the thickness of the discontinuous transport protection layer, e.g. the thickness of at least one of a plurality of discrete structures, a mesh structure, a woven structure and a nonwoven structure, is from about 0.05 micron to about 3000 microns, from about 0.05 micron to about 2000 microns, from about 0.05 micron to about 1000 microns, about 0.05 micron to about 500 microns, from about 1 micron to about 3000 microns, from about 1 micron to about 2000 microns, from about 1 micron to about 1000 microns, about 1 micron to about 500 microns, from about 10 microns to about 3000 microns, from about 10 microns to about 2000 microns, from about 10 microns to about 1000 microns, about 10 microns to about 500 microns, from about 50 microns to about 3000 microns, from about 50 microns to about 2000 microns, from about 50 microns to about 1000 microns, or even from about 50 microns to about 500 microns.

In some embodiments, to maximize the resistance to shorting of a cell or battery (associated with, for example, carbon fiber penetration of the ion permeable membrane), it may be desirable to have a thicker discontinuous transport protection layer. In these embodiments, the thickness of the discontinuous transport protection layer may be on the higher end of the ranges of thickness described above. For example, the thickness of the discontinuous transport protection layer may be from about 25 microns to about 3000 microns, from about 25 microns to about 2000 microns, from about 25 microns to about 1000 microns, from about 25 microns to about 500 microns, from about 50 microns to about 3000 microns, from about 50 microns to about 2000 microns, from about 50 microns to about 1000 microns, from about 50 microns to about 500 microns, from about 75 microns to about 3000 microns, from about 75 microns to about 2000 microns, from about 75 microns to about 1000 microns, from about 75 microns to about 500 microns, from about 100 microns to about 3000 microns, from about 100 microns to about 2000 microns, from about 100 microns to about 1000 microns, or even from about 100 microns to about 500 microns.

In some embodiments, to enhance cell resistance and/or short resistance, the thickness of the porous protection layer may be between about 25 microns and about 500 microns, between about 50 microns and about 500 microns, between about 75 microns and about 500 microns, between about 100 microns and about 500 microns, between about 25 microns and about 400 microns, between about 50 microns and about 400 microns, between about 75 microns and about 400 microns, between about 100 microns and about 400 microns, between about 25 microns and about 300 microns, between about 50 microns and about 300 microns, between about 75 microns and about 300 microns, or even between about 100 microns and about 300 microns.

In some embodiments, in order to improve the cell resistance (lower the cell resistance), it may be desirable to have a thinner discontinuous transport protection layer. In these embodiments, the thickness of the discontinuous transport protection layer may be on the lower end of the ranges of thickness described above. be between about 25 microns and about 500 microns, between about 50 microns and about 500 microns, between about 75 microns and about 500 microns, between about 100 microns and about 500 microns, between about 25 microns and about 400 microns, between about 50 microns and about 400 microns, between about 75 microns and about 400 microns, between about 100 microns and about 400 microns, between about 25 microns and about 300 microns, between about 50 microns and about 300 microns, between about 75 microns and about 300 microns, or even between about 100 microns and about 300 microns.

In some embodiments, the discontinuous transport protection layer may include at least one of a plurality of discrete structures, a mesh structure, a woven structure and a nonwoven structure; combinations of structures may be used. Discrete structures are characterized as being independent of one another. There is no interconnecting polymer material between them, for example, there is no land region, i.e. a thin film of polymer, connecting the discrete structures. The shape of the plurality of discrete structures is not particularly limited. The shape of plurality of discrete structures includes, but is not limited to, cylinders, half spheres, cubes, rectangular prism, triangular prism, hexagonal prism, triangular pyramid, 4, 5 and 6-sided pyramids, truncated pyramids, cones, truncated cones, lines, e.g. straight lines, wavy lines, non-intersecting lines, non-intersecting straight lines, non-intersecting wavy lines, parallel lines, parallel straight lines, parallel wavy lines and the like. If the discrete structures are in the form of a line, the cross-section of the line may be any shape. The plurality of discrete structures may include combinations of shapes. In some embodiments, the plurality of discrete structures of the discontinuous transport protection layer may be arranged randomly or may be arranged in a pattern, e.g. a repeating pattern. Patterns include, but are not limited to, square arrays, hexagonal arrays, a pattern of parallel lines with a constant pitch and the like. Combination of patterns may be used.

The size of the plurality of discrete structures of the discontinuous transport protection layer is not particularly limited. In some embodiments, the plurality discrete structures have a longest dimension, e.g. length, width or thickness, from about 10 microns to about 5000 microns, from about 10 microns to about 3000 microns, from about 10 microns to about 1000 microns, from about 10 microns to about 500 microns, from about 30 microns to about 5000 microns, from about 30 microns to about 3000 microns, from about 30 microns to about 1000 microns, from about 30 microns to about 500 microns, from about 50 microns to about 5000 microns, from about 50 microns to about 3000 microns, from about 50 microns to about 1000 microns, from about 50 microns to about 500 microns, from about 100 microns to about 5000 microns, from about 100 microns to about 3000 microns, from about 100 microns to about 1000 microns or even from about 100 microns to about 500 microns.

In some embodiments, the discontinuous transport protection layer includes a plurality of non-intersecting, continuous lines. In some embodiments, the plurality of non-intersecting continuous line are substantially parallel over a length scale of from about 2 cm to about 100 cm, from about 5 cm to about 100 cm, from about 10 cm to about 100 cm, from about 2 cm to about the length of the porous electrode, from about 5 cm to about the length of the porous electrode or even from about 10 cm to about the length of the porous electrode. In some embodiments, the plurality of non-intersecting continuous lines are straight lines. In some embodiments, the plurality of non-intersecting continuous lines are curved lines. In some embodiments, the plurality of non-intersecting, continuous lines have a pitch from about 0.3 mm to about 11 mm, from about 0.5 mm to about 11 mm, from about 1.0 mm to about 11 mm, 0.3 mm to about 9 mm, from about 0.5 mm to about 9 mm, from about 1.0 mm to about 9 mm from about 0.3 mm to about 7 mm, from about 0.5 mm to about 7 mm or even from about 1.0 mm to about 7 mm. In some embodiments, the pitch may be the same between adjacent lines. In some embodiments, the pitch may vary between two or more adjacent lines. In some embodiments, the plurality of non-intersecting, continuous lines have a width from about 0.01 mm to about 10 mm, 0.025 mm to about 10 mm, 0.05 mm to about 10 mm, 0.1 mm to about 10 mm, from about 0.3 to about 10 mm, from about 0.5 mm to about 10 mm, from about 1 mm to about 10 mm, 0.01 mm to about 8 mm, 0.025 mm to about 8 mm, 0.05 mm to about 8 mm, from about 0.1 mm to about 8 mm, from about 0.3 to about 8 mm, from about 0.5 mm to about 8 mm, from about 1 mm to about 8 mm, 0.01 mm to about 6 mm, 0.025 mm to about 6 mm, 0.05 mm to about 6 mm, from about 0.1 mm to about 6 mm, from about 0.3 to about 6 mm, from about 0.5 mm to about 6 mm, from about 1 mm to about 6 mm or even from about 10 microns to about 1000 microns. The width of the lines may be the same or may vary.

Discrete structures may be fabricated by a variety of techniques known in the art, including, but not limited to, extrusion, 3-dimensional printing, transfer lamination using a segmented transfer tape, micro-replication and the like.

In some embodiments, the discontinuous transport protection layer may include a mesh structure (see FIGS. 1I and 1J). Mesh structure include a continuous sheet or layer having a plurality of open regions, e.g. a plurality of through-holes. A mesh structure may include, for example, a polymer film with a plurality of through-holes. The mesh structure of the present disclosure does not include conventional woven and nonwoven structures, i.e. woven and nonwoven substrates. The shape of the plurality of open regions of the mesh structure is not particularly limited and includes, but is not limited to, circular, elliptical, irregular polygons and regular polygons, e.g. triangle, quadrilateral (square, rectangle, rhombus and trapezoid), pentagon, hexagon and octagon. Combinations of shapes may be used. In some embodiments, the plurality of open regions of the mesh structure may have a length and/or width of from about 10 microns to about 10 mm, 50 microns to about 10 mm, 100 microns to about 10 mm, from about 200 microns to about 10 mm, from about 500 microns to about 10 mm, from about 1000 microns to about 10 mm, 10 microns to about 8 mm, 50 microns to about 8 mm, from about 100 microns to about 8 mm, from about 200 microns to about 8 mm, from about 500 microns to about 8 mm, from about 1000 microns to about 8 mm, 10 microns to about 6 mm, 50 microns to about 6 mm, from about 100 microns to about 6 mm, from about 200 microns to about 6 mm, from about 500 microns to about 6 mm, from about 1000 microns to about 6 mm or even from about 10 microns to about 1000 microns. The depth of the plurality of open regions may correspond to the thickness, Tp, of the discontinuous transport protection layer, as previously described. The dimensions, i.e. length, width and/or depth of each open region may be substantially the same or may be different. The plurality of open regions of the mesh structure may be random or may be in a pattern. Patterns include, but are not limited to, square arrays, hexagonal arrays and the like. Combination of patterns may be used.

Mesh structures may be fabricated by known techniques in the art. For example, a polymer film may be fabricated by an extrusion process and a plurality of open regions may be formed in the polymer film via techniques known in the art, including, but not limited to, die cutting, laser cutting, water jet cutting, needle punching, etching and the like. A mesh structure may also be formed by an extrusion process where a first set of strands of polymer, substantially parallel to one another, for example, are extruded in one direction on a porous electrode and a second set of polymer strands, substantially parallel to one another, yet off-set by an angle, theta, relative to the first set of strands, is extruded on the porous electrode, thereby forming a mesh structure. Theta may be from about 5 degrees to about 90 degrees, from about 15 degrees to about 90 degrees, from about 30 degrees to about 90 degrees or even from about 45 degrees to about 90 degrees.

In some embodiments, the discontinuous transport protection layer may include a woven structure, i.e. a woven substrate (see FIGS. 1K and 1L) having a plurality of open regions. Conventional woven structures known in the art may be used, e.g. woven cloths and woven fabrics. In some embodiments, the plurality of open regions of the woven structure may have a length and/or width of from about 10 microns to about 10 mm, from about 50 microns to about 10 mm, from about 100 microns to about 10 mm, from about 200 microns to about 10 mm, from about 500 microns to about 10 mm, from about 1000 microns to about 10 mm, from about 10 microns to about 8 mm, from about 50 microns to about 8 mm, from about 100 microns to about 8 mm, from about 200 microns to about 8 mm, from about 500 microns to about 8 mm, from about 1000 microns to about 8 mm, from about 10 microns to about 6 mm, from about 50 microns to about 6 mm, from about 100 microns to about 6 mm, from about 200 microns to about 6 mm, from about 500 microns to about 6 mm, or even from about 1000 microns to about 6 mm. The depth of the plurality of open regions may correspond to the thickness, Tp, of the discontinuous transport protection layer, as previously described.

In some embodiments, the discontinuous transport protection layer may include a nonwoven structure, i.e. a nonwoven substrate (see FIGS. 1M and 1N) having open regions, the open regions may be substantially interconnected. Conventional nonwoven structures known in the art may be used, e.g. nonwoven paper, nonwoven felt and nonwoven web.

The woven and nonwoven structures of the discontinuous transport protection layer of the present disclosure may be non-conductive structures. The woven and nonwoven structures of the discontinuous transport protection layer, generally, include fiber. In some embodiments, the discontinuous transport protection layers includes a woven non-conductive structure and is free of a nonwoven non-conductive structure. In some embodiments, the discontinuous transport protection layers includes a nonwoven non-conductive structure and is free of a woven non-conductive structure. The woven and nonwoven non-conductive structure of the discontinuous transport protection layer include polymer and, optionally may include an inorganic. The woven and nonwoven structures may include a non-conductive polymer material and, optionally, a non-conductive inorganic material. The woven and nonwoven non-conductive substrate may comprise fiber, e.g. a plurality of fibers. The woven and nonwoven structures may be fabricated from polymer fiber, e.g. non-conductive polymer fiber and, optionally inorganic fiber, e.g. non-conductive inorganic fiber. In some embodiments, the woven and nonwoven structures may include polymer fiber and exclude inorganic fiber.

In some embodiments, the fibers of the woven and nonwoven structures may have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 500 microns, from between about 0.001 to about 250 microns, from between about 0.001 to about 100 microns, from between about 0.001 microns to about 50 microns, from between about 0.001 to about 25 microns, from between about 0.001 microns to about 10 microns, from about 0.001 microns to about 1 microns, from between about from between about 0.01 to about 500 microns, from between about 0.01 to about 250 microns, 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 500 microns, from between about 0.05 to about 250 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 to about 500 microns, from between about 0.1 to about 250 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same. In some embodiments, smaller microfibers may be woven or bonded together to form macro-fibers having significantly larger dimension, e.g. width and/or thickness, than the individual fibers they are composed of.

The fibers may be fabricated into a woven and nonwoven structure using conventional techniques. A nonwoven structure may be fabricated by a melt blown fiber process, spunbond process, a carding process and the like. In some embodiments, the length to thickness and length to width aspect ratios of the fiber may be greater than 1000000, greater than about 10000000 greater than about 100000000 or even greater than about 1000000000. In some embodiments, the length to thickness and length to width aspect ratios of the fiber may be between about 10 to about 1000000000; between about 10 and about 100000000 between about 10 and about 10000000, between about 20 to about 1000000000; between about 20 and about 100000000 between about 20 and about 10000000, between about 50 to about 1000000000; between about 50 and about 100000000 or even between about 50 and about 10000000.

The at least one of a woven and nonwoven structure may include conventional woven and nonwoven paper, felt, mats and cloth (fabrics) known in the art. The woven and nonwoven structure may include polymer fiber and, optionally, ceramic fiber. The number of types, polymer fiber types and ceramic fiber types, used to form the at least one of a woven and nonwoven non-conductive substrate, is not particularly limited. The polymer fiber may include at least one polymer, e.g. polymer composition or one polymer type. The polymer fiber may include at least two polymers, i.e. two polymer compositions or two polymer types. The polymer fiber may be a core-sheath polymer fiber composed of at least two different polymer types. For example, the polymer fiber may include one set of fibers composed of polyethylene and another set of fibers composed of polypropylene. If at least two polymers are used, the first polymer fiber may have a lower glass transition temperature and or melting temperature than the second polymer fiber. The first polymer fiber may be used for fusing the polymer fiber of the at least one of a woven and nonwoven structure together, to improve, for example, the mechanical properties of the woven and nonwoven structure. The first polymer fiber may also be embedded in the in at least a portion of the plurality of voids of the porous electrode, or a portion of the porous electrode may be embedded in a portion of the first polymer fiber or a combination thereof. The optional ceramic fiber may include at least one ceramic, e.g. one ceramic composition or one ceramic type. The optional ceramic fiber may include at least two ceramics, i.e. two ceramic compositions or two ceramic types. The woven and nonwoven structures may include at least one polymer fiber, e.g. one polymer composition or polymer type, and at least one ceramic fiber, e.g. one ceramic composition or one ceramic type. For example, the at least one of a woven and nonwoven non-structure may include polyethylene fiber and glass fiber.

The basis weight of the at least one of a woven and nonwoven structure is not particularly limited. In some embodiments, the basis weight of the at least one of a woven and nonwoven structure, measured in gram per square meter (gsm) of material, may be between about 4 gsm and about 60 gsm, between about 4 gsm and about 50 gsm, between about 4 gsm and about 40 gsm, between about 4 gsm and about 32 gsm, between about 6 gsm and about 60 gsm, between about 6 gsm and about 50 gsm, between about 6 gsm and about 40 gsm, between about 6 gsm and about 32 gsm, between about 8 gsm and about 60 gsm, between about 8 gsm and about 50 gsm, between about 8 gsm and about 40 gsm or even between about 8 gsm and about 32 gsm.

In some embodiments, the woven and nonwoven structure may include small amounts of one or more conductive material, so long as the conductive material does not alter the at least one of a woven and nonwoven non-conductive substrate to be conductive. In some embodiments, the at least one of a woven and nonwoven non-conductive structure is substantially free of conductive material. In this case, “substantially free of conductive material” means that the at least one of a woven and nonwoven non-conductive substrate includes less than about 25% by wt., less than about 20% by wt., less than about 15% by wt., less than about 10% by wt., less than about 5% by wt., less than about 3% by wt., less than about 2%, by wt., less than about 1% by wt., less than about 0.5% by wt., less than about 0.25% by wt., less than about 0.1% by wt., or even 0.0% by wt. conductive material.

The polymer fiber of the at least one of a woven and nonwoven structure is not particularly limited. In some embodiments, the polymer fiber of the at least one of a woven and nonwoven structure is non-conductive. In some embodiments, the polymer fiber of the woven and nonwoven structure may include least one of a thermoplastic and thermoset. Thermoplastics may include thermoplastic elastomers. A thermoset may include a B-stage polymer. In some embodiments, polymer fiber of the woven and nonwoven structure includes, but is not limited to, at least one of epoxy resin, phenolic resin, polyurethane, urea-formadehyde resin, melamine resin, polyester, e.g. polyethylene terephthalate, polyethylene naphthalate, polyamide, polyether, polycarbonate, polyimide, polysulphone, polyphenylene oxide, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the polymer fiber comprises at least one of polyurethane, polyester, polyamide, polyether, polycarbonate, polyimides, polysulphone, polyphenylene oxide, polyacrylates, polymethacylates, polyolefin, styrene and styrene based random and block copolymers, polyvinyl chloride, and fluorinated polymer.

The optional ceramic fiber of the woven and nonwoven structure is not particularly limited. The ceramic of the ceramic fiber may include, but is not limited to, metal oxides, for example silicon oxide, e.g. glass and doped glass, and aluminum oxide.

The discontinuous transport protection layer may be a multi-layer structure. In some embodiments, the discontinuous transport protection layer comprises at least one layer. In some embodiments, the discontinuous transport protection layer comprises two or more layers. The layers of the discontinuous transport protection layer may be the same composition and/or structure or may include two or more different compositions and/or two or more different structures.

The discontinuous transport protection layers of the present disclosure may further include an ionic resin coating over at least a portion of discontinuous transport protection layer. The ionic resin coating of the discontinuous transport protection layer should allow the select ion(s) of the electrolytes to transfer through the discontinuous transport protection layer. This may be achieved by allowing the electrolyte to easily wet and absorb into a given discontinuous transport protection layer. The material properties, particularly the surface wetting characteristics of the discontinuous transport protection layer may be selected based on the type of anolyte and catholyte solution, i.e. whether they are aqueous based or non-aqueous based. In some embodiments the ionic resin of the ionic resin coating may have a surface contact angle with water, catholyte and/or anolyte of between about 90 degrees and 0 degrees, of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the ionic resin coats at least 10%, at least 20%, at least 30%, at least 40%, at least 50%, at least 60%, at least 70%, at least 75%, at least 80%, at least 85%, at least 90%, at least 95% or even at least 100% of the surface area of the discontinuous transport protection layer. As improvement in the wettability, generally, increase with the area of coverage of the ionic resin coating, higher areal coverage may be preferred.

The ionic resin coating may be formed from a precursor ionic resin containing one or more of monomer and oligomer which may be cured to form an ionic resin coating. The precursor ionic resin may also contain dissolved polymer. The precursor ionic resin may contain solvent which is removed prior to or after curing of the precursor ionic resin. The ionic resin may be formed from a dispersion of ionic resin particles, the solvent of the dispersion being removed to form the ionic resin coating of the discontinuous transport protection layer. The ionic resin coating may include an ionic polymer, which may be dispersed or dissolved in a solvent, the solvent being removed to form the ionic resin coating of the discontinuous transport protection layer. The ionic resin coating may include at least one of ionic polymer, ionomer resin and ion exchange resin, as previously described herein.

The ratio of the weight of the ionic resin to total weight of the discontinuous transport protection layer is not particularly limited. In some embodiments, the ratio of the weight of the ionic resin to the total weight of the discontinuous transport protection layer is from about 0.03 to about 0.95, from about 0.03 to about 0.90, from about 0.03 to about 0.85, from about 0.03 to about 0.80, from about 0.03 to about 0.70, from about 0.05 to about 0.95, from about 0.05 to about 0.90, from about 0.05 to about 0.85, from about 0.05 to about 0.80, from about 0.05 to about 0.70, from about 0.10 to about 0.95, from about 0.10 to about 0.90, from about 0.10 to about 0.85, from about 0.10 to about 0.80, from about 0.10 to about 0.70, from about 0.20 to about 0.95, from about 0.20 to about 0.90, from about 0.20 to about 0.85, from about 0.20 to about 0.80, from about 0.20 to about 0.70, from about 0.30 to about 0.95, from about 0.30 to about 0.90, from about 0.30 to about 0.85, from about 0.30 to about 0.80, from about 0.30 to about 0.70, from about 0.40 to about 0.95, from about 0.40 to about 0.90, from about 0.40 to about 0.85, from about 0.40 to about 0.80, or even from about 0.40 to about 0.70.

Coating techniques know in the art may be used including, but not limited to, brush coating, dip coating, spray coating, knife coating, e.g. slot-fed knife coating, notch bar coating, metering rod coating, e.g. Meyer bar coating, die coating, e.g. fluid bearing die coating, roll coating, e.g. three roll coating, curtain coating and the like.

In some embodiments, the ionic resin is coated on at least a portion of the fiber surface of discontinuous transport protection layer in the form an ionic resin coating solution, e.g. a solution that includes the ionic resin, solvent and any other desired additives. The volatile components of the ionic resin coating solution, e.g. solvent, are removed by drying, leaving the ionic resin on at least a portion of the surface of discontinuous transport protection layer. Ionic resin coating solutions may be prepared by solution blending, which includes combining the resin, an appropriate solvent and any other desired additives, followed by mixing at the desired shear rate. Mixing may include using any techniques known in the art, including blade mixers and conventional milling, e.g. ball milling. Other additives to the ionic resin coating solutions may include, but are not limited to, surfactants, dispersants, thickeners, wetting agents and the like. Surfactants, dispersants and thickeners may help to facilitate the ability of the ionic resin coating solution to wet the surface of the discontinuous transport protection layer. They may also serve as viscosity modifiers. Prior to making the coating solution, the ionic resin may be in the form of a dispersion or a suspension, as would be generated if the ionic resin was prepared via an emulsion polymerization technique or suspension polymerization technique, for example. Additives, such as surfactants, may be used to stabilize the ionic resin dispersion or suspension in their solvent.

Solvent useful in the ionic resin coating solution may be selected based on the ionic resin type. Solvents useful in the ionic resin coating solution include, but are not limited to, water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The amount of solvent, on a weight basis, in the ionic resin coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

Surfactants may be used in the ionic resin coating solutions, for example, to improve wetting. Surfactants may include cationic, anionic and nonionic surfactants. Surfactants useful in the ionic resin coating solution include, but are not limited to TRITON X-100, available from Dow Chemical Company, Midland, Mich.; DISPERSBYK 190, available from BYK Chemie GMBH, Wesel, Germany; amines, e.g. olyelamine and dodecylamine; amines with more than 8 carbons in the backbone, e.g. 3-(N, N-dimethyldodecylammonio) propanesulfonate (SB12); SMA 1000, available from Cray Valley USA, LLC, Exton, Pa.; 1,2-propanediol, triethanolamine, dimethylaminoethanol; quaternary amine and surfactants disclosed in U.S. Pat. Publ. No. 2013/0011764, which is incorporated herein by reference in its entirety. If one or more surfactants are used in the ionic resin coating solution, the surfactant may be removed from the discontinuous transport protection layer by a thermal process, wherein the surfactant either volatilizes at the temperature of the thermal treatment or decomposes and the resulting compounds volatilize at the temperature of the thermal treatment. In some embodiments, the ionic resin is substantially free of surfactant. By “substantially free” it is meant that the ionic resin contains, by weight, from 0 percent to 0.5 percent, from 0 percent to 0.1 percent, from 0 percent to 0.05 percent or even from 0 percent to 0.01 percent surfactant. In some embodiments, the ionic resin contains no surfactant. The surfactant may be removed from the ionic resin by washing or rinsing with a solvent of the surfactant. Solvents include, but are not limited to water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The discontinuous transport protection layer may be formed with ionic resin coating solution by coating the solution on a liner or release liner. A first major surface of a discontinuous transport protection layer, for example a first major surface of a woven or nonwoven structure, may then be placed in contact with the ionic resin coating solution. The discontinuous transport protection layer is removed from the liner and at least a portion of the first major surface of the discontinuous transport protection layer is coated with the ionic resin coating solution. Optionally, a new liner or the same liner may be coated with the same or a different ionic resin coating solution and the second major surface of the discontinuous transport protection layer, may then be placed in contact with the ionic resin coating solution. The discontinuous transport protection layer is removed from the liner and at least a portion of the second major surface of the discontinuous transport protection layer is coated with the ionic resin coating solution. The discontinuous transport protection layer is then exposed to a thermal treatment, e.g. heat from an oven or air flow through oven, in order to remove the volatile compounds, e.g. solvent, from the ionic resin coating solution, producing a discontinuous transport protection layer comprising polymer and an ionic resin, which coats at least a portion of the surface of the polymer of the discontinuous transport protection layer. An alternative approach to fabricating the discontinuous transport protection layer would include coating the ionic resin coating solution directly onto the first and/or second major surfaces of the discontinuous transport protection layer, for example, followed by a thermal treatment, e.g. heat from an oven or air flow through oven, in order to remove the volatile compounds, e.g. solvent, from the ionic resin coating solution, producing a discontinuous transport protection layer having comprising polymer and an ionic resin, which coats at least a portion of the polymer surface the discontinuous transport protection layer. If the amount of coating solution is too great after coating, the discontinuous transport protection layer may be run through the nip of a two roll coater, for example, to remove some of the ionic resin coating solution, prior to thermal treatment.

If the ionic resin is in the from a precursor ionic resin, a discontinuous transport protection layer may be formed by coating at least one major surface of discontinuous transport protection layer comprising polymer with the precursor resin, wherein at least a portion of the polymer surface of the discontinuous transport protection layer is coated by the precursor ionic resin. The precursor ionic resin coating of the discontinuous transport protection layer may then be cured by any technique known in the art including, but not limited to, thermal curing, actinic radiation curing and e-beam curing. The precursor ionic resin may contain one or more of curing agents, catalyst, chain transfer agents, chain extenders and the like, as dictated by the cure chemistry of the precursor ionic resin and the desired final properties of the ionic resin. Curing the ionic resin precursor produces a discontinuous transport protection layer comprising polymer and an ionic resin, which coats at least a portion of the polymer surface of the discontinuous transport protection layer.

In some embodiments, at least one of the volume porosity and open area porosity of the discontinuous transport protection layer may be between about 0.10 and about 0.995, between about 0.10 and about 0.95, between about 0.10 and about 0.90, between about 0.10 and about 0.85, between about 0.10 and about 0.75, between about 0.15 and about 0.995, between about 0.15 and about 0.95, between about 0.15 and about 0.90, between about 0.15 and about 0.85, between about 0.15 and about 0.75, between about 0.25 and about 0.995, between about 0.25 and about 0.95, between about 0.25 and about 0.90, between about 0.25 and about 0.85, between about 0.25 and about 0.75, between about 0.35 and about 0.995, between about 0.35 and about 0.95, between about 0.35 and about 0.90, between about 0.35 and about 0.85, between about 0.35 and about 0.75, between about 0.45 and about 0.995, between about 0.45 and about 0.95, between about 0.45 and about 0.90, between about 0.45 and about 0.85, about 0.45 and about 0.75, between about 0.50 and about 0.995, between about 0.50 and about 0.95, between about 0.50 and about 0.90, between about 0.50 and about 0.85, between about 0.50 and about 0.75, between about 0.65 and about 0.995, between about 0.65 and about 0.95, between about 0.65 and about 0.90, between about 0.65 and about 0.85, or even between about 0.65 and about 0.75.

The volume porosity of the discontinuous transport protection layer is defined as the volume of the void space of the discontinuous transport layer divided by the total volume, i.e. bulk volume, of the discontinuous transport protection layer. Volume porosity may be determined by conventional techniques known in the art, e.g. direct methods, optical methods and gas expansion methods. For example, the volume porosity may be calculated from the following equation:

Volume Porosity=1−(Ds/Dm)

where,

Ds=density of a substrate (bulk density) in g/cm³ for example.

Dm=Density of the material making up the substrate in g/cm³ for example.

If the substrate happens to be a woven or nonwoven substrate containing more than one fiber type, then Dm is the weighted average density:

Weighted Average Density=D1(w1/w3)+D2(w2/w3)

where,

D1 is the density of component 1

D2 is the density of component 2

w1 is the weight of component 1

w2 is the weight of component 2

w3 is the total weight (w3=w1+w2)

For example, for a nonwoven substrate having a density, Ds, of 0.3 g/cm³ made from polyethylene fiber having a density of 0.95 g/cm³, the porosity would be (1-0.3/0.95) which is 0.684. The volume porosity is the volume fraction of pores or open volume in the substrate.

The open area porosity is the ratio of the area of the voids, e.g. through-holes, to the total area of the surface of the discontinuous transport protection layer at a major surface of the discontinuous transport protection layer (area of the through-holes and corresponding polymer). The open area porosity may be determined by conventional techniques known in the art. The open area porosity may be calculated, for example, for a mesh having a rectangular through hole of length, l, and width, w, and a fiber width or diameter for the weft fibers, Dwe, and warp fibers, Dwa, as follows (assuming the length of the hole corresponds to the direction of the warp fiber and the width of the hole corresponds to the direction of the weft fiber):

Open Area Porosity=(1×w)/[(1+Dwe)(w+Dwa)]

In some embodiments, to maximize the resistance to shorting of a cell or battery (associated with carbon fiber penetration of the ion permeable membrane), it may be desirable to have a less porous discontinuous transport protection layer. In these embodiments, at least one of the volume porosity and open area porosity of the discontinuous transport protection layer may be on the lower end of the ranges of volume porosity and/or open area porosity described above. For example, at least one of the volume porosity and open area porosity of the discontinuous transport protection layer may be between about 0.10 and about 0.65, between about 0.10 and about 0.55, between about 0.10 and about 0.45, between about 0.10 and about 0.35, between about 0.15 and about 0.65, between about 0.15 and about 0.55, between about 0.15 and about 0.45, or even between about 0.15 and about 0.35.

In some embodiments, to increase the fluid flow, i.e. the flow of anolyte and/or catholyte, in a cell or battery in order to maximize the cell resistance (lower the cell resistance), it may be desirable to have a more porous discontinuous transport protection layer. In these embodiments, at least one of the volume porosity and open area porosity of the discontinuous transport protection layer may be on the higher end of the ranges of volume porosity and/or open area porosity described above. For example, at least one of the volume porosity and open area porosity of the discontinuous transport protection layer may be between about 0.35 and about 0.995, between about 0.35 and about 0.95, between about 0.35 and about 0.90, between about 0.35 and about 0.85, between about 0.35 and about 0.75, between about 0.45 and about 0.995, between about 0.45 and about 0.95, between about 0.45 and about 0.90, between about 0.45 and about 0.85, or even between about 0.45 and about 0.75.

With respect to improving the short resistance and cell resistance of an electrochemical cell or battery containing a discontinuous transport protection layer of the present disclosure, a change in the porosity, either increasing or decreasing, generally, will improve one of the parameters while adversely affecting the other parameter. However, it has been surprisingly found that the resistance to shorting (associated with carbon fiber penetration of the ion permeable membrane) of an electrochemical cell may be improved while at least not significantly changing and, in some cases, improving the cell resistance of an electrochemical cell containing a discontinuous transport protection layer of the present disclosure. In these embodiments, at least one of the volume porosity and open area porosity of the discontinuous transport protection layer may be between about 0.35 and about 0.995, between about 0.35 and about 0.95, between about 0.35 and about 0.90, between about 0.35 and about 0.85, or even between about 0.35 and about 0.75.

The present disclosure also provides membrane-electrode assemblies. The membrane-electrode assemblies may comprise an electrode assembly, e.g. a first electrode assembly, according to any one of the electrode assemblies of the present disclosure and further include an ion permeable membrane having a first surface and an opposed second surface, e.g. an ion exchange membrane, disposed adjacent to or on the major surface of the discontinuous transport protection layer opposite the interfacial region. The electrode assembly and ion permeable membrane may form an integral structure. In some embodiments, the major surface of the discontinuous transport protection layer opposite the interfacial region may be laminated to a first major surface of the ion permeable membrane (e.g. an ion exchange membrane), using conventional lamination techniques, which may include at least one of pressure and heat, thereby forming a membrane-electrode assembly. A second discontinuous transport protection layer may be laminated to the opposed second major surface of the ion permeable membrane, thereby forming a membrane-electrode assembly.

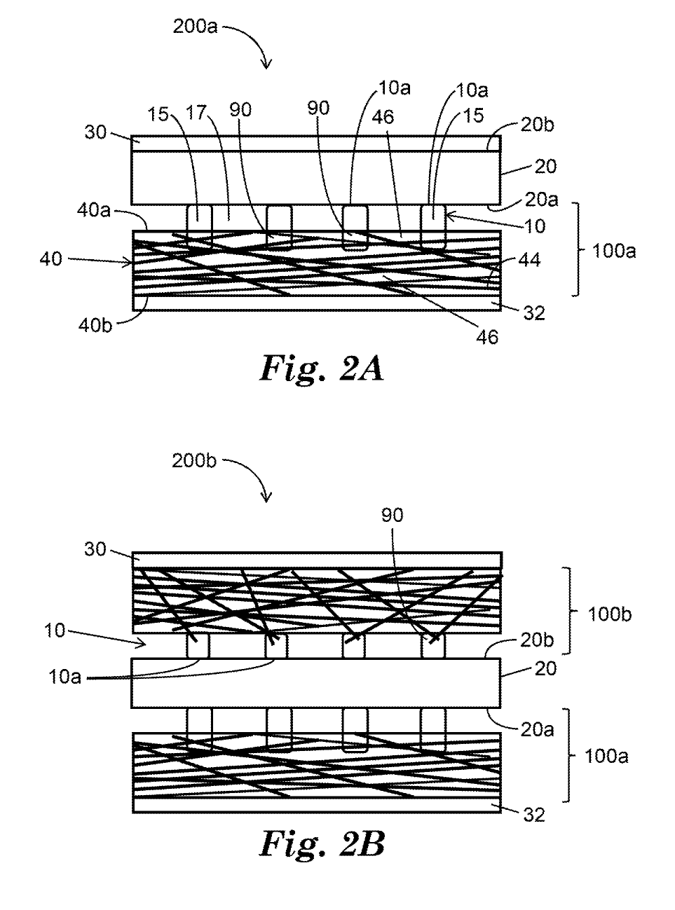

FIG. 2A shows a schematic cross-sectional side view of a membrane-electrode assembly according to one exemplary embodiment of the present disclosure. Membrane-electrode assembly 200a includes ion permeable membrane 20, e.g. an ion exchange membrane, having first major surface 20a and an opposed second major surface 20b and first electrode assembly 100a, as previously described per FIGS. 1A and 1B. Ion permeable membrane 20 is disposed on the major surface 10a of the discontinuous transport protection layer 10 opposite interfacial region 90. First major surface 20a of ion permeable membrane 20 may be in contact with the major surface of first discontinuous transport protection layer 10 of electrode assembly 100a opposite interfacial region 90. First electrode assembly 100a may be replaced by any of the electrode assemblies of the present disclosure, for example those disclosed in FIGS. 1C through 1N. Membrane-electrode assembly 200a may further include one or more optional release liner 30, 32. Conventional release liners known in the art may be used for optional release liners 30 and 32.

FIG. 2B shows a schematic cross-sectional side view of an exemplary membrane-electrode assembly according to one exemplary embodiment of the present disclosure. FIG. 2B is identical to FIG. 2A, as previously described, except it includes a second electrode assembly 100b, as previously described per FIG. 1D. Membrane-electrode assembly 200b includes ion permeable membrane 20, e.g. an ion exchange membrane, having a first surface 20a and an opposed second surface 20b and a first electrode assembly 100a, as previously described per FIG. 1B, a second electrode assembly 100b, as previously described per FIG. 1D. Ion permeable membrane 20 (surface 20b) is disposed on the major surface 10a of the discontinuous transport protection layer 10 of second electrode assembly 100b opposite interfacial region 90. First surface 20b of ion permeable membrane 20 may be in contact with the major surface 10a of discontinuous transport protection layer 10 of electrode assembly 100b opposite interfacial region 90. First electrode assembly 100a and/or second electrode assembly 100b may be replaced by any of the electrode assemblies of the present disclosure, for example those disclosed in FIGS. 1B, 1D, 1F, 1H, 1J, 1L and 1N. Membrane-electrode assembly 200b may further include one or more optional release liner 30, 32. Conventional release liners known in the art may be used for optional release liners 30 and 32.

The membrane-electrode assemblies of the present disclosure may further include a first adhesive layer disposed between the ion permeable membrane and at least one of the porous electrode and the discontinuous transport protection layer of a first electrode assembly (e.g. disposed between the first surface of an ion permeable membrane and the discontinuous transport protection layer of a first electrode assembly), wherein the first adhesive layer is disposed along the perimeter of the membrane-electrode assembly, e.g. at least a portion of the first adhesive layer is disposed along the perimeter of the membrane-electrode assembly. In some embodiments, the first adhesive layer may be in contact with at least one of or both the first surface of the ion permeable membrane and the discontinuous transport protection layer of a first electrode assembly. In some embodiments, the first adhesive layer may be in contact with at least one of or both the first surface of the ion permeable membrane and the porous electrode of a first electrode assembly. The membrane-electrode assemblies of the present disclosure may, optionally, include a second adhesive layer and a second electrode assembly, wherein the second adhesive layer is disposed between the ion permeable membrane and at least one of the porous electrode and the discontinuous transport protection layer of the second electrode assembly (e.g. disposed between the second surface of the ion permeable membrane and the discontinuous transport protection layer of a second electrode assembly), wherein the second adhesive layer is disposed along the perimeter of the membrane-electrode assembly, e.g. at least a portion of the second adhesive layer is disposed along the perimeter of the membrane-electrode assembly. In some embodiments, the second adhesive layer may be in contact with at least one of or both the second surface of the ion permeable membrane and the discontinuous transport protection layer of the second electrode assembly. In some embodiments, the second adhesive layer may be in contact with at least one of or both the second surface of the ion permeable membrane and the porous electrode of the second electrode assembly. In some embodiments, the first and/or second adhesive layer is disposed along the perimeter of the membrane-electrode assembly but does not extend to the peripheral edge of first electrode assembly and/or second electrode assembly, respectively.

The first adhesive layer and/or second adhesive layer may be in the shape of an annulus, i.e. an annular shaped first adhesive layer and/or an annular shaped second adhesive layer. The term “annulus” and/or “annular” is generally used to describe a ring shaped object bounded by two concentric circles. In some embodiments, the first and/or second adhesive layer is disposed along the perimeter of the membrane-electrode assembly but does not extend into the center portion of first electrode assembly and/or second electrode assembly, respectively. However, in the present disclosure, the term “annulus” and/or “annular” will refer to a ring shaped objected. The shape of the annulus is not particularly limited and may include, but is not limited to, a circle, square, rectangle, triangle, oval and diamond. The adhesive layers may be disposed along the perimeter of the membrane-electrode assembly. In some embodiments, one or more of the adhesive layers, e.g. first adhesive layer and second adhesive layer, may be disposed along the perimeter of the membrane-electrode assembly and be a series of discontinuous lines or strips. In some embodiments, one or more of the adhesive layers e.g. first adhesive layer and second adhesive layer, may be disposed along the perimeter of the membrane-electrode assembly and include two adhesive regions, e.g. two discrete adhesive lines, on opposite sides of the membrane-electrode assembly perimeter.

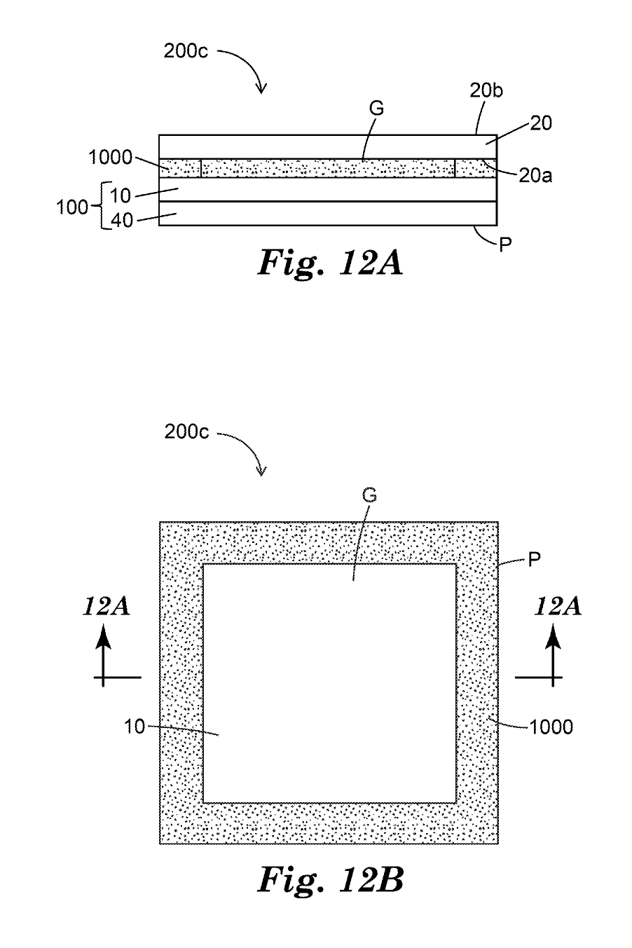

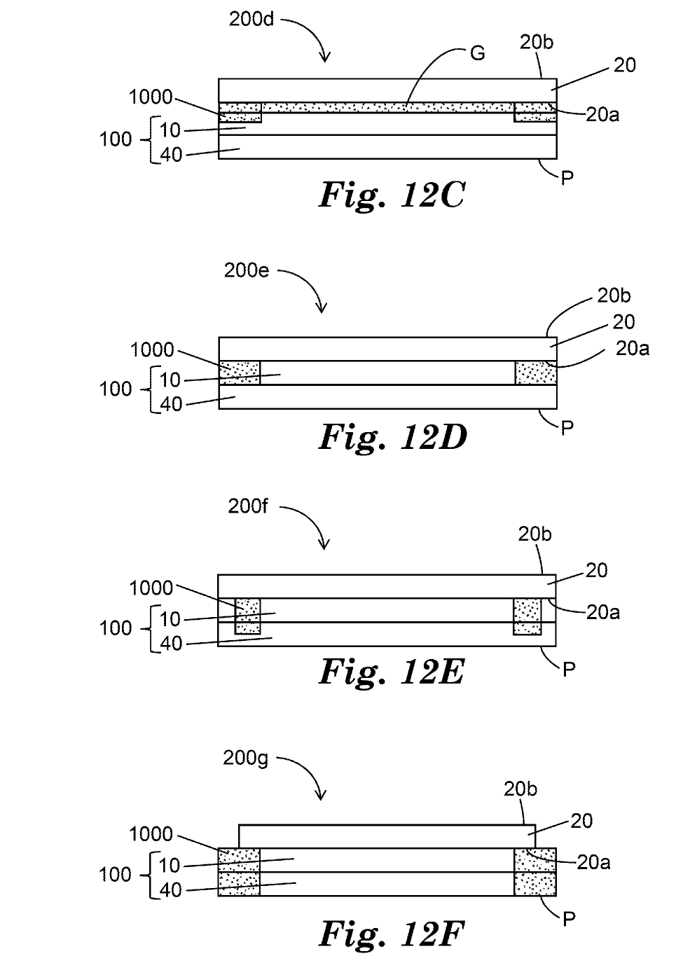

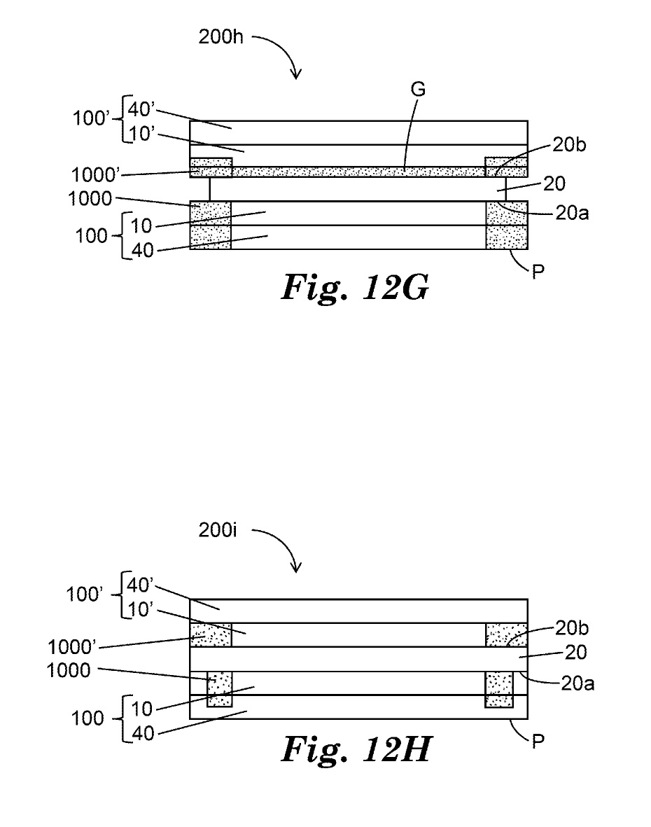

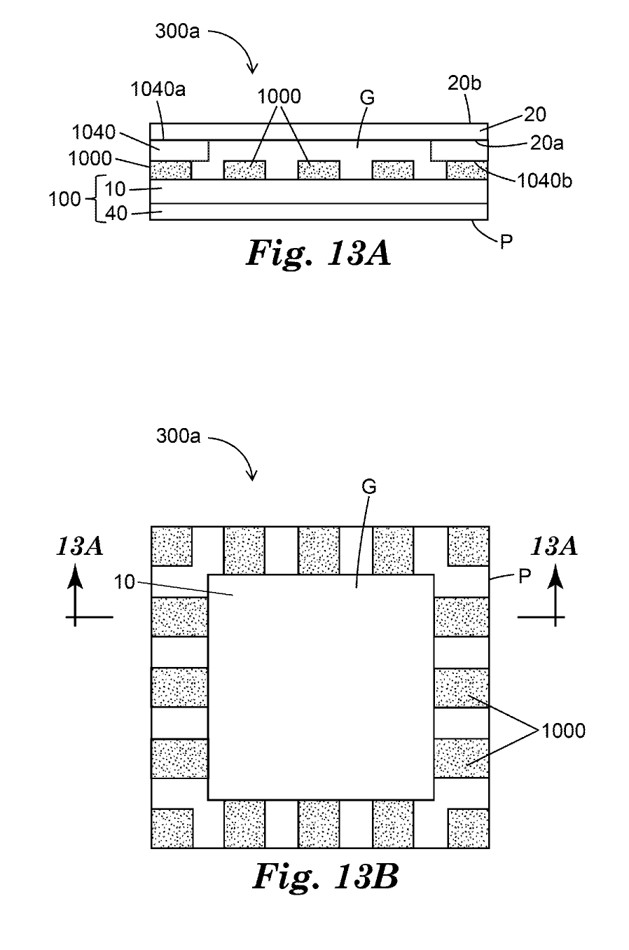

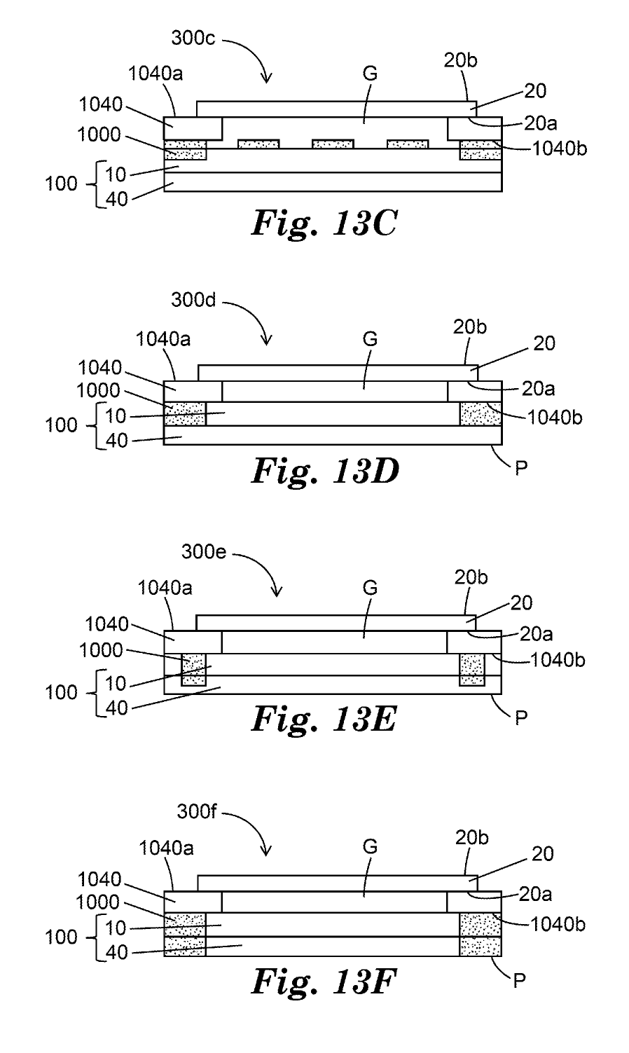

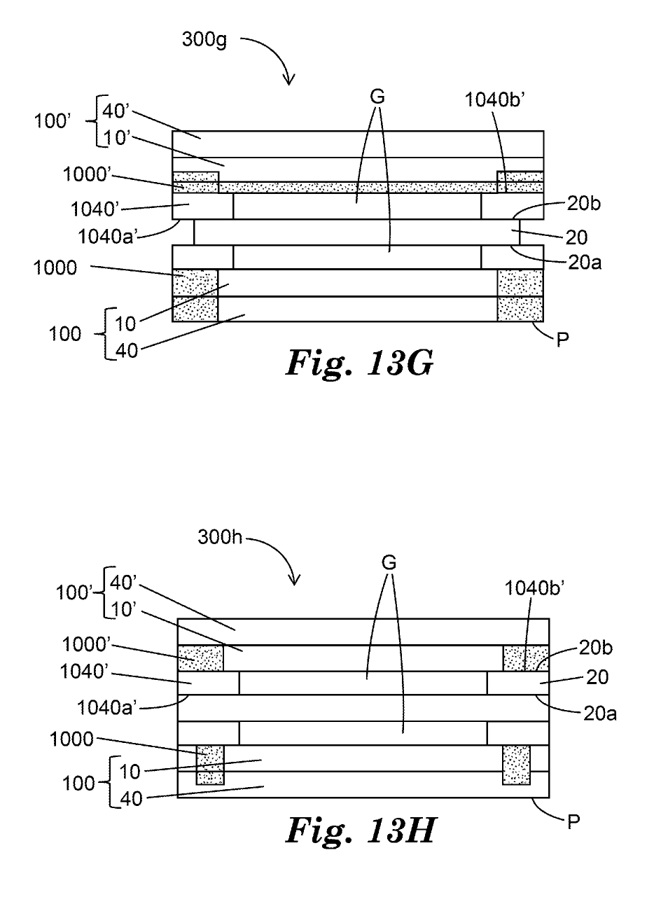

In some embodiments, the first and/or the second adhesive layer is disposed in an annular shaped region along or near the perimeter of the membrane-electrode assembly and the interior of the annular shaped region is free of the first and/or the second adhesive layer, respectively. In some embodiments, at least a portion of the first adhesive layer and/or at least a portion of second adhesive layer may be embedded in the discontinuous transport protection layer of the first electrode assembly and/or second electrode assembly, respectively. In some embodiments, substantially the entire first adhesive layer and/or substantially the entire second adhesive layer may be embedded in the discontinuous transport protection layer of the first electrode assembly and/or second electrode assembly, respectively. By “substantially the entire” it is meant that at least 80 percent, at least 90 percent, at least 95 percent at least 99 or even at least 100 percent of the volume of the first adhesive layer is embedded in the indicated layer or layers. In some embodiments, at least a portion of the first adhesive layer and/or at least a portion of second adhesive layer may be embedded in the discontinuous transport protection layer and the porous electrode of the first electrode assembly and/or second electrode assembly, respectively. In some embodiments, substantially the entire first adhesive layer and/or substantially the entire second adhesive layer, may be embedded in the discontinuous transport protection layer and the porous electrode of the first electrode assembly and/or second electrode assembly, respectively. The first adhesive layer and/or second adhesive layer may be a continuous adhesive layer, as shown in for example FIG. 12B, first adhesive layer 1000. The first adhesive layer and/or second adhesive layer may be a discontinuous adhesive layer, as shown in for example FIG. 13B, first adhesive layer 1000. In some embodiments, the first adhesive layer and/or second adhesive layer may be a discontinuous adhesive layer comprising two adhesive regions, a first adhesive region and a second adhesive region, located along the perimeter of the membrane-electrode assembly, wherein the first adhesive region is opposite the second adhesive region, i.e. the first adhesive region is located along a portion of the perimeter opposite the portion of the perimeter where the second adhesive region is located. The membrane-electrode assemblies may be integral structures. In some embodiments, the electrode assembly and the ion permeable membrane form an integral structure. The first adhesive layer may be used to adhere the first electrode assembly to the ion permeable membrane, such that, the first electrode assembly and ion permeable membrane form an integral structure and; if present, the second adhesive layer may be used to adhere the second electrode assembly to the ion permeable membrane, such that, the second electrode assembly and ion permeable membrane form an integral structure. The first and second electrode assemblies may be any of the electrode assemblies of the present disclosure, for example, electrode assemblies 100a through 100g of FIGS. 1A through 1N.

In the present disclosure, with respect to an adhesive layer, e.g. a first adhesive layer and/or a second adhesive layer, and a discontinues transport protection layer, e.g. a discontinues transport protection layer of a first and/or second electrode assembly, the phrase “adhesive layer disposed between the ion permeable membrane and the discontinuous transport protection layer of an electrode assembly” includes the embodiments wherein at least a portion of the adhesive layer, up to including substantially all of the adhesive layer, is embedded in the electrode assembly (embedded in the discontinuous transport protection layer or both the discontinuous transport protection layer and porous electrode of the electrode assembly) and/or the ion permeable membrane. In some embodiments, the ion permeable membrane is a solid film free of adhesive layer embedded therein, i.e. the ion permeable membrane does not include porosity, and therefore the adhesive layer is incapable of embedding therein.

FIG. 12A is a schematic cross-sectional side view, through line 12A of FIG. 12B, of an exemplary membrane-electrode assembly according to one exemplary embodiment of the present disclosure. FIG. 12A shows membrane-electrode assembly 200c, including first electrode assembly 100, which includes discontinuous transport protection layer 10 and porous electrode 40; ion permeable membrane 20 having a first surface 20a and an opposed second surface 20b; and first adhesive layer 1000 disposed between first surface 20a of ion permeable membrane 20 and discontinuous transport protection layer 10 of first electrode assembly 100. First adhesive layer 1000 is disposed along the perimeter, P, of the membrane-electrode assembly. In this exemplary embodiment, first adhesive layer 1000 is in contact with both the first surface 20a of ion permeable membrane 20 and discontinuous transport protection layer 10 of first electrode assembly 100. In this exemplary embodiment, first adhesive layer 1000 is a continuous adhesive layer. In this exemplary embodiment, first adhesive layer 1000 has an annular shape, i.e. is in the shape of an approximately square shaped annulus. The central portion of the annular shaped first adhesive layer forms gap, G, in the membrane-electrode assembly. FIG. 12B is a schematic top view in the plane of the adhesive layer (a plane which would be perpendicular to the page with respect to FIG. 12A) of the exemplary membrane-electrode assembly of FIG. 12A, according to one exemplary embodiment of the present disclosure. FIG. 12B shows first adhesive layer 1000 disposed along perimeter, P, of membrane-electrode assembly 200c. During use, in an electrochemical cell which is typically under compression, gap, G, may be compressed or eliminated altogether or may be at least partially filled with at least one of the ion permeable membrane and the discontinuous transport protection layer of the electrode assembly.

FIGS. 12C through 12F are a schematic cross-sectional side views of exemplary membrane-electrode assemblies according to exemplary embodiments of the present disclosure. FIGS. 12C through 12F are similar to FIG. 12A, as previously described, except for modifications to the adhesive layer as discussed below. FIG. 12C is a schematic cross-sectional side view of an exemplary membrane-electrode assembly 200d. Membrane-electrode assembly 200d includes first adhesive layer 1000. First adhesive layer 1000 is disposed between first surface 20a of ion permeable membrane 20 and discontinuous transport protection layer 10 of first electrode assembly 100. In this exemplary embodiment, first adhesive layer 1000 is in contact with both first surface 20a of the ion permeable membrane 20 and discontinuous transport protection layer 10 of first electrode assembly 100. At least a portion of the first adhesive layer 1000 is embedded in the discontinuous transport protection layer 10 of first electrode assembly 100. As a portion of the first adhesive layer 1000 is embedded in the discontinuous transport protection layer 100, gap, G, decreases somewhat, compared to FIG. 12A, according to this exemplary embodiment. If one desired to maintain the thickness of gap, G, similar to that of FIG. 12A, the thickness of first adhesive layer 1000 could be increased to account for the portion of adhesive layer 1000 embedded in discontinuous transport protection layer 100. In FIG. 12C, first adhesive layer is diagramed as being embedded only through a portion of the thickness of discontinuous transport protection layer 10. However, this is not a particular limitation and first adhesive layer 1000 may be embedded through substantially the entire thickness of discontinuous transport protection layer 10 (see FIG. 12D); through substantially the entire thickness of discontinuous transport protection layer 10 and partially through the thickness of porous electrode 40 (see FIG. 12E) or through substantially the entire thickness of discontinuous transport protection layer 10 and through substantially the entire thickness of porous electrode 40 (see FIG. 12F). The phrase “may be embedded through substantially the entire thickness” is meant to include that at least 80 percent, at least 90 percent, at least 95 percent at least 99 or even at least 100 percent of the thickness of the layer has been embedded with adhesive.

FIG. 12D is a schematic cross-sectional side view of an exemplary membrane-electrode assembly 200e. Membrane-electrode assembly 200e includes first adhesive layer 1000. First adhesive layer 1000 is disposed between ion permeable membrane 20 and discontinuous transport protection layer 10 of first electrode assembly 100. In this exemplary embodiment, first adhesive layer 1000 is in contact with both the first surface 20a of ion permeable membrane 20 and discontinuous transport protection layer 10 of first electrode assembly 100. At least a portion of first adhesive layer 1000 is embedded in discontinuous transport protection layer 10 of first electrode assembly 100. In this exemplary embodiment, substantially the entire first adhesive layer 1000 is embedded in the discontinuous transport protection layer 10 of first electrode assembly 100. As substantially the entire first adhesive layer 1000 is embedded in discontinuous transport protection layer 10, gap, G, is very thin or is no longer present, compared to FIG. 12A. If one desired to maintain the thickness of gap, G, similar to that of FIG. 12A, the thickness of first adhesive layer 1000 could be increased. In this exemplary embodiment, first adhesive layer 1000 is embedded through substantially the entire thickness of discontinuous transport protection layer 10. In the embodiment of, for example, FIG. 12D, the adhesive layer may act as a gasket, sealing the perimeter of the discontinuous transport protection layer.

In an alternative embodiment, the transport protection layer may be designed such that it is not present along the perimeter of the membrane-electrode assembly. In this embodiment, the adhesive layer may be disposed between the ion permeable membrane and the porous electrode of the electrode assembly and the adhesive layer is along the perimeter of the membrane-electrode assembly. The interior region of the adhesive layer is a void in which the transport protection layer may reside. An embodiment such as this is shown in FIG. 12D, if the adhesive layer 1000 is taken as a separate layer that is not embedded in the discontinuous transport protection layer 10 and discontinuous transport protection layer 10 is located in the interior region of the adhesive layer. In this embodiment, the adhesive layer would be disposed between the ion permeable membrane and the porous electrode of the electrode assembly. In this embodiment, the adhesive layer may also act as a gasket, sealing the perimeter of the discontinuous transport protection layer.

FIG. 12E is a schematic cross-sectional side view of an exemplary membrane-electrode assembly 200f. Membrane-electrode assembly 200f includes first adhesive layer 1000. First adhesive layer 1000 is disposed between ion permeable membrane 20 and discontinuous transport protection layer 10 of first electrode assembly 100. In this exemplary embodiment, first adhesive layer 1000 is in contact with both the first surface 20a of ion permeable membrane 20 and discontinuous transport protection layer 10 of first electrode assembly 100. At least a portion of the first adhesive layer 1000 is embedded in discontinuous transport protection layer 10 and porous electrode 40 of first electrode assembly 100. In this exemplary embodiment, substantially the entire first adhesive layer 1000 is embedded in discontinuous transport protection layer 10 and porous electrode 40 of first electrode assembly 100. As Substantially the entire first adhesive layer 1000 is embedded in the discontinuous transport protection layer 100, gap, G, is very thin or is no longer present, compared to FIG. 12A. If one desired to maintain the thickness of gap, G, similar to that of FIG. 12A, the thickness of first adhesive layer 1000 could be increased. In this exemplary embodiment, first adhesive layer 1000 is disposed along perimeter, P, of membrane-electrode assembly 200f However, in this exemplary embodiment, first adhesive layer 1000 does not extend to the peripheral edge of membrane-electrode assembly 200f. This configuration may be used in any of the membrane-electrode assemblies of the present disclosure. In this exemplary embodiment, first adhesive layer 1000 is embedded through substantially the entire thickness of discontinuous transport protection layer 10 and partially through the thickness of porous electrode 40. In the embodiment of, for example, FIG. 12E, the adhesive layer may act as a gasket, sealing the perimeter of the discontinuous transport protection layer.

FIG. 12F is a schematic cross-sectional side view of an exemplary membrane-electrode assembly 200g. Membrane-electrode assembly 200g includes first adhesive layer 1000. First adhesive layer 1000 is disposed between ion permeable membrane 20 and discontinuous transport protection layer 10 of first electrode assembly 100. In this exemplary embodiment, first adhesive layer 1000 is in contact with both the first surface 20a of ion permeable membrane 20 and discontinuous transport protection layer 10 of first electrode assembly 100. At least a portion of the first adhesive layer 1000 is embedded in discontinuous transport protection layer 10 and porous electrode 40 of first electrode assembly 100. In this exemplary embodiment, substantially the entire first adhesive layer 1000 is embedded in discontinuous transport protection layer 10 and porous electrode 40 of first electrode assembly 100. As substantially the entire first adhesive layer 1000 is embedded in the discontinuous transport protection layer 100, gap, G, is very thin or is no longer present, compared to FIG. 12A. If one desired to maintain the thickness of gap, G, similar to that of FIG. 12A, the thickness of first adhesive layer 1000 could be increased. In this exemplary embodiment, first adhesive layer 1000 is embedded through substantially the entire thickness of discontinuous transport protection layer 10 and through substantially the entire thickness of porous electrode 40. In the embodiment of, for example, FIG. 12F, the adhesive layer may act as a gasket, sealing the perimeter of at least one or both of the discontinuous transport protection layer and the porous electrode.

FIGS. 12G and 12H are a schematic cross-sectional side views of exemplary membrane-electrode assemblies according to exemplary embodiments of the present disclosure. The membrane-electrode assembly 200h of FIG. 12G is similar to membrane-electrode assembly 200g of FIG. 12F, as previously described, except membrane-electrode assembly 200h further includes a second adhesive layer 1000′ disposed between the second surface 20b of ion permeable membrane 20 and discontinuous transport protection layer 10′ of a second electrode assembly 100′, wherein the second adhesive layer is disposed along the perimeter of the membrane-electrode assembly. In this exemplary embodiment, second adhesive layer 1000′ is in contact with both the second surface 20b of ion permeable membrane 20 and discontinuous transport protection layer 10′ of a second electrode assembly 100′. The membrane-electrode assembly 200i of FIG. 12H is similar to membrane-electrode assembly 200f of FIG. 12E, as previously described, except membrane-electrode assembly 200i further includes a second adhesive layer 1000′ disposed between the second surface 20b of ion permeable membrane 20 and discontinuous transport protection layer 10′ of a second electrode assembly 100′, wherein the second adhesive layer is disposed along the perimeter of the membrane-electrode assembly. In this exemplary embodiment, second adhesive layer 1000′ is in contact with both the second surface 20b of ion permeable membrane 20 and discontinuous transport protection layer 10′ of a second electrode assembly 100′. Any of the previously described membrane-electrode assemblies that include a single adhesive layer, for example, membrane-electrode assemblies described in FIGS. 12A through 12F may be used to form membrane-electrode assemblies that include two adhesive layers and two electrode assemblies, similar to those shown in FIGS. 12G and 12H.

The membrane-electrode assemblies of the present disclosure may further include a first gasket disposed between the ion permeable membrane and the first adhesive layer (i.e. disposed between the first surface of the ion permeable membrane and the first adhesive layer), wherein the first gasket is disposed along the perimeter of the membrane-electrode assembly. The first gasket may be in contact with at least one of or both the first surface of the ion permeable membrane and the first adhesive layer. The membrane-electrode assemblies of the present disclosure may, optionally, include a second gasket disposed between the ion permeable membrane and a second adhesive layer (i.e. disposed between the second surface of the ion permeable membrane and the second adhesive layer), wherein the second gasket is disposed along the perimeter of the membrane-electrode assembly. The second gasket may be in contact with at least one of or both the second surface of the ion permeable membrane and the second adhesive layer. In some embodiments, the first and/or second adhesive layer is disposed along the perimeter of the membrane-electrode assembly but does not extend to the peripheral edge of first electrode assembly and/or second electrode assembly, respectively. The first and/or second gasket may be in the shape of an annulus, i.e. an annular shaped first gasket and/or an annular shaped second gasket. The term “annulus” and/or “annular” is generally used to describe a ring shaped object bounded by two concentric circles. However, in the present disclosure, the term “annulus” and/or “annular” will refer to a ring shaped objected. The shape of the annulus is not particularly limited and may include, but is not limited to, a circle, square, rectangle, triangle, oval and diamond.

FIG. 13A is a schematic cross-sectional side view, through line 13A of FIG. 13B, of an exemplary membrane-electrode assembly according to one exemplary embodiment of the present disclosure. FIG. 13A shows membrane-electrode assembly 300a, including first electrode assembly 100, which includes discontinuous transport protection layer 10 and porous electrode 40; ion permeable membrane 20 having a first surface 20a and an opposed second surface 20b; first adhesive layer 1000; and first gasket 1040, having first surface 1040a and opposed second surface 1040b, disposed between first surface 20a of ion permeable membrane 20 and first adhesive layer 1000. First adhesive layer 1000 is disposed along the perimeter, P, of the membrane-electrode assembly. In this exemplary embodiment, first surface 1040a of first gasket 1040 is in contact with first surface 20a of ion permeable membrane 20 and second surface 1040b of first gasket 1040 is in contact with first adhesive layer 1000. In this exemplary embodiment, first adhesive layer 1000 is in contact with second surface 1040b of first gasket 1040 and discontinuous transport protection layer 10 of first electrode assembly 100. Additionally, in this exemplary embodiment, first adhesive layer 1000 is a discontinuous adhesive layer, e.g. a series of discrete regions of adhesive. In this exemplary embodiment, first gasket 1040 has an annular shape, i.e. it is in the shape of an approximately square shaped annulus. The central portion of the annular shaped first gasket forms gap, G, in the membrane-electrode assembly. FIG. 13B is a schematic top view in the plane of the adhesive layer of the exemplary membrane-electrode assembly of FIG. 13A, according to one exemplary embodiment of the present disclosure. FIG. 13B shows first adhesive layer 1000 disposed along perimeter, P, of membrane-electrode assembly 300a. The square shaped dashed line is an imaginary line that represents the interior edge of first gasket 1040 and provides a perspective of the annular shape and the position of first gasket 1040.

FIGS. 13C through 13F are a schematic cross-sectional side views of exemplary membrane-electrode assemblies according to exemplary embodiments of the present disclosure. FIGS. 13C through 13F are similar to FIG. 13A, as previously described, except for modifications to the adhesive layer as discussed below. FIG. 13C is a schematic cross-sectional side view of exemplary membrane-electrode assembly 300c. Membrane-electrode assembly 300c includes first adhesive layer 1000. First adhesive layer 1000 is disposed between first gasket 1040 and discontinuous transport protection layer 10 of first electrode assembly 100. In this exemplary embodiment, first adhesive layer 1000 is in contact with both second surface 1040b of first gasket 1040 and discontinuous transport protection layer 10 of first electrode assembly 100. At least a portion of the first adhesive layer 1000 is embedded in the discontinuous transport protection layer 10 of first electrode assembly 100. As a portion of the first adhesive layer 1000 is embedded in the discontinuous transport protection layer 100, gap, G, decreases somewhat, compared to FIG. 13A, according to this exemplary embodiment. If one desired to maintain the thickness of gap, G, similar to that of FIG. 13A, the thickness of first adhesive layer 1000 could be increased to account for the portion of adhesive layer 1000 embedded in discontinuous transport protection layer 100. In FIG. 13A, first adhesive layer is diagramed as being embedded only through a portion of the thickness of discontinuous transport protection layer 10. However, this is not a particular limitation and first adhesive layer 1000 may be embedded through substantially the entire thickness of discontinuous transport protection layer 10 (see FIG. 13D); through the substantially the entire thickness of discontinuous transport protection layer 10 and partially through the thickness of porous electrode 40 (see FIG. 13E) or through substantially the entire thickness of discontinuous transport protection layer 10 and through substantially the entire thickness of porous electrode 40 (see FIG. 13F). The phrase “may be embedded through substantially the entire thickness” is meant to include that at least 80 percent, at least 90 percent, at least 95 percent at least 99 or even at least 100 percent of the thickness of the layer has been embedded with adhesive.

FIG. 13D is a schematic cross-sectional side view of an exemplary membrane-electrode assembly 300d. Membrane-electrode assembly 300d includes first adhesive layer 1000. First adhesive layer 1000 is disposed between first gasket 1040 and discontinuous transport protection layer 10 of first electrode assembly 100. In this exemplary embodiment, first adhesive layer 1000 is in contact with both second surface 1040b of first gasket 1040 and discontinuous transport protection layer 10 of first electrode assembly 100. At least a portion of first adhesive layer 1000 is embedded in discontinuous transport protection layer 10 of first electrode assembly 100. In this exemplary embodiment, substantially the entire first adhesive layer 1000 is embedded in the discontinuous transport protection layer 10 of first electrode assembly 100. As substantially the entire first adhesive layer 1000 is embedded in discontinuous transport protection layer 10, gap, G, is very thin or is no longer present, compared to FIG. 13A. If one desired to maintain the thickness of gap, G, similar to that of FIG. 13A, the thickness of first adhesive layer 1000 could be increased. In this exemplary embodiment, first adhesive layer 1000 is embedded through substantially the entire thickness of discontinuous transport protection layer 10.

FIG. 13E is a schematic cross-sectional side view of an exemplary membrane-electrode assembly 300e. Membrane-electrode assembly 300e includes first adhesive layer 1000. First adhesive layer 1000 is disposed between first gasket 1040 and discontinuous transport protection layer 10 of first electrode assembly 100. In this exemplary embodiment, first adhesive layer 1000 is in contact with both the second surface 1040b of first gasket 1040 and discontinuous transport protection layer 10 of first electrode assembly 100. At least a portion of the first adhesive layer 1000 is embedded in discontinuous transport protection layer 10 and porous electrode 40 of first electrode assembly 100. In this exemplary embodiment, substantially the entire first adhesive layer 1000 is embedded in discontinuous transport protection layer 10 and porous electrode 40 of first electrode assembly 100. As substantially the entire first adhesive layer 1000 is embedded in the discontinuous transport protection layer 100, gap, G, is very thin or is no longer present, compared to FIG. 13A. If one desired to maintain the thickness of gap, G, similar to that of FIG. 13A, the thickness of first adhesive layer 1000 could be increased. In this exemplary embodiment, first adhesive layer 1000 is disposed along perimeter, P, of membrane-electrode assembly 300e. However, in this exemplary embodiment, first adhesive layer 1000 does not extend to the peripheral edge of membrane-electrode assembly 200f. This configuration may be used in any of the membrane-electrode assemblies of the present disclosure. In this exemplary embodiment, first adhesive layer 1000 is embedded through substantially the entire thickness of discontinuous transport protection layer 10 and partially through the thickness of porous electrode 40.

FIG. 13F is a schematic cross-sectional side view of an exemplary membrane-electrode assembly 300f. Membrane-electrode assembly 300f includes first adhesive layer 1000. First adhesive layer 1000 is disposed between first gasket 1040 and discontinuous transport protection layer 10 of first electrode assembly 100. In this exemplary embodiment, first adhesive layer 1000 is in contact with both the second surface 1040b of first gasket 1040 and discontinuous transport protection layer 10 of first electrode assembly 100. At least a portion of the first adhesive layer 1000 is embedded in discontinuous transport protection layer 10 and porous electrode 40 of first electrode assembly 100. In this exemplary embodiment, substantially the entire first adhesive layer 1000 is embedded in discontinuous transport protection layer 10 and porous electrode 40 of first electrode assembly 100. As substantially the entire first adhesive layer 1000 is embedded in the discontinuous transport protection layer 100, gap, G, is very thin or is no longer present, compared to FIG. 13A. If one desired to maintain the thickness of gap, G, similar to that of FIG. 13A, the thickness of first adhesive layer 1000 could be increased. In this exemplary embodiment, first adhesive layer 1000 is embedded through substantially the entire thickness of discontinuous transport protection layer 10 and through substantially the entire thickness of porous electrode 40.

FIGS. 13G and 13H are a schematic cross-sectional side views of exemplary membrane-electrode assemblies according to exemplary embodiments of the present disclosure. The membrane-electrode assembly 300g of FIG. 13G is similar to membrane-electrode assembly 300f of FIG. 13F, as previously described, except membrane-electrode assembly 200h further includes second electrode assembly 100′, which includes discontinuous transport protection layer 10′ and porous electrode 40′; second adhesive layer 1000′; and second gasket 1040′, having first surface 1040a′ and opposed second surface 1040b′, disposed between second surface 20b of ion permeable membrane 20 and second adhesive layer 1000′. Second adhesive layer 1000′ is disposed along the perimeter, P, of the membrane-electrode assembly. In this exemplary embodiment, first surface 1040a′ of second gasket 1040′ is in contact with second surface 20b of ion permeable membrane 20 and second surface 1040b′ of second gasket 1040′ is in contact with second adhesive layer 1000′. In this exemplary embodiment, second adhesive layer 1000′ is in contact with second surface 1040b′ of second gasket 1040′ and discontinuous transport protection layer 10′ of second electrode assembly 100′.

The membrane-electrode assembly 300h of FIG. 13H is similar to membrane-electrode assembly 300e of FIG. 13E, as previously described, except membrane-electrode assembly 300h further includes second electrode assembly 100′, which includes discontinuous transport protection layer 10′ and porous electrode 40′; second adhesive layer 1000′; and second gasket 1040′, having first surface 1040a′ and opposed second surface 1040b′, disposed between second surface 20b of ion permeable membrane 20 and second adhesive layer 1000′. Second adhesive layer 1000′ is disposed along the perimeter, P, of the membrane-electrode assembly. In this exemplary embodiment, first surface 1040a′ of second gasket 1040′ is in contact with second surface 20b of ion permeable membrane 20 and second surface 1040b′ of second gasket 1040′ is in contact with second adhesive layer 1000′. In this exemplary embodiment, second adhesive layer 1000′ is in contact with second surface 1040b′ of second gasket 1040′ and discontinuous transport protection layer 10′ of second electrode assembly 100′. Any of the previously described membrane-electrode assemblies that include a single adhesive layer, for example, membrane-electrode assemblies described in FIGS. 13A through 13F may be used to form membrane-electrode assemblies that include two adhesive layers and two electrode assemblies, similar to those shown in FIGS. 13G and 13H.

Throughout this disclosure, various components of the membrane-electrode assembly, e.g. adhesive layers and gasket layers, have included a “gap”. During actual use, within an electrochemical cell or liquid flow battery, one or more of the gaps, up to including all the gaps, may be decreased in thickness or eliminated completely, due to the forces, e.g. compression forces, applied to the membrane-electrode assembly during the assembly of an electrochemical cell or liquid flow battery.

Membrane-electrode assemblies that include at least one gasket in contact with the ion permeable membrane, for example the membrane-electrode assemblies described in FIGS. 13A-13G, may be integral structures. In some embodiments, the gasket may be laminated to the ion permeable membrane, under heat and or pressure, if required, such that the electrode assembly and ion permeable membrane form an integral structure. In some embodiments, the gasket may be adhered to the membrane electrode assembly through a third adhesive layer (not shown in FIGS. 13A-13H), such that the electrode assembly and ion permeable membrane form an integral structure.

In other embodiments, the membrane-electrode assemblies of the present disclosure may include a first adhesive layer disposed between the ion permeable membrane and at least one of the porous electrode and the discontinuous transport protection layer of a first electrode assembly (e.g. disposed between the first surface of an ion permeable membrane and the discontinuous transport protection layer of a first electrode assembly), wherein the first adhesive layer is a plurality of first adhesive regions disposed at least within the interior of the membrane-electrode assembly and wherein the area of the first plurality of adhesive regions, in the plane of the membrane electrode assembly, is less than at least 50 percent of the projected area of the membrane electrode assembly. In some embodiments, the area of the first plurality of adhesive regions, in the plane of the membrane electrode assembly, is less than at least 50 percent, less than at least 40 percent less than at least 30 percent, less than at least 20 percent, less than at least 10 percent or even less than at least 5 percent of the projected area of the membrane electrode assembly. By “within the interior” it is meant the interior with respect to the plane of the membrane-electrode assembly, i.e. the interior region as opposed to the perimeter region. In some embodiments, the first adhesive layer may be in contact with at least one of or both the first surface of the ion permeable membrane and the discontinuous transport protection layer of the first electrode assembly. In some embodiments, the first adhesive layer may be in contact with at least one of or both the first surface of the ion permeable membrane and the porous electrode of the first electrode assembly. The membrane-electrode assemblies of the present disclosure may, optionally, include a second adhesive layer and a second electrode assembly, wherein the second adhesive layer is disposed between the ion permeable membrane and at least one of the porous electrode and the discontinuous transport protection layer of a second electrode assembly (e.g. disposed between the second surface of the ion permeable membrane and the discontinuous transport protection layer of a second electrode assembly), wherein the second adhesive layer is a plurality of second adhesive regions disposed at least within the interior of the membrane-electrode assembly and wherein the area of the second plurality of adhesive regions, in the plane of the membrane electrode assembly, is less than at least 50 percent of the projected area of the membrane electrode assembly. In some embodiments, the area of the second plurality of adhesive regions, in the plane of the membrane electrode assembly, is less than at least 50 percent, less than at least 40 percent less than at least 30 percent, less than at least 20 percent, less than at least 10 percent or even less than at least 5 percent of the projected area of the membrane electrode assembly. In some embodiments, the second adhesive layer may be as described in any one of FIGS. 12A-12H and FIGS. 13A-13H. In some embodiments, the second adhesive layer may be in contact with at least one of or both the second surface of the ion permeable membrane and the discontinuous transport protection layer of the second electrode assembly. In some embodiments, the second adhesive layer may be in contact with at least one of or both the second surface of the ion permeable membrane and the porous electrode of the second electrode assembly. In some embodiments, the first and/or second adhesive layer is disposed along the perimeter of the membrane-electrode assembly but does not extend to the peripheral edge of first electrode assembly and/or second electrode assembly, respectively. In some embodiments, at least a portion of the first adhesive layer and/or at least a portion of second adhesive layer may be embedded in the discontinuous transport protection layer of the first electrode assembly and/or second electrode assembly, respectively. In some embodiments, substantially the entire first adhesive layer and/or substantially the entire second adhesive layer may be embedded in the discontinuous transport protection layer of the first electrode assembly and/or second electrode assembly, respectively. By “substantially the entire” it is meant that at least 80 percent, at least 90 percent, at least 95 percent at least 99 or even at least 100 percent of the volume of the first adhesive layer is embedded in the indicated layer or layers. In some embodiments, at least a portion of the first adhesive layer and/or at least a portion of second adhesive layer may be embedded in the discontinuous transport protection layer and the porous electrode of the first electrode assembly and/or second electrode assembly, respectively. In some embodiments, substantially the entire first adhesive layer and/or substantially the entire second adhesive layer, may be embedded in the discontinuous transport protection layer and the porous electrode of the first electrode assembly and/or second electrode assembly, respectively.

The membrane-electrode assemblies, which include a first adhesive layer comprising a plurality of first adhesive regions disposed at least within the interior of the membrane-electrode assembly and wherein the area of the first plurality of adhesive regions, in the plane of the membrane electrode assembly, is less than at least 50 percent of the projected area of the membrane electrode assembly, may further include a first gasket and, optionally a second gasket, similar to the membrane-electrode assemblies previously described in FIGS. 13A-13H. The membrane-electrode assemblies may further include a first gasket disposed between the ion permeable membrane and the first adhesive layer (i.e. disposed between the first surface of the ion permeable membrane and the first adhesive layer) or the discontinuous transport protection layer. As the first gasket is generally annular in shape and positioned along the perimeter, P, of the membrane-electrode assembly, the first gasket may be disposed between the first surface of the ion permeable membrane and the first adhesive layer, if the first adhesive layer extends to and is disposed along perimeter of the membrane-electrode assembly, i.e. the first gasket and first adhesive layer overlap. If the first gasket and first adhesive layer do not overlap, the first gasket may be disposed between the first surface of the ion permeable membrane and the discontinuous transport protection layer of the first electrode assembly. The first gasket may be in contact with at least one of or both the first surface of the ion permeable membrane and the discontinuous transport protection layer of the first electrode assembly. The first gasket may be in contact with at least one of or both the first surface of the ion permeable membrane and the first adhesive layer. The membrane-electrode assemblies of the present disclosure may, optionally, include a second gasket disposed between the ion permeable membrane and a second adhesive layer (i.e. disposed between the second surface of the ion permeable membrane and the second adhesive layer) or a discontinuous transport protection layer of a second electrode-assembly. As the second gasket is generally annular in shape and positioned along the perimeter, P, of the membrane-electrode assembly, the second gasket may be disposed between the second surface of the ion permeable membrane and the second adhesive layer, if the second adhesive layer extends to and is disposed along perimeter of the membrane-electrode assembly, i.e. the second gasket and second adhesive layer overlap. If the second gasket and second adhesive layer do not overlap, the second gasket may be disposed between the second surface of the ion permeable membrane and the discontinuous transport protection layer of the second electrode assembly. The second gasket may be in contact with at least one of or both the second surface of the ion permeable membrane and the discontinuous transport protection layer of the second electrode assembly. The second gasket may be in contact with at least one of or both the second surface of the ion permeable membrane and the second adhesive layer. The first and/or second gasket may be in the shape of an annulus, as previously described. The first and second electrode assemblies may be any of the electrode assemblies of the present disclosure, for example, electrode assemblies 100a through 100g of FIGS. 1A through 1N.

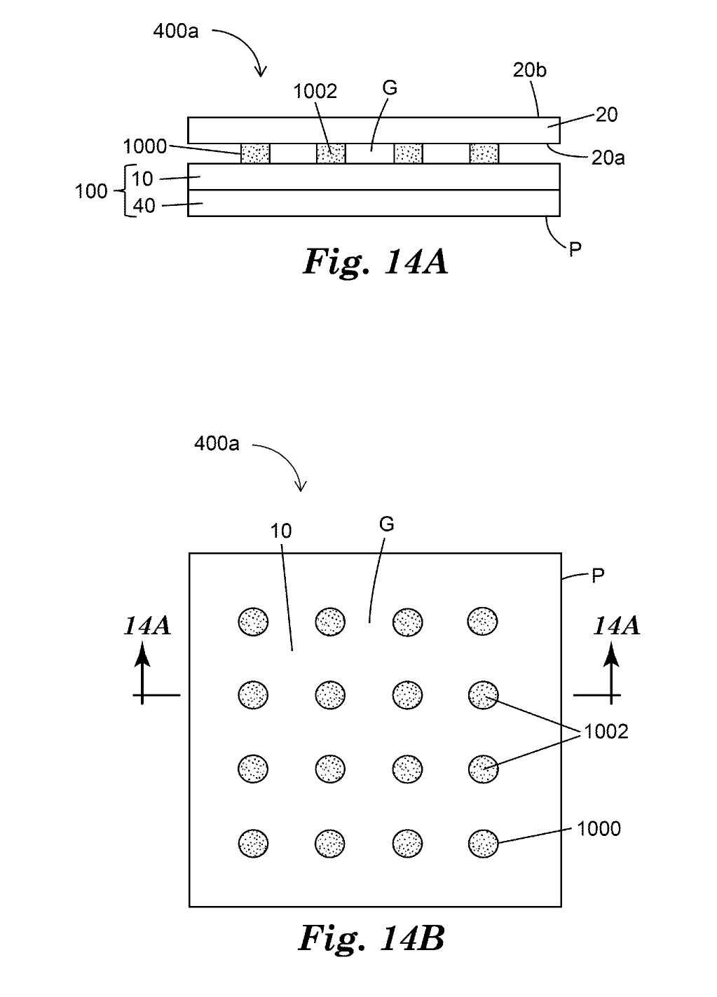

FIG. 14A is a schematic cross-sectional side view, through line 14A of FIG. 14B, of an exemplary membrane-electrode assembly according to one exemplary embodiment of the present disclosure. FIG. 14A shows membrane-electrode assembly 400a, including first electrode assembly 100, which includes discontinuous transport protection layer 10 and porous electrode 40; ion permeable membrane 20 having a first surface 20a and an opposed second surface 20b; and first adhesive layer 1000 disposed between first surface 20a of ion permeable membrane 20 and discontinuous transport protection layer 10 of first electrode assembly 100. First adhesive layer 1000 is a plurality of first adhesive regions 1002 disposed within the interior of the membrane-electrode assembly 400a, wherein the area of the first plurality of adhesive regions, in the plane of the membrane electrode assembly 400a (total area of the circles shown in FIG. 14B), is less than at least 50 percent of the projected area of the membrane electrode assembly (area of the large square shown in FIG. 14B). In this exemplary embodiment, first adhesive layer 1000 is in contact with both the first surface 20a of ion permeable membrane 20 and discontinuous transport protection layer 10 of first electrode assembly 100. FIG. 14B is a schematic top view in the plane of the adhesive layer of the exemplary membrane-electrode assembly of FIG. 14A, according to one exemplary embodiment of the present disclosure. FIG. 14B shows first adhesive layer 1000, which includes a plurality of first adhesive regions 1002 disposed within the interior of the membrane-electrode assembly 400a. In FIG. 14A, the first adhesive layer is diagramed as being in contact with the transportation protection layer 10 of electrode assembly 100, but not being embedded therein. However, this is not a particular limitation and first adhesive layer 1000 may be embedded through a portion of the thickness of discontinuous transport protection layer 10 (see FIG. 12C); through substantially the entire thickness of discontinuous transport protection layer 10 (see FIG. 12D); through substantially the entire thickness of discontinuous transport protection layer 10 and partially through the thickness of porous electrode 40 (see FIG. 12E) or through substantially the entire thickness of discontinuous transport protection layer 10 and through substantially the entire thickness of porous electrode 40 (see FIG. 12F). The phrase “may be embedded through substantially the entire thickness” is meant to include that at least 80 percent, at least 90 percent, at least 95 percent, at least 99 or even at least 100 percent of the thickness of the layer has been embedded with adhesive. Membrane-electrode assembly 400a may further include a second adhesive layer and a second electrode assembly, as previously described in FIGS. 12G and 12H and FIGS. 13G and 13H, for example. The second adhesive layer may also be as that described by the first adhesive layer of FIGS. 14A and 14B, wherein the second adhesive layer is a second plurality of adhesive regions disposed within the interior of the membrane-electrode assembly and wherein the area of the second plurality of adhesive regions, in the plane of the membrane electrode assembly, is less than at least 50 percent of the projected area of the membrane electrode assembly. In some embodiments, the area of the second plurality of adhesive regions, in the plane of the membrane electrode assembly, is less than at least 50 percent, less than at least 40 percent less than at least 30 percent, less than at least 20 percent, less than at least 10 percent or even less than at least 5 percent of the projected area of the membrane electrode assembly. The shape of the adhesive regions is not particularly limited and may include, but are not limited to, cubes, rectangular solids, cylinders, spheres, spheroids, pyramids, truncated pyramids, cones and the like. The adhesive regions may be discrete lines, e.g. rectangular solid lines, cylindrical lines and the like.

The adhesive layers of the present disclosure may include at least one of a pressure sensitive adhesive, a hot melt adhesive and a thermosetting adhesive. Pressure sensitive adhesives that may be used in the adhesive layers of the present disclosure include, but are not limited to, those based on acrylates, silicones, nitrile rubber, butyl rubber, natural rubber, stryrene block copolymers, urethane and the like. Pressure sensitive adhesives based on poly(meth)acrylates may be particularly suitable.

Heat activated adhesives are adhesives that may act as an adhesive, e.g. a pressure sensitive adhesive or structural adhesive, at ambient or use temperature, while having the ability to flow, similar to a liquid, at an elevated temperature. Heat activated adhesives include hot melt adhesives, are adhesives that are semi-crystalline or amorphous and have the ability to flow when they are heated to a temperature above their crystalline melting temperature, Tm, and/or above their glass transition temperature, Tg. Once cooled back to a temperature below their Tm and/or Tg, the hot melt adhesive solidifies and provides adhesive properties. The hot melt adhesive may include at least one of a polyurethane, polyamide, polyester, polyacrylate, polyolefin, polycarbonate and epoxy resin. The hot melt adhesive may be capable of being cured. Curing the hot melt adhesive may comprise at least one of moisture curing, thermal curing and actinic radiation curing. Heat activated adhesives may include the adhesives disclosed in U.S. Pat. Publ. No. 2012/0325402 (Suwa, et. al.) and U.S. Pat. No. 7,008,680 (Everaerts, et. al.) and U.S. Pat. No. 5,905,099 (Everaerts, et. al.), all incorporated herein by reference.

The adhesives of the present disclosure may be applied to the membrane-electrode assembly by known techniques in the art including lamination, e. g. lamination of an adhesive layer to the discontinuous transport protection layer of an electrode assembly via use of an adhesive transfer tape; and various coating and printing techniques, e. g. screen printing an adhesive on the discontinuous transport protection layer of an electrode assembly.

The first and second gaskets may be prepared form materials typically used as gasket material in the field of liquid flow batteries. Although the material used for the gasket is not particularly limited, generally, the material of the gasket has good chemical resistance to the anolyte and/or catholyte used in the liquid flow batteries. The first and/or second gasket may include at least one polymer. In some embodiments the first and/or second gasket may include, but is not limited to, at least one of polyester, e.g. polyethylene terephthalate, polyamide, polycarbonate, polyimide, polysulphone, polyphenylene oxide, polyethylene naphthalate, polyacrylates, polymethacylates, polyolefin, e.g. polyethylene and polypropylene, styrene and styrene based random and block copolymers, e.g. styrene-butadiene-styrene, polyvinyl chloride, and fluorinated polymer, e.g. polyvinylidene fluoride and polytetrafluoroethylene.

Throughout this disclosure, the first and second gaskets have been diagramed (see FIGS. 13C-13H, for example) to have the same width as that of the membrane-electrode assembly, but that is not a requirement. In some embodiments, the width of the first and/or second gaskets may be less than the width of at least one of the membrane electrode assembly and the discontinuous transport protection layer. In some embodiments, the width of the first and/or second gaskets may be greater than the width of at least one of the membrane electrode assembly and the discontinuous transport protection layer. When the width of the first and or second gasket is greater than the width of at least one of the membrane electrode assembly and the discontinuous transport protection layer, the gasket may be used to seal the membrane electrode assembly, when included in an electrochemical cell or liquid flow battery.

The membrane-electrode assemblies of the present disclosure include an ion permeable membrane, ion exchange membranes being particularly useful. Ion permeable membranes and ion exchange membranes known in the art may be used. Ion permeable membranes, e.g. ion exchange membranes, are often referred to as separators and may be prepared from ionic polymers, for example, those previously discussed for the ionic polymer of the discontinuous transport protection layer including, but not limited to, ion exchange resin, ionomer resin and combinations thereof. In some embodiments, the membranes, e.g., ion exchange membranes may include a fluorinated ion exchange resin. Membranes, e.g. ion exchange membranes, useful in the embodiments of the present disclosure may be fabricated from ion exchange resins and/or ionomer known in in the art or may be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and

SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company and materials described in U.S. Pat. No. 7,348,088, incorporated herein by reference in its entirety. In some embodiments, the ion exchange membrane includes a fluoropolymer. In some embodiments, the fluoropolymer of the ion exchange membrane may contain between about 10% to about 90%, from about 20% to about 90%, from about 30% to about 90% or even from about 40% to about 90% fluorine by weight.

The membranes, e.g. ion permeable membranes, of the present disclosure may be obtained as free standing films from commercial suppliers or may be fabricated by coating a solution of the appropriate membrane resin, e.g. ion exchange membrane resin, in an appropriate solvent, and then heating to remove the solvent. The membrane may be formed from a coating solution by coating the solution on a release liner and then drying the membrane coating solution coating to remove the solvent.

Any suitable method of coating may be used to coat the membrane coating solution on a release liner. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Coating may be achieved in one pass or in multiple passes. Coating in multiple passes may be useful to increase coating weight without corresponding increases in cracking of the ion permeable membrane.

The amount of solvent, on a weight basis, in the membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of membrane resin, e.g. ion exchange resin and ionomer resin, on a weight basis, in the membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The thickness of the ion permeable membrane may be from about 5 microns to about 250 microns, from about 5 microns to about 200 microns, from about 5 microns to about 150 microns, from about 5 microns to about 100 microns, from about 10 microns to about 250 microns, from about 10 microns to about 200 microns, from about 10 microns to about 150 microns, from about 5 microns to about 10 microns, from about 15 microns to about 250 microns, from about 15 microns to about 200 microns, from about 15 microns to about 150 microns, or even from about 15 microns to about 100 microns.

Throughout this disclosure the ion permeable membrane has been diagramed (see FIGS. 12A through 14B, for example) to have the same width as that of the membrane-electrode assembly, but that is not a requirement. In some embodiments, the width of the ion permeable membrane may be less than the width of at least one of the membrane electrode assembly and the discontinuous transport protection layer. In some embodiments, the width of the ion permeable membrane may be greater than the width of at least one of the membrane electrode assembly and the discontinuous transport protection layer.

The electrode assemblies and membrane-electrode assemblies of the present disclosure include at least one porous electrode. The porous electrode of the present disclosure is electrically conductive and the porosity facilitates the oxidation/reduction reaction that occur therein by increasing the amount of active surface area for reaction to occur, per unit volume of electrode, and by allowing the anolyte and catholyte to permeate into the porous regions and access this additional surface area. The porous electrodes may include at least one of woven and nonwoven fiber mats, woven and nonwoven fiber papers, felts and cloths (fabrics). In some embodiments, the porous electrode includes carbon fiber. The carbon fiber of the porous electrode may include, but is not limited to, glass like carbon, amorphous carbon, graphene, carbon nanotubes and graphite. Particularly useful porous electrode materials include carbon papers, carbon felts and carbon cloths (fabrics). In some embodiment, the porous electrode includes at least one of carbon paper, carbon felt and carbon cloth. In some embodiments, the porous electrode includes from about 30 percent to about 100 percent, from about 40 percent to about 100 percent, from about 50 percent to about 100 percent, from about 60 percent to about 100 percent, from about 70 percent to about 100 percent, from about 80 percent to about 100 percent, from about 90 percent to about 100 percent or even from about 95 percent to about 100 percent carbon fiber by weight. In some embodiments, the porous electrode includes from about 50 percent to about 100 percent, from about 60 percent to about 100 percent, from about 70 percent to about 100 percent, from about 80 percent to about 100 percent, from about 90 percent to about 100 percent, from about 95 percent to about 100 percent or even from about from about 97 percent to about 100 percent electrically conductive carbon particulate by weight. In some embodiments, the electrically conductive carbon particulate may include at least one of carbon particles, carbon flakes, carbon fibers, carbon dendrites, carbon nanotubes and branched carbon nanotubes; combinations may be used. In some embodiments, the electrically conductive carbon particulate may include at least one of graphite particles, graphite flakes, graphite fibers and graphite dendrites; combinations may be used. In some embodiments, the porous electrode includes from about 5 percent to about 100 percent, from about 10 percent to about 100 percent, from about 20 percent to about 100 percent, from about 35 percent to about 100 percent or even from about from about 50 percent to about 100 percent, by weight, of at least one of at least one of graphite particles, graphite flakes, graphite fibers and graphite dendrites.

Other porous electrodes useful in the electrode assemblies and membrane-electrode assemblies of the present disclosure include those included in pending U.S. Provisional Appl. Nos. 62/183,429, titled “Porous Electrodes and Electrochemical Cells and Liquid Flow Batteries Therefrom”, filed Jun. 23, 2015; 62/183,441, titled “Porous Electrodes and Electrochemical Cells and Liquid Flow Batteries Therefrom”, filed Jun. 23, 2015; 62/269,227, titled “Porous Electrodes, Membrane-Electrode Assemblies, Electrode Assemblies, and Electrochemical Cells and Liquid Flow Batteries Therefrom”, filed Dec. 18, 2015; and 62/269,239, titled “Porous Electrodes and Electrochemical Cells and Liquid Flow Batteries Therefrom”, filed Dec. 18, 2015, which are all incorporated herein by reference in their entirety.

The thickness of the porous electrode may be from about 10 microns to about 15000 microns, from about 10 microns to about 10000 microns, from about 10 microns to about 5000 microns, from about 10 microns to about 1000 microns, from about 10 microns to about 500 microns, from about 10 microns to about 250 microns, from about 10 microns to about 100 microns, from about 25 microns to about 15000 microns, from about 25 microns to about 10000 microns, from about 25 microns to about 5000 microns, from about 25 microns to about 1000 microns, from about 25 microns to about 500 microns, from about 25 microns to about 250 microns, or even from about 25 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent.

The porous electrode may be a single layer or multiple layers of woven and nonwoven fiber mats; and woven and nonwoven fiber papers, felts, and cloths; multi-layer papers and felts having particular utility. When the porous electrode includes multiple layers, there is no particular limit as to the number of layers that may be used. However, as there is a general desire to minimize the number of layers of the electrode assemblies and the membrane-electrode assemblies of the present disclosure in order to reduce cost and/or the number of assembly steps, the porous electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of woven and nonwoven fiber mats and woven and nonwoven fiber papers, felts, cloths, and foams. In some embodiments the porous electrode includes from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of carbon paper, carbon felt and/or carbon cloth.

In some embodiments, the porous electrode may be surface treated to enhance the wettability of the porous electrode to a given anolyte or catholyte or to provide or enhance the electrochemical activity of the porous electrode relative to the oxidation—reduction reactions associated with the chemical composition of a given anolyte or catholyte. Surface treatments include, but are not limited to, at least one of chemical treatments, thermal treatments and plasma treatments. Thermal treatments of porous electrodes may include heating to elevated temperatures in an oxidizing atmosphere, e.g. oxygen and air. Thermal treatments may be at temperatures from about 100 to about 1000 degrees centigrade, from about 100 to about 850 degrees centigrade, from about 100 to about 700 degrees centigrade, 200 to about 1000 degrees centigrade, from about 200 to about 850 degrees centigrade, from about 200 to about 700 degrees centigrade, from about 300 to about 1000 degrees centigrade, from about 300 to about 850 degrees centigrade, or even from about 300 to about 700 degrees centigrade. The duration of the thermal treatment may be from about 0.1 hours to about 60 hours, from about 0.25 hour to about 60 hours, from about 0.5 hour to about 60 hours, from about 1 hour to about 60 hours, from about 3 hours to about 60 hours, from about 0.1 hours to about 48 hours, from about 0.25 hour to about 48 hours, from about 0.5 hour to about 48 hours, from about 1 hour to about 48 hours, from about 3 hours to about 48 hours, from about 0.1 hours to about 24 hours, from about 0.25 hour to about 24 hours, from about 0.5 hour to about 24 hours, from about 1 hour to about 24 hours from about 3 hours to about 24 hours, from about 0.1 hours to about 12 hours, from about 0.25 hour to about 12 hours, from about 0.5 hour to about 12 hours, from about 1 hour to about 12 hours, or even from about 3 hours to about 48 hours. In some embodiments, the porous electrode includes at least one of a carbon paper, carbon felt and carbon cloth that has been thermally treated in at least one of an air, oxygen, hydrogen, nitrogen, argon and ammonia atmosphere at a temperature from about 300 degrees centigrade to about 700 degrees centigrade for between about 0.1 hours and 48 hours.

In some embodiments, the porous electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments, the porous electrode may have a surface contact angle with water, catholyte and/or anolyte of less than 90 degrees. In some embodiments, the porous electrode may have a surface contact angle with water, catholyte and/or anolyte of between about 90 degrees and about 0 degrees, of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

The interfacial region of the electrode assemblies and membrane-electrode assemblies of the present disclosure includes a portion of the polymer of the discontinuous transport protection layer embedded in at least a portion of the plurality of voids of the porous electrode, a portion of the porous electrode embedded in a portion of the polymer of the discontinuous transport protection layer or a combination thereof. The thickness, Ti, of the interfacial region is not particularly limited. In some embodiments, the thickness of the interfacial region is from about 10 microns to about 300 microns, from about 10 microns to about 200 microns, from about 10 microns to about 150 microns, 20 microns to about 300 microns, from about 20 microns to about 200 microns, from about 20 microns to about 150 microns, 30 microns to about 300 microns, from about 30 microns to about 200 microns, or even from about 30 microns to about 150 microns. In some embodiments, the discontinuous transport protection layer has a thickness Tp, the interfacial region has a thickness Ti and the ratio Ti/Tp is from about 0.005 to about 0.8, from about 0.01 to about 0.8, from about 0.025 to about 0.8, from about 0.05 to about 0.8, from about 0.1 to about 0.8, from about 0.005 to about 0.65, from about 0.01 to about 0.65, from about 0.025 to about 0.65, from about 0.05 to about 0.65, from about 0.1 to about 0.65, from about 0.005 to about 0.5, from about 0.01 to about 0.5, from about 0.025 to about 0.5, from about 0.05 to about 0.5, from about 0.1 to about 0.5, from about 0.005 to about 0.4, from about 0.01 to about 0.4, from about 0.025 to about 0.4, from about 0.05 to about 0.4, from about 0.1 to about 0.4, from about 0.005 to about 0.3, from about 0.01 to about 0.3, from about 0.025 to about 0.3, from about 0.05 to about 0.3, or even from about 0.1 to about 0.3. The interfacial region may include mechanical bonds between the polymer and the porous electrode. The integral structure of the electrode assembly may be formed by bonds, e.g. mechanical bonds, between the polymer of the discontinuous transport protection layer and the porous electrode within the interfacial region. In some embodiments, the interfacial region bonds the discontinuous transport protection layer to the porous electrode thereby forming an integral structure. The interfacial region may be formed during the electrode assembly fabrication process.

In one embodiment, the discontinuous transport protection may be formed by melt extrusion of polymer which is disposed on the first major surface of the porous electrode. The molten polymer may flow into at least a portion of the plurality of voids of the porous electrode and, optionally, encapsulate fibers of the porous electrode (if present), solidify on cooling and thereby bond, e.g. mechanically bond, the discontinuous transport protection layer to the porous electrode, forming an integral structure. Pressure and/or heat may be applied to one or both of the discontinuous transport protection layer and the porous electrode to urge the molten polymer into the plurality of voids.

In another embodiment, a polymer solution, of appropriate viscosity, may be screen printed in the desired pattern on the first major surface of the porous electrode. The polymer solution may flow into at least a portion of the plurality of voids of the porous electrode and, optionally, encapsulate fibers of the porous electrode (if present), solidify on drying, curing and/or the removal of shear stress and thereby bond, e.g. mechanically bond, the discontinuous transport protection layer to the porous electrode, forming an integral structure. Pressure and/or heat may be applied to one or both of the discontinuous transport protection layer and the porous electrode to urge the polymer solution into the plurality of voids.

In yet another embodiments, a continuous film of a thermoplastic or B-stage thermoset may be formed into a discontinuous transport protection layer, by for example, die cutting the desired open regions into the continuous film, forming a mesh structure. The discontinuous transport protection layer may be laminated to the first major surface of a porous electrode at an appropriate temperature above the softening temperature of the thermoplastic or B-stage thermoset, such that the thermoplastic or B-stage thermoset flows into at least a portion of the plurality of voids of the porous electrode and, optionally, encapsulate fibers of the porous electrode (if present), then solidifies on cooling or cures (B-stage thermoset) under heat or actinic radiation and thereby bond, e.g. mechanically bond, the discontinuous transport protection layer to the porous electrode, forming an integral structure. Pressure and/or additional heat may be applied to one or both of the discontinuous transport protection layer and the porous electrode to urge the thermoplastic or B-stage thermoset into the plurality of voids.

In another embodiments, a woven structure or nonwoven structure of thermoplastic fibers or B-stage thermoset fibers may be formed into a discontinuous transport protection layer, by for example, fabricating a woven structure or nonwoven structure using conventional techniques. The discontinuous transport protection layer may be laminated to the first major surface of a porous electrode at an appropriate temperature above the softening temperature of the thermoplastic or B-stage thermoset, such that the thermoplastic or B-stage thermoset flows into at least a portion of the plurality of voids of the porous electrode and, optionally, encapsulate fibers of the porous electrode (if present), then solidifies on cooling or cures (B-stage thermoset) under heat or actinic radiation and thereby bond, e.g. mechanically bond, the discontinuous transport protection layer to the porous electrode, forming an integral structure. Pressure and/or additional heat may be applied to one or both of the discontinuous transport protection layer and the porous electrode to urge the thermoplastic or B-stage thermoset into the plurality of voids.

In some embodiments, the surface of the porous electrode may be rough and include protrusions above its surface, for example, fibers that comprise the porous electrode may protrude above the surface of the porous electrode. In these embodiments the polymer of the discontinuous transport protection layer, when it is above its softening temperature and/or in the form of a flowable solution, may flow and encapsulate the protrusions and, upon solidification due to cooling (for a polymer melt, e.g. thermoplast, or B-stage thermoset, for example) or drying (for a polymer solution, for example) or curing (for a polymer solution or B-staged thermoset, for example), thereby bond, e.g. mechanically bond, the discontinuous transport protection layer to the porous electrode, forming an integral structure.

In some embodiments, the thickness of the porous electrode combined with the thickness of the interfacial region, i.e. Te+Ti, may be from about 10 microns to about 1000 microns, from about 10 microns to about 500 microns, from about 10 microns to about 250 microns, from about 10 microns to about 100 microns, from about 25 microns to about 1000 microns, from about 25 microns to about 500 microns, from about 25 microns to about 250 microns, or even from about 25 microns to about 100 microns.

The discontinuous transport protection layers, porous electrodes, membranes, and the corresponding electrode assemblies and membrane-electrode assemblies of the present disclosure may be used to fabricate an electrochemical cell for use in, for example, a liquid flow battery, e.g. a redox flow battery. In some embodiments, the present disclosure provides an electrochemical cell that include at least one electrode assembly or at least one membrane-electrode assembly. In one embodiment, the present disclosure provides an electrochemical cell including an electrode assembly according to any one of the electrode assemblies of the present disclosure. In another embodiment, the present disclosure provides an electrochemical cell including a membrane-electrode assembly according to any one of the membrane-electrode assemblies of the present disclosure.

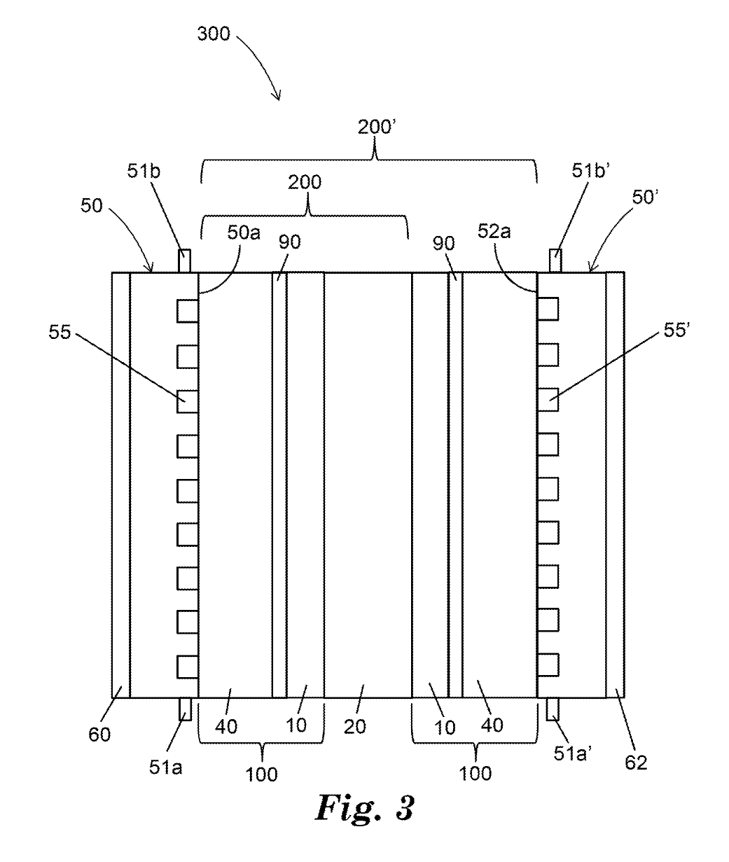

FIG. 3 shows a schematic cross-sectional side view of an exemplary electrochemical cell according to one exemplary embodiment of the present disclosure. Electrochemical cell 300 includes porous electrodes 40, discontinuous transport protection layers 10, interfacial regions 90 and ion permeable membrane 20, all as previously described. Electrochemical cell 300 includes end plates 50 and 50′ having fluid inlet ports, 51a and 51a′, respectively, and fluid outlet ports, 51b and 51b′, respectively, flow channels 55 and 55′, respectively and first surface 50a and 52a respectively. Electrochemical cell 300 also includes current collectors 60 and 62. End plates 50 and 51 are in electrical communication with porous electrodes 40, through surfaces 50a and 52a, respectively. Support plates, not shown, may be placed adjacent to the exterior surfaces of current collectors 60 and 62. The support plates are electrically isolated from the current collector and provide mechanical strength and support to facilitate compression of the cell assembly. In some embodiments, electrochemical cell 300 includes at least one electrode assembly 100, including a porous electrode 40, a discontinuous transport protection layer 10 and interfacial region 90. Electrode assembly 100, may be any of the electrode assemblies of the present disclosure, for example, electrode assemblies 100a through 100g (FIGS. 1A through 1N). FIG. 3 shows two electrode assemblies 100, e.g. a first electrode assembly and a second electrode assembly. The two electrode assemblies may be the same or may be different. For example, the first electrode assemblies may be electrode assembly 100a (FIGS. 1A and 1B) while a second electrode assembly may be electrode assembly 100f (FIGS. 1K and 1L). Electrochemical cell 300 may also include a membrane-electrode assembly, 200 and/or 200′. Membrane-electrode assembly, 200 may be any of the membrane-electrode assemblies, having a single porous electrode, described herein, for example, membrane-electrode assembly 200a (FIG. 2A). Membrane-electrode assembly, 200′ may be any of the membrane-electrode assemblies, having two porous electrodes, described herein, for example, membrane-electrode assembly 200b (FIG. 2B).

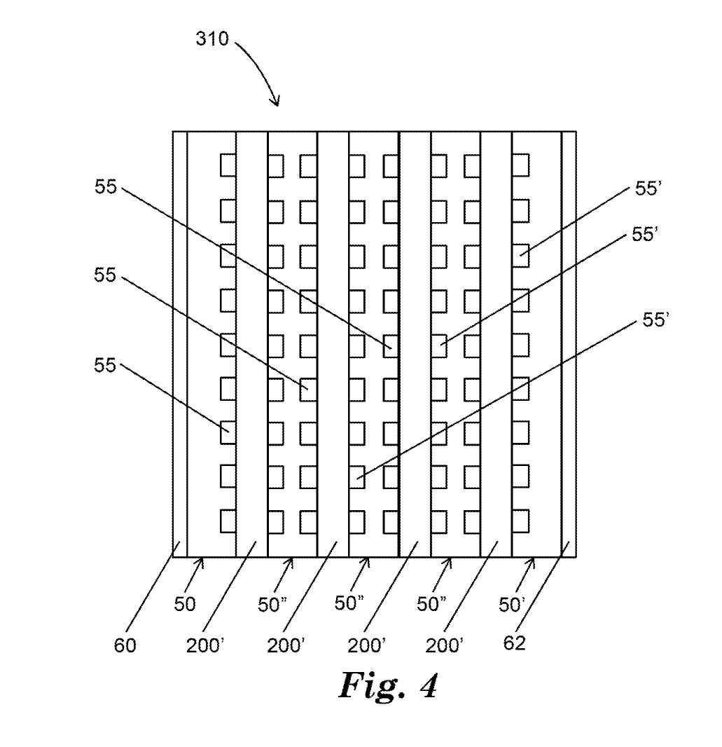

Individual electrochemical cells may be arranged to form an electrochemical cell stack. The electrochemical cell stacks of the present disclosure may include a plurality of electrode assemblies and/or a plurality of membrane-electrode assemblies, as previously described herein. In one embodiment, the present disclosure provides an electrochemical cell stack including at least two, at least three or even at least four electrode assemblies, according to any one of the electrode assemblies of the present disclosure. In another embodiment, the present disclosure provides an electrochemical cell stack including at least two, at least three, at least four membrane-electrode assemblies, according to any one of the membrane-electrode assemblies of the present disclosure. FIG. 4 shows a schematic cross-sectional side view of an exemplary electrochemical cell stack according to one exemplary embodiment of the present disclosure. Electrochemical cell stack 310 includes membrane-electrode assemblies 200′, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 310 includes multiple electrochemical cells, each cell represented by a membrane-electrode assembly and the corresponding adjacent bipolar plates and/or end plates. Membrane-electrode assemblies 200′ have previously been described. In some embodiments, membrane-electrode assemblies 200′ may each include two electrode assemblies of the present disclosure, for example, at least two of electrode assemblies 100a-100g. In some embodiments, one of the electrode assemblies of membrane-electrode assembly 200′ may be replaced with an electrode assembly which does not contain a discontinuous transport protection layer. Within an electrochemical cell stack, the membrane-electrode assemblies may be the same or may be different. Within an electrochemical cell stack, the electrode assemblies may be the same or may be different. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system is not shown. These features may be provided as known in the art.

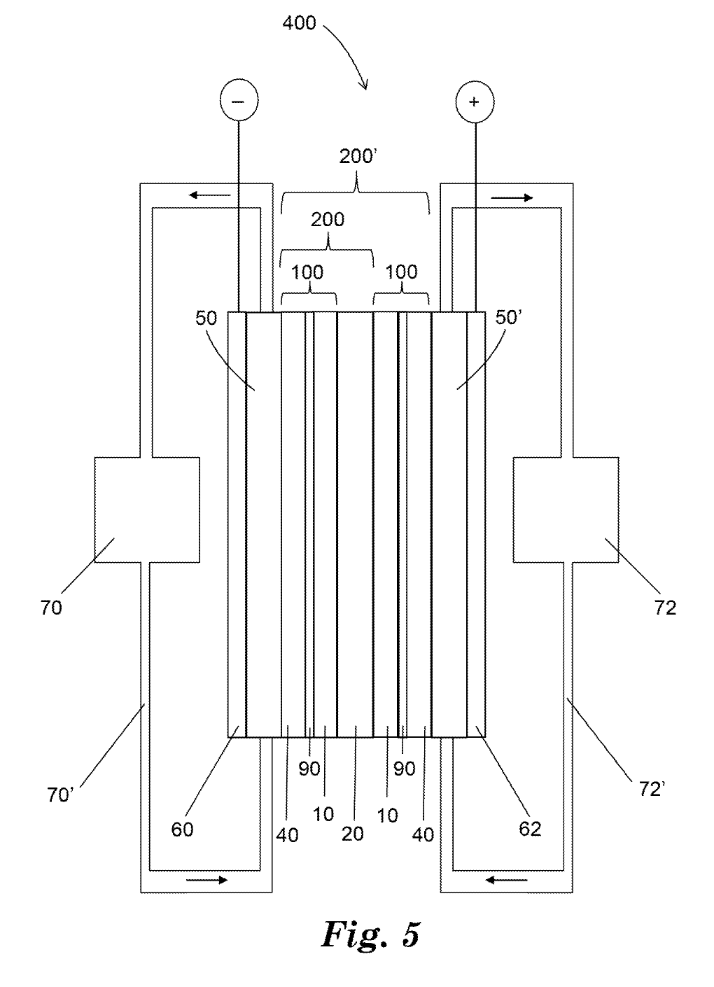

The discontinuous transport protection layers, porous electrodes and ion permeable membranes, and their corresponding electrode assemblies and membrane-electrode assemblies of the present disclosure may be used to fabricate liquid flow batteries, e.g. a redox flow battery. In some embodiments, the present disclosure provides a liquid flow battery that includes at least one electrode assembly and/or at least one membrane-electrode assembly of the present disclosure. In one embodiment, the present disclosure provides a liquid flow battery including an electrode assembly according to any one of the electrode assemblies of the present disclosure, for example electrode assemblies 100a-100g. In another embodiment, the present disclosure provides a liquid flow battery including a membrane-electrode assembly according to any one of the membrane-electrode assemblies of the present disclosure, for example membrane-electrode assemblies 200a and 200b. FIG. 5 shows a schematic view of an exemplary single cell, liquid flow battery according to one exemplary embodiment of the present disclosure. Liquid flow battery 400 includes porous electrodes 40, discontinuous transport protection layers 10, interfacial regions 90 and ion permeable membrane 20, all as previously described. The porous electrodes 40 and discontinuous transport protection layers 10 may be included in liquid flow battery 400 as electrode assemblies 100, as previously described, and may be any of the electrode assemblies of the present disclosure, e.g. electrode assemblies 100a through 100g. The porous electrodes 40, discontinuous transport protection layers 10 and membrane 20 may be included in liquid flow battery 400 as membrane-electrode assemblies 200, 200′ as previously described, and may be any of the membrane-electrode assemblies of the present disclosure, e.g. electrode assemblies 200a and 200b. The Liquid flow battery 400 also includes end plates 50 and 50′ having flow channels (flow channels not shown), current collectors 60 and 62, anolyte reservoir 70 and anolyte fluid distribution 70′, and catholyte reservoir 72 and catholyte fluid distribution system 72′. Pumps for the fluid distribution system are not shown. Current collectors 60 and 62 may be connected to an external circuit which includes an electrical load (not shown). Support plates, not shown, may be placed adjacent to the exterior surfaces of current collectors 60 and 62. The support plates are electrically isolated from the current collector and provide mechanical strength and support to facilitate compression of the cell assembly. Although a single cell liquid flow battery is shown, it is known in the art that liquid flow batteries may contain multiple electrochemical cells, i.e. a cell stack. Multiple cell stacks may be used to form a liquid flow battery, e. g. multiple cell stacks connected in series. The discontinuous transport protection layers, porous electrodes and ion exchange membranes, and their corresponding electrode assemblies and membrane-electrode assemblies of the present disclosure may be used to fabricate liquid flow batteries having multiple cells, for example, the multiple cell stack of FIG. 5. Flow fields may be present, but this is not a requirement.

The electrode assemblies and membrane-electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, as described in the Example section of the present disclosure, which includes at least one of a an electrode assembly and membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane, i.e. laterally across the cell, shown in FIG. 3 or FIG. 5. In some embodiments, a test cell, as described in the Example section of the present disclosure, which includes at least one of an electrode assembly and membrane-electrode assembly of the present disclosure may have a cell resistance of between about 0.01 and about 10 ohm-cm², 0.01 and about 5 ohm-cm², between about 0.01 and about 3 ohm-cm², between about 0.01 and about 1 ohm-cm², between about 0.04 and about 5 ohm-cm², between about 0.04 and about 3 ohm-cm², between about 0.04 and about 0.5 ohm-cm², between about 0.07 and about 5 ohm-cm², between about 0.07 and about 3 ohm-cm² or even between about 0.07 and about 0.1 ohm-cm².

In some embodiments of the present disclosure, the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁺/Fe²⁺ vs. Br₂/Br⁻, Mn²⁺/Mn³⁺ vs. Br²/Br⁻, vs. Fe³⁺/Fe²⁺ vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Publ, Nos. 2014/0028260, 2014/0099569, and 2014/0193687 and organic complexes, for example, Pat. Publ. No. 2014/0370403 and international application published under the patent cooperation treaty Int. Publ. No. WO 2014/052682, all of which are incorporated herein by reference in their entirety.

The present disclosure also provides methods of making an electrode assembly. In some embodiments, the method of making an electrode assembly includes (i) providing a porous electrode having a first major surface with a first surface area, Ae, an opposed second major surface and a plurality of voids, (ii) disposing on the first major surface a discontinuous transport protection layer comprising polymer and having a cross-sectional area, Ap, substantially parallel to the first major surface (iii) forming an interfacial region wherein a portion of the of the discontinuous transport protection layer is embedded in at least a portion of the plurality of voids, a portion of the porous electrode is embedded in a portion of the polymer or a combination thereof, and wherein 0.02Ae≤Ap≤0.85Ae and the porous electrode and polymer layer form an integral structure. Optionally, the methods may further include disposing an ion permeable membrane on the major surface of the discontinuous transport protection layer opposite the interfacial region, thereby forming a membrane-electrode assembly.

In some embodiments the disposing step includes at least one of extruding, e.g. melt extruding a polymer; printing of a polymer, e.g. 3-dimensional printing and ink jet printing a polymer; and transfer laminating a polymer, e.g. segmented transfer laminating a polymer. Extrusion processes, e.g. polymer melt extrusion, and polymer printing are well known in the art and conventional techniques may be employed in the fabrication of the electrode assemblies and membrane-electrode assemblies of the present disclosure. Transfer laminating a polymer is also known in the art, e.g. segmented transfer lamination, and conventional techniques may be used. One example of a segmented transfer lamination method is forming a continuous polymer film on a release liner, kiss cutting the polymer film to form the desired pattern of the segments to be transferred, removing the weed of the segmented polymer film, i.e. removing the undesired portion of the segmented polymer film, to form a discontinuous transport protection layer with release liner, providing a porous electrode, laminating (e.g. thermal laminating) the exposed major surface of the discontinuous transport protection layer to the surface of a porous electrode thereby forming an interfacial region, wherein the porous electrode and polymer layer form an integral structure. Pressure and/or heat may be applied to one or both of the discontinuous transport protection layer and the porous electrode to urge the molten polymer into the plurality of voids. Pressure and/or heat may be applied to one or both of the discontinuous transport protection layer and the porous electrode to urge the polymer into the plurality of voids. The release liner may be removed when desired.

In some embodiments of the methods of making an electrode assembly, the forming an interfacial region step is included in the disposing step. In some embodiments, the forming step includes providing at least one of pressure and heat to at least one of the porous electrode and the discontinuous transport protection layer. Providing at least one of pressure and heat to at least one of the porous electrode and the discontinuous transport protection layer may be conducted by urging at least one of the porous electrode and the discontinuous transport protection layer through at least one set of nip rolls, optionally wherein at least one of the nip rolls is heated. In some embodiments, the forming step includes providing at least one of pressure and heat to the porous electrode and the discontinuous transport protection layer. Providing at least one of pressure and heat to the porous electrode and the discontinuous transport protection layer may be conducted by urging the porous electrode and polymer layer through at least one set of nip rolls, optionally wherein at least one of the nip rolls is heated.

Select embodiments of the present disclosure include, but are not limited to, the following:

In a first embodiment, the present disclosure provides an electrode assembly comprising:

a porous electrode having a first major surface with a first surface area, Ae, an opposed second major surface and a plurality of voids;

a discontinuous transport protection layer, comprising polymer, disposed on the first major surface and having a cross-sectional area, Ap, substantially parallel to the first major surface; and

an interfacial region wherein the interfacial region includes a portion of the polymer embedded in at least a portion of the plurality of voids, a portion of the porous electrode embedded in a portion of the polymer or a combination thereof; and wherein 0.02Ae≤Ap≤0.85Ae and the porous electrode and discontinuous transport protection layer form an integral structure.

In a second embodiment, the present disclosure provides an electrode assembly according to the first embodiment, wherein the plurality of voids enable fluid communication between at least a portion of the first major surface and opposed second major surface of the porous electrode.

In a third embodiment, the present disclosure provides an electrode assembly according to the first or second embodiments, wherein the discontinuous transport protection layer is non-electrically conductive.

In a fourth embodiment, the present disclosure provides an electrode assembly according to any one of the first through third embodiments, wherein 0.02Ae≤Ap≤0.5Ae.

In a fifth embodiment, the present disclosure provides an electrode assembly according to any one of the first through fourth embodiments, wherein 0.02Ae≤Ap≤0.3Ae.

In a sixth embodiment, the present disclosure provides an electrode assembly according to any one of the first through fifth embodiments, wherein the discontinuous transport protection layer has a thickness Tp, the interfacial region has a thickness Ti and the ratio Ti/Tp is from about 0.005 to about 0.8.

In a seventh embodiment, the present disclosure provides an electrode assembly according to any one of the first through sixth embodiments, wherein the discontinuous transport protection layer comprises at least one of a plurality of discrete structures, a mesh structure, a woven structure and a nonwoven structure.

In an eighth embodiment, the present disclosure provides an electrode assembly according to any one of the first through sixth embodiments, wherein the discontinuous transport protection layer comprises a plurality of discrete structures.

In a ninth embodiment, the present disclosure provides an electrode assembly according to the eighth embodiment, wherein the plurality of discrete structures have a thickness from about 0.050 micron to about 3000 microns.

In a tenth embodiment, the present disclosure provides an electrode assembly according to the eighth or ninth embodiments, wherein the plurality of discrete structures are in a pattern.

In an eleventh embodiment, the present disclosure provides an electrode assembly according to any one of the eighth through tenth embodiments, wherein the plurality of discrete structures includes a plurality of non-intersecting, continuous lines.

In a twelfth embodiment, the present disclosure provides an electrode assembly according to the eleventh embodiment, wherein the plurality non-intersecting, continuous lines are straight lines.

In a thirteenth embodiment, the present disclosure provides an electrode assembly according to the eleventh or through twelfth embodiments, wherein the plurality of non-intersecting, continuous lines have a pitch from about 0.3 mm to about 11 mm.

In a fourteenth embodiment, the present disclosure provides an electrode assembly according to any one of the eleventh through thirteenth embodiments, wherein the plurality of non-intersecting, continuous lines have a width from about 0.01 mm to about 10 mm.

In a fifteenth embodiment, the present disclosure provides an electrode assembly according to any one of the eleventh through fourteenth embodiments, wherein the plurality of non-intersecting, continuous lines are substantially parallel over a length scale of from about 2 cm to about the length of the porous electrode.

In a sixteenth embodiment, the present disclosure provides an electrode assembly according to any one of the eighth through fourteenth embodiments, wherein the plurality of discrete structures have a longest dimension from about 10 microns to about 5000 microns.

In a seventeenth embodiment, the present disclosure provides an electrode assembly according to any one of the first through sixth embodiments, wherein the discontinuous transport protection layer comprises at least one of a mesh structure, woven structure and nonwoven structure.

In an eighteenth embodiment, the present disclosure provides an electrode assembly according to the seventeenth embodiment, wherein the at least one of a woven, nonwoven and mesh structure has at least one of a volume porosity and an open area porosity of between about 0.10 and about 0.995.

In a nineteenth embodiment, the present disclosure provides an electrode assembly according to any one of the first through eighteenth embodiments, wherein the discontinuous transport protection layer contains between 0 percent and 5 percent by weight of at least one of an electrically conductive particulate and a non-electrically conductive particulate.

In a twentieth embodiment, the present disclosure provides an electrode assembly according to any one of the first through nineteenth embodiments, wherein the discontinuous transport protection layer comprises at least one of a thermoplastic and a B-stage thermoset.

In a twenty-first embodiment, the present disclosure provides an electrode assembly according to any one of the first through twentieth embodiments, wherein the discontinuous transport protection layer is non-tacky at 25 degrees centigrade.

In a twenty-second embodiment, the present disclosure provides an electrode assembly according to any one of the first through twenty-first embodiments, wherein the polymer of the discontinuous transport protection layer has a softening temperature from about 50 degrees centigrade to about 400 degrees centigrade.

In a twenty-third embodiment, the present disclosure provides an electrode assembly according to any one of the first through twenty-second embodiments, wherein the polymer of the discontinuous transport protection layer is a solid having between about 0 and about 5 percent porosity by volume.

In a twenty-fourth embodiment, the present disclosure provides an electrode assembly according to any one of the first through twenty-third embodiments, wherein the discontinuous transport protection layer comprises from about 5 percent to about 100 percent by weight of a hydrophilic polymer.

In a twenty-fifth embodiment, the present disclosure provides an electrode assembly according to any one of the first through twenty-fourth embodiments, wherein the discontinuous transport protection layer further comprises a hydrophilic coating.

In a twenty-sixth embodiment, the present disclosure provides an electrode assembly according to any one of the first through twenty-fifth embodiments, wherein the porous electrode includes from about 5 percent to about 100 percent by weight of at least one of graphite particles, graphite flakes, graphite fibers and graphite dendrites.

In a twenty-seventh embodiment, the present disclosure provides an electrode assembly according to any one of the first through twenty-fifth embodiments, wherein the porous electrode includes from about 30 percent to about 100 percent electrically conductive carbon particulate by weight.

In a twenty-eighth embodiment, the present disclosure provides an electrode assembly according to the twenty-seventh embodiment, wherein the electrically conductive carbon particulate is at least one of carbon particles, carbon flakes, carbon dendrites, carbon nanotubes and branched carbon nanotubes.

In a twenty-ninth embodiment, the present disclosure provides an electrode assembly according to the twenty-seventh embodiment, wherein the electrically conductive carbon particulate is at least one of graphite particles, graphite flakes, graphite fibers and graphite dendrites.

In a thirtieth embodiment, the present disclosure provides an electrode assembly according to any one of the first through twenty-fifth embodiments, wherein the porous electrode includes from about 50 percent to about 100 percent carbon fiber by weight.

In a thirty-first embodiment, the present disclosure provides a method of making an electrode assembly comprising:

providing a porous electrode having a first major surface with a first surface area, Ae, an opposed second major surface and a plurality of voids;

disposing on the first major surface a discontinuous transport protection layer comprising polymer and having a cross-sectional area, Ap, substantially parallel to the first major surface;

forming an interfacial region wherein a portion of the of the discontinuous transport protection layer is embedded in at least a portion of the plurality of voids, a portion of the porous electrode is embedded in a portion of the polymer or a combination thereof; and wherein 0.02Ae≤Ap≤0.85Ae and the porous electrode and polymer layer form an integral structure.

In a thirty-second embodiment, the present disclosure provides an electrode assembly according to the thirty-first embodiment, wherein the disposing step includes at least one of extruding, printing and transfer laminating.

In a thirty-third embodiment, the present disclosure provides an electrode assembly according to the thirty-first embodiment, wherein the disposing step includes extruding a polymer melt.

In a thirty-fourth embodiment, the present disclosure provides an electrode assembly according to any one of the thirty-first through thirty-third embodiments, wherein the forming step is included in the disposing step.

In a thirty-fifth embodiment, the present disclosure provides an electrode assembly according to any one of the thirty-first through thirty-fourth embodiments, wherein the forming step includes providing at least one of pressure and heat to at least one of the porous electrode and the discontinuous transport protection layer.

In a thirty-sixth embodiment, the present disclosure provides an electrode assembly according to the thirty-fifth embodiment, wherein providing at least one of pressure and heat to at least one of the porous electrode and the discontinuous transport protection layer is conducted by urging at least one of the porous electrode and the discontinuous transport protection layer through at least one set of nip rolls, optionally wherein at least one of the nip rolls is heated.

In a thirty-seventh embodiment, the present disclosure provides an electrode assembly according to any one of the thirty-first through thirty-fourth embodiments, wherein the forming step includes providing at least one of pressure and heat to the porous electrode and the discontinuous transport protection layer.

In a thirty-eighth embodiment, the present disclosure provides an electrode assembly according to the thirty-seventh embodiment, wherein providing at least one of pressure and heat to the porous electrode and the discontinuous transport protection layer is conducted by urging the porous electrode and polymer layer through at least one set of nip rolls, optionally wherein at least one of the nip rolls is heated.

In a thirty-ninth embodiment, the present disclosure provides a membrane-electrode assembly comprising:

a first electrode assembly according to any one of the electrode assemblies of the first through thirtieth embodiments; and

an ion permeable membrane, having a first surface and an opposed second surface, disposed adjacent to or on the major surface of the discontinuous transport protection layer opposite the interfacial region; and wherein the first electrode assembly and the ion permeable membrane form an integral structure.

In a fortieth embodiment, the present disclosure provides an electrode assembly according to the thirty-ninth embodiment, further comprising a first adhesive layer disposed between the ion permeable membrane and at least one of the porous electrode and the discontinuous transport protection layer of a first electrode assembly, wherein the first adhesive layer is disposed along the perimeter of the membrane-electrode assembly.

In a forty-first embodiment, the present disclosure provides an electrode assembly according to the fortieth embodiment, wherein the first adhesive layer is in the shape of an annulus or is two discrete adhesive lines on opposite sides of the membrane-electrode assembly perimeter.

In a forty-second embodiment, the present disclosure provides an electrode assembly according to the fortieth or forty-first embodiments, wherein the first adhesive layer is in contact with the first surface of the ion permeable membrane and the discontinuous transport protection layer of the first electrode assembly.

In a forty-third embodiment, the present disclosure provides an electrode assembly according to any one of the fortieth through forty-second embodiments, further comprising a second adhesive layer and a second electrode assembly, wherein the second adhesive layer is disposed between the second surface of the ion permeable membrane and at least one of the porous electrode and the discontinuous transport protection layer of the second electrode assembly and wherein the second electrode assembly and the ion permeable membrane form an integral structure and, optionally, wherein the second adhesive layer is in the shape of an annulus or is two discrete adhesive lines on opposite sides of the membrane-electrode assembly perimeter.

In a forty-fourth embodiment, the present disclosure provides an electrode assembly according to any one of the fortieth through forty-second embodiments, further comprising a second adhesive layer and a second electrode assembly, wherein the second adhesive layer is in contact with the second surface of the ion permeable membrane and the discontinuous transport protection layer of the second electrode assembly, wherein the second electrode assembly and the ion permeable membrane form an integral structure and, optionally, wherein the second adhesive layer is in the shape of an annulus or is two discrete adhesive lines on opposite sides of the membrane-electrode assembly perimeter.

In a forty-fifth embodiment, the present disclosure provides an electrode assembly according to any one of the fortieth, forty-first, forty-third or forty-fourth embodiments, further comprising a first gasket disposed between the ion permeable membrane and the first adhesive layer, wherein the first gasket is disposed along the perimeter of the membrane-electrode assembly.

In a forty-sixth embodiment, the present disclosure provides an electrode assembly according to the forty-fifth embodiment, further comprising a second gasket disposed between the ion permeable membrane and the second adhesive layer, wherein the second gasket is disposed along the perimeter of the membrane-electrode assembly and, optionally, wherein the second gasket is in the shape of an annulus.

In a forty-seventh embodiment, the present disclosure provides an electrode assembly according to the forty-fifth or forty-sixth embodiments, wherein the first gasket is in the shape of an annulus.

In a forty-eighth embodiment, the present disclosure provides an electrode assembly according to the thirty-ninth embodiment, further comprising a first adhesive layer disposed between the ion permeable membrane and at least one of the porous electrode and the discontinuous transport protection layer of a first electrode assembly, wherein the first adhesive layer is a plurality of first adhesive regions disposed at least within the interior of the membrane-electrode assembly and wherein the area of the first plurality of adhesive regions, in the plane of the membrane electrode assembly, is less than at least 50 percent of the projected area of the membrane electrode assembly.

In a forty-ninth embodiment, the present disclosure provides an electrode assembly according to the forty-eighth embodiment, further comprising a second adhesive layer and a second electrode assembly, wherein the second adhesive layer is disposed between the second surface of the ion permeable membrane and at least one of the porous electrode and the discontinuous transport protection layer of the second electrode assembly and wherein the second electrode assembly and the ion permeable membrane form an integral structure.

In a fiftieth embodiment, the present disclosure provides an electrode assembly according to the forty-ninth embodiment, wherein the second adhesive layer is disposed along the perimeter of the membrane-electrode assembly.

In a fifty-first embodiment, the present disclosure provides an electrode assembly according to the forty-ninth embodiment, wherein the second adhesive layer is a plurality of first adhesive regions disposed at least within the interior of the membrane-electrode assembly and wherein the area of the first plurality of adhesive regions, in the plane of the membrane electrode assembly, is less than at least 50 percent of the projected area of the membrane electrode assembly.

In a fifty-second embodiment, the present disclosure provides an electrode assembly according to any one of the forty-eighth through fifty-first embodiments, further comprising a first gasket disposed between the ion permeable membrane and the discontinuous transport protection layer of the first electrode assembly, wherein the first gasket is disposed along the perimeter of the membrane-electrode assembly.

In a fifty-third embodiment, the present disclosure provides an electrode assembly according to the fifty-second embodiment, further comprising a second gasket disposed between the ion permeable membrane and the discontinuous transport protection layer of the second electrode assembly, wherein the second gasket is disposed along the perimeter of the membrane-electrode assembly.

In a fifty-fourth embodiment, the present disclosure provides an electrochemical cell comprising: an electrode assembly according to any one of the electrode assemblies of the first through thirtieth embodiments.

In a fifty-fifth embodiment, the present disclosure provides an electrochemical cell comprising: a membrane-electrode assembly according to any one of the membrane-electrode assembly of the thirty-ninth through fifty-third embodiments.

In a fifty-sixth embodiment, the present disclosure provides a liquid flow battery comprising: an electrode assembly according to any one of the electrode assemblies of the first through thirtieth embodiments.

In a fifty-seventh embodiment, the present disclosure provides a liquid flow battery comprising: a membrane-electrode assembly according to any one of the the membrane-electrode assembly of the thirty-ninth through fifty-third embodiments.

### EXAMPLES

| Materials | |
|---|---|
| Abbreviation | |
| or Trade Name | Description |
| 3M 825EW | A perfluorosulphonic acid membrane |
| unsupported PFSA | prepared from, 3M825EW, following the |
| membrane | membrane preparation procedure described in |
| | the EXAMPLE section of U.S. Pat. No. |
| | 7,348,088. |
| 3M 825EW | A perfluorosulphonic acid (PFSA) membrane |
| Supported PFSA | prepared from an 825 equivalent weight 3M |
| Membrane | PFSA ionomer with an electrospun support |
| | layer (4.3 g/m² basis weight). The membrane |
| | was solution cast by methods outlined in |
| | patent application US 20140134518A1 with a |
| | final thickness of 20 μm. Such membranes are |
| | available from 3M Company, using this |
| | description. |
| GDL 35AA | Carbon paper, having a thickness of 280 +/− 30 |
| | microns under 5 PSI (34.5 kPa) pressure, |
| | available under the trade designation |
| | “SIGRACET GDL 35AA” from SGL Group, |
| | Wiesbaden, Germany. |
| Infiana 100 | High Density Polyethylene (HDPE) |
| micron HDPE | Film.74325.100 micron siliconized 1850, |
| | available from Infiana Germany GmbH & Co. |
| | KG, Zweibrueckenstrasse 15-25 91301 |
| | Forchheim, Germany. |
| Infiana 100 | Low Density Polyethylene (LDPE) |
| micron LDPE | Film.74000.100 micron, available from |
| | Infiana Germany GmbH & Co. KG, |
| | Zweibrueckenstrasse 15-25 91301 Forchheim, |
| | Germany. |
| TEONEX Q83 | TEONEX Q83 2 mil (0.051 mm) Polyethylene |
| PEN Film | Naphthalate Film available from Dupont |
| | Teijin Films Chester, VA. |

### Test Procedures/Methods:

### Electrochemical Cell Test Procedure

The hardware used was a modified fuel cell test fixture that utilizes two graphite bi-polar plates made by Fuel Cell Technologies (Albuquerque, N. Mex.), two gold plated copper current collectors and aluminum end plates. The graphite bi-polar plates have a 5 cm² single serpentine channel with an entry port on top and exit port on the bottom.

The test cell was assembled as follows. First, three 5.2 mil (0.13 mm) thick pieces of polytetrafluoroethylene PTFE glass fiber composite gasket material (available from Nott Company, Arden Hills, Minn.) that had a 5 cm² area removed from the center were stacked and placed along the perimeter of the major surface of one graphite plate, the gasket being on the side of the plate having the serpentine channel. A piece of GDL 35AA, cut to the size of the gasket opening, was placed in the gasket opening and adjacent to the serpentine channel of the graphite plate. The electrode assembly was then placed into the gasket cavity, with the electrode of the electrode assembly next to the piece of GDL 35AA. Next a 3M 825EW membrane (as specified in the Cell Resistance Results) was placed over the gasket/electrode assembly, adjacent the discontinuous transport protection layer (DTPL) of the electrode assembly. Next, another set of three 5.2 mil (0.13 mm) thick pieces of gasket material, with a cavity, was placed onto the membrane. A second electrode assembly was placed in this cavity, with the discontinuous transport protection layer (DTPL) of the electrode assembly adjacent the PFSA membrane. A second piece of GDL 35AA, cut to the size of the gasket cavity, was placed in the gasket cavity adjacent the electrode of the second electrode assembly. A second graphite plate was placed onto the stack, with the serpentine channels of the graphite plate adjacent the second piece of GDL 35AA, completing the test cell. The test cell was then placed between two aluminum end plates with current collectors and secured with a series of 8 bolts that are tightened to 110 in·lbs (12.4 N·m).

Connected to the entry and exit ports of the test cell was tubing that allows for delivery of the electrolyte, at a flow rate of 23 ml/min, to the serpentine channels of the cell by a KNF Neuberger NFB5 diaphragm pump (available from KNF Neuberger Inc, Trenton, N.J.). Electrolyte delivery was accomplished by pumping the fluid from one tank into the upper entry port, out the lower exit port and finally back into the original tank. A pumping system was set-up for each graphite plate. The electrolyte used for these examples was 1.5M VOSO₄, 2.6M H₂SO₄. The VOSO₄*xH₂O powder was purchased from Sigma Aldrich (St. Louis, Mo.) and concentrated H₂SO₄ (95-98%) was purchased from Sigma Aldrich. The amount of water in the VOSO₄*xH₂O varies from lot to lot, but was known and solution concentrations were adjusted to account for this water. The final solution was made by the combination of these constituents with 18MΩ DI water at the stated molar ratios and mixed with a stir bar for two to three hours before use. A 30 ml catholyte solution containing 1.5M VOSO4 in 2.6M sulfuric acid, charged to the V⁺⁵ state, was pumped through one side of the cell. In the other side of the cell, 30 ml of anolyte solution containing 1.5M VOSO4 in 2.6M sulfuric acid, charged to the V⁺² state, was pumped. In this setup the catholyte was reduced from V⁺⁵ to V⁺⁴ and the anolyte was oxidized from V⁺² to V⁺³ during discharge of the cell. Electrochemical operation of the cell: The cell was next connected to a Biologic MPG-205 potentio/galvanostat with one current collector serving as the anode and the other current collector serving as the cathode. To perform a test the following steps were followed:

1. Ensure that electrolyte was flowing through the cell.

2. Charge the cell at 80 mA/cm² until a cell voltage of 1.8V was reached.

3. Hold the cell voltage at 1.8V until the current decays to 5 mA/cm².

4. Monitor the open circuit voltage for 120 seconds.

5. Discharge the cell at 160 mA/cm² for 120 seconds and record the voltage.

6. Monitor the open circuit voltage for 120 seconds.

7. Discharge the cell at 140 mA/cm² for 120 seconds and record the voltage.

8. Monitor the open circuit voltage for 120 seconds.

9. Discharge the cell at 120 mA/cm² for 120 seconds and record the voltage.

10. Monitor the open circuit voltage for 120 seconds.

11. Discharge the cell at 100 mA/cm² for 120 seconds and record the voltage.

12. Monitor the open circuit voltage for 120 seconds.

13. Discharge the cell at 80 mA/cm² for 120 seconds and record the voltage.

Cell resistance was calculated by subtracting the cell voltage while under load from the cell voltage at open circuit and dividing by the operating current.

### Cell Short Test Procedure

Determination of electronic short resistance was done using a fuel cell test stand and a potentiostat. The test fixture used was a 5 cm² single serpentine cell made by Fuel Cell Technologies (Albuquerque, N. Mex.). The fuel cell test stand consists of two mass flow controllers (MKS Instruments, Andover, Mass.), for nitrogen flow, two Scientific Systems Inc. (State College, Pa.) HPLC pumps for humidification control and a Love controls (Michigan City, Ind.) temperature controller. The cell under test was assembled in the following order between two graphite block flowfields—gasket, carbon paper, subgasket, membrane, subgasket, gasket, carbon paper. The cell bolts were tightened in a star pattern first to tighten, then torqued to 110 lbf·in (12.4 N·m) with a torque wrench. The gaskets are a PTFE glass fiber composite die cut for a 5 cm² opening. The thickness of the gasket is chosen so that it's thickness is some fraction of carbon paper under test thickness. That fraction subtracted from one and multiplied by 100 is the % compression. The membrane used was 20 micron 3M 825EW unsupported PFSA membrane. The cell was connected to the test stand and the following conditions were set—1000 standard cubic centimeters per minute N2 per side, 0.4 cc/min water per side and the cell setpoint temperature was set at 50 degrees C. Leads from a Solaritron 1470 multistat (Leicester England) were used to apply a voltage and measure the current. The test sequence used to test was—OCV for 15 minutes, then two loops of (a potentiodynamic scan from 0 to 0.25 volts at 5 mV/s followed by five cyclic voltammagrams of 0.25-0.5 volts at 5 mV/s then an OCV step of five minutes before looping back. The slope of the plot of voltage vs. current for the cyclic voltammagrams gave the electronic resistance which was then multiplied by the cell area yielding the electronic resistance in ohm-cm². Samples that have high electronic resistances typically showed a hysteresis with sweep direction. With the limited voltage swing and increasing hysteresis, the limit of the upper bound of test accuracy was set at 50 kohm-cm². A single electrode or electrode with embedded DTPL was cut to 5 cm². Samples with DTPLs were placed in the 5 cm² opening in the gaskets with the DTPL facing the membrane. Samples were measured to determine thickness. Gaskets were determined based on measured sample thickness to achieve a % compression of about 30%.

### Scanning Electron Microscope (SEM) Procedure

Discontinuous transport protection layer samples were cut with a scissors. A small section was removed from the larger sample and adhered to a metal stub using Nisshin Em Co. LTD. NEM carbon tape. The metal stub had a surface orthogonal to the stub base to allow for cross sections to be imaged on the edge of the cut sample. The sample adhered to the metal stub was blown gently with compressed air to remove any loose debris from the cross section to be imaged. The sample was then sputter coated with a Gold-Paladium target in a Denton Vacuum Desk IV (Denton Vacuum, Moorestown, N.J.) for 3 minutes. The cross section of the sample was imaged in a Hitachi TM 3030 tabletop Scanning Electron Microscope (SEM).

### Linear Strand Ap Measurement Procedure

An Olympus BX60 optical microscope (available from Olympus America Inc., Center Valley, Pa.) with a Leica DFC 320 camera (available from Leica Microsystems Imaging Solutions Ltd., Cambridge, UK) was used to capture an image of the Embedded Linear Polypropylene Strands on GDL 35AA with the 1.25× objective (12.5× magnification) in Bright Field. Image Pro Plus Version 6.3.0.512 software (available from Media Cybernetics, Inc., Rockville, Md.) was used to measure average line width and pitch for the Linear Polypropylene Strands. The length was measured from the leading edge of one strand to the leading edge of the third strand. This number was divided by 3 to get an average pitch of 0.983 mm. Four length measurements between the strands were summed and divided by 4 to get an average distance between strands of 0.810 mm. Dividing 0.810 mm by 0.983 mm yields the average open area of 82.4%. This leaves a covered area of 17.6% or an Ap of 0.176Ae.

### Cross Strand Ap Measurement Procedure

The Olympus BX60 optical microscope with a Leica DFC 320 camera described above, was used to capture an image of the Embedded Cross Polypropylene Strands on GDL 35AA with the 1.25× objective (12.5× magnification) in Bright Field. Image Pro Plus Version 6.3.0.512 software described above, was used to measure average line width and pitch for the Cross Polypropylene Strands. The length was measured from the leading edge of one strand to the leading edge of the 4th strand. This number was divided by 4 to get an average pitch of 0.990 mm. The overall square area repeating unit=0.990 mm×0.990 mm=0.980 mm². Three length measurements between the strands were summed and divided by 3 to get an average distance between strands of 0.754 mm. The square of 0.754 mm gives the average open size of 0.569 mm². Dividing 0.569 mm² by 0.980 mm² yields the average open area of 58.1%. This leaves a covered area of 41.9% or an Ap of 0.419Ae.

### Embedded Perforated Film Ap Calculation Procedure

Embedding of the Infiana 100 micron HDPE perforated film did not noticeably change the open area, therefore a change in basis weight before and after perforation can be used to determine open area. A 16 cm² die (available from Mathias Die Company, St. Paul, Minn.) was used to cut out a piece of Infiana 100 micron HDPE film. The same procedure was used to singulate a 16 cm² sample of the perforated 100 micron HDPE film. The mass of the as received film and perforated film were 0.1530 g and 0.0636 g respectively. The ratio of the perforated film mass to the unperforated film mass gives an Ap value of 0.416Ae.

### Embedded 11 gsm Polypropylene Nonwoven Ap Calculation

An average value for the cross-sectional area, Ap, of a nonwoven was calculated from the following equation: Ap=Mp/(Dp×Tp) where, Mp is the mass of the polymer of the nonwoven (within the given area), Dp is the density of the polymer used to form the nonwoven, Tp is the thickness of the nonwoven (within the given area).

A 5.25 inch (13.34 cm) outer diameter circle was cut from the 11 gsm polypropylene nonwoven having an area of 139.66 cm², a thickness of 13 mil (0.0330 cm), and mass of 0.17 g. The density of the polypropylene is 0.91 g/cm³. Using the above equation, Ap was calculated to be 5.66 cm² for the 139.66 cm² sample, yielding an Ap of 0.041Ae.

### Embedded 24 gsm Polypropylene Nonwoven Ap Calculation

An average value for the cross-sectional area, Ap, of a nonwoven was calculated from the following equation: Ap=Mp/(Dp×Tp) where, Mp is the mass of the polymer of the nonwoven (within the given area), Dp is the density of the polymer used to form the nonwoven, Tp is the thickness of the nonwoven (within the given area).

A 5.25 inch (13.34 cm) outer diameter circle was cut from the 24 gsm polypropylene nonwoven having an area of 139.66 cm², a thickness of 23.5 mil (0.0597 cm), and mass of 0.33 g. The density of the polypropylene is 0.91 g/cm³. Using the above equation, Ap was calculated to be 6.07 cm² for the 139.66 cm² sample, yielding an Ap of 0.043Ae.

### Embedded 9.1 Mil Wire Diameter Polypropylene Woven Ap Calculation

Embedding of the 9.1 mil (0.23 mm) wire diameter polypropylene woven did not noticeably change the open area, therefore the specification of open area provided by the vendor McMaster Carr can be used. The specified open area was 41%, which corresponds to a covered area of 59% or an Ap of 0.59Ae.

### Embedded 4.3 Mil (0.11 mm) Wire Diameter Polypropylene Woven Ap Calculation

Embedding of the 4.3 mil 0.11 mm) wire diameter polypropylene woven did not noticeably change the open area, therefore the specification of open area provided by the vendor McMaster Carr can be used. The specified open area was 34%, which corresponds to a covered area of 66% or an Ap of 0.66Ae.

### Example 1: Embedded Linear Polypropylene Strands

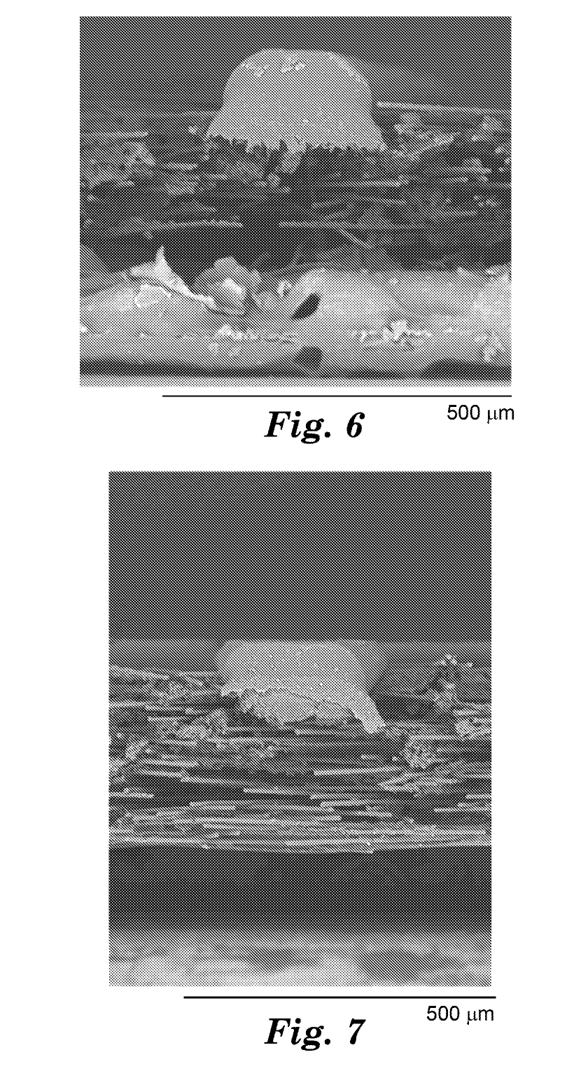

An extruder along with a nip roll assembly, 3 adjacent rolls having two nips, was used to extrude and embed strands onto a moving substrate, a porous electrode, producing linear lines along the web direction. A single screw extruder was used to extrude Polypropylene Resin 3866 (available from Total Petrochemical, Houston, Tex.) through a die with a die tip consisting of circular holes with average diameter of 0.33 mm and average spacing of 1.09 mm (center to center). The substrate GDL 35AA carbon paper was spliced into a 18 gram per square meter (gsm) Polyethylene Terepthalate (PET) spunbond nonwoven carrier web (available from Midwest Filtration LLC, Cincinnati, Ohio) with tape, so that the carrier web did not pass under the carbon substrate. Rolls 1 and 2 were heated to 450 degrees F. (232 degrees C.) and set at a ⅛ inch (3.2 mm) fixed gap, which heated the carbon paper just prior to the deposition of the polypropylene strands from the extruder. The carrier web with the spliced GDL 35AA was fed through the line at 30 ft/min (9.1 m/min). After passing through nip rolls 1 and 2, molten strands extruded from the die tip contacted GDL 35AA carbon paper. GDL 35AA with the linear strands on the surface next passed through nip rolls 2 and 3 set at a fixed gap of 12 mils (0.30 mm). Roll 3 was set 45 degrees F. (7 degrees centigrade) to cool and solidify the molten strands to form solidified strands bonded on the top surface of the GDL 35AA, thereby forming Example 1, an electrode assembly having a discontinuous transport protection layer. The interfacial region was identified by Scanning Electron Microscopy (SEM) procedure listed above. The resulting cross-sectional SEM image of the electrode assembly of Example 1 is shown in FIG. 6.

### Example 2: Embedded Cross Polypropylene Strands

Polypropylene 3866 was extruded on GDL 35AA using the same procedure as described in Example 1. The sample was then rotated 90 degrees and spliced into a 18 gram per square meter (gsm) Polyethylene Terepthalate (PET) spunbond nonwoven carrier web (available from Midwest Filtration LLC, Cincinnati, Ohio) and sent through the extrusion line using the same conditions described in Example 1 for a second pass, creating a square pattern of crossed linear strands and thereby forming Example 2, an electrode assembly having a discontinuous transport protection layer. The interfacial region was identified by Scanning Electron Microscopy (SEM) procedure listed above. The resulting cross-sectional SEM image of the electrode assembly of Example 2 is shown in FIG. 7.

### Example 3: Embedded High Density Polyethylene (HDPE) Perforated Film

A sheet of Infiana 100 micron HDPE Polyethylene was obtained from Infiana (Infiana Germany GmgH & Co. KG, Forchheim, Germany). To the 8 inch (20 cm)×11 inch (28 cm)×100 micron HDPE film, Clear Choice AT75 application tape (available from USCutter.com) was laminated on with a hand roller. A Summa Cutter D75 cutting unit (Summa Incorporated, Seattle, Wash.) was used to cut out a pattern of 60 mil (1.5 mm) diameter holes evenly spaced, in a hexagonal packing pattern. The Summa cutter cut at 6 inch/sec (15 cm/sec), 60 g K knife pressure, producing a final 100 micron HDPE perforated film with 58.5% open area.

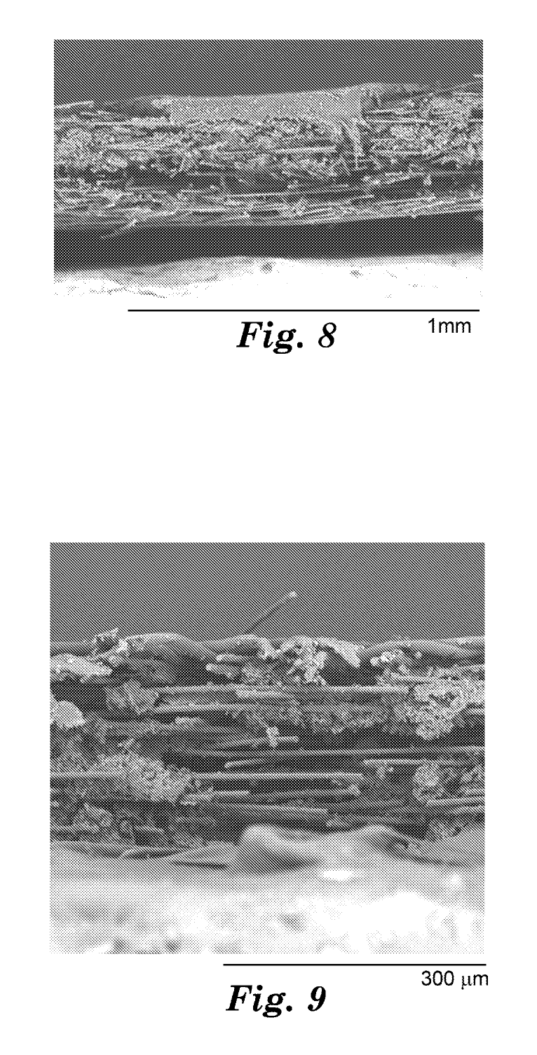

A Carver Laboratory Press Model M, serial #20506-106 (Fred S. Carver Inc, subsidiary of Sterling INC, Menomonee Falls, Wis.) was used to thermally bond the perforated film to GDL 35AA. The bottom platen in the carver press was heated to 150 degree C., the top platen was not heated and was at a temperature of 110 degree C. at the time of bonding. On the bottom platen, 8 inch (20 cm)×8 inch (20 cm)×0.85 mm thick polished steel sheet was placed. On top of that a 5 inch (13 cm)×5 inch (13 cm) piece GDL 35AA paper was placed, followed by a 3 inch (7.6 cm)×4 inch (10 cm) piece of 100 micron HDPE perforated film. On top of the perforated film was another 8 inch (20 cm)×8 inch (20 cm)×0.85 mm thick polished steel sheet. The stack was compressed in the Carver Press at 1500 pounds (680 kg) for 1.5 minutes. The polished steel sheets with the carbon paper and perforated HDPE film were removed and allowed to cool for 2 minutes. The steel sheets were then opened up, yielding the embedded 100 micron HDPE perforated film on the GDL 35AA paper, thereby forming Example 3, an electrode assembly having a discontinuous transport protection layer. The interfacial region was identified by Scanning Electron Microscopy (SEM) procedure listed above. The resulting cross-sectional SEM image of the electrode assembly of Example 3 is shown in FIG. 8.

### Example 4: Embedded Polypropylene Nonwoven 11 gsm (Grams/Square Meter)

A nonwoven web was formed using a Drilled Orifice Die. Meltblown fibers were created by a molten polymer entering the die, the flow being distributed across the width of the die in the die cavity and the polymer exiting the die through a series of orifices as filaments. A heated air stream passed through air manifolds and an air knife assembly adjacent to the series of polymer orifices that form the die exit (tip). This heated air stream was adjusted for both temperature and velocity to attenuate (draw) the polymer filaments down to the desired fiber diameter. The meltblown fibers were conveyed in this turbulent air stream towards a rotating surface where they collect to form a web.

A roll of approximately 10 inch (25.4 cm) wide nonwoven web was collected under the conditions as follows: The MF-650X polypropylene polymer (manufactured by LyondellBasell, Rotterdam, Netherlands, and commercially available through Nexeo Solutions, The Woodlands, Tex.) was extruded through a 10 inch (25.4 cm) wide drilled orifice die (DOD) at 10 lb/hr (4.5 kg/hr). The polymer melt temperature was 357 degree F. (181 degree C.). The die-to-collector distance was 14 inches (35.6 cm). Samples of the web were collected on a Unipro 200, 68 g/m² spunbond scrim (available from Midwest Filtration LLC, Cincinnati, Ohio) at 85 ft/min (25.9 m/min), the meltblown web was separated from the scrim and evaluated for effective fiber diameter (EFD) according to the method set forth in Davies, C. N., “The Separation of Airborne Dust and Particles,” Institution of Mechanical Engineers, London Proceedings 1B, 1952. The air temperature and velocity were adjusted to achieve an effective fiber diameter of 29 micrometers. The basis weight of the web was 11 grams per square meter (gsm).

A Carver Laboratory Press Model M, serial #20506-106 (Fred S. Carver Inc, subsidiary of Sterling Inc., Menomonee Falls, Wis.) was used to thermally bond the polypropylene nonwoven to SGL Sigracet GDL 35AA (SGL Carbon GmbH, Germany). The bottom platen in the carver press was heated to 140 degree C., the top platen was not heated and was at a temperature of 90 degree C. at the time of bonding. On the bottom platen 8 inch (20 cm)×8 inch (20 cm)×0.85 mm thick polished steel sheet was placed. On top of that a 4 inch (10 cm)×4 inch (10 cm) piece GDL 35AA paper was placed, followed by a 3 inch (7.6 cm)×3.75 inch (9.5 cm) piece of the 11 gsm polypropylene nonwoven. On top of the perforated film was another 8 inch (20 cm)×8 inch (20 cm)×0.85 mm thick polished steel sheet. The stack was compressed in the Carver Press at 1500 pounds (680 kg) for 30 seconds. The polished steel sheets with the carbon paper and polypropylene nonwoven between were removed from the press. The steel sheets were then opened up, yielding the embedded 11 gsm polypropylene nonwoven on the GDL 35AA paper, thereby forming Example 4, an electrode assembly having a discontinuous transport protection layer. The interfacial region was identified by Scanning Electron Microscopy (SEM) procedure listed above. The resulting cross-sectional SEM image of the electrode assembly of Example 4 is Shown in FIG. 9.

### Example 5: Embedded Polypropylene Nonwoven 24 gsm (Grams/Square Meter)

A nonwoven web was formed using a Drilled Orifice Die. Meltblown fibers were created by a molten polymer entering the die, the flow being distributed across the width of the die in the die cavity and the polymer exiting the die through a series of orifices as filaments. A heated air stream passed through air manifolds and an air knife assembly adjacent to the series of polymer orifices that form the die exit (tip). This heated air stream was adjusted for both temperature and velocity to attenuate (draw) the polymer filaments down to the desired fiber diameter. The meltblown fibers were conveyed in this turbulent air stream towards a rotating surface where they collect to form a web.

A roll of approximately 10 inch (25.4 cm) wide nonwoven web was collected under the conditions as follows: The MF-650X polypropylene polymer (manufactured by LyondellBasell and commercially available in smaller quantities through Nexeo Solutions) was extruded through a 10 inch (25.4 cm) wide drilled orifice die (DOD) (described above) at 10 lb/hr (4.5 kg/hr). The polymer melt temperature was 366 degrees F. (185 degrees C.). The die-to-collector distance was 14 inches (35.6 cm). Samples of the web were collected on a Unipro 125, 42 g/m2 spunbond scrim (available from Midwest Filtration LLC, Cincinnati, Ohio) at 40.5 ft/min (12.3 m/min), the meltblown web was separated from the scrim and evaluated for effective fiber diameter (EFD) according to the method set forth in Davies, C. N., “The Separation of Airborne Dust and Particles,” Institution of Mechanical Engineers, London Proceedings 1B, 1952. The air temperature and velocity were adjusted to achieve an effective fiber diameter of 21 microns. The basis weight of the web was 24 grams per square meter (gsm).

The 24 gsm nonwoven was bonded to GDL 35AA using the same procedure described in Example 4, thereby forming Example 5, an electrode assembly having a discontinuous transport protection layer. The nonwoven and GDL 35AA paper formed an integral structure and could not be separated by gravity or during singulation for cell resistance and cell resistance testing.

### Example 6: Embedded 9.1 Mil Wire Diameter Polypropylene Woven Mesh

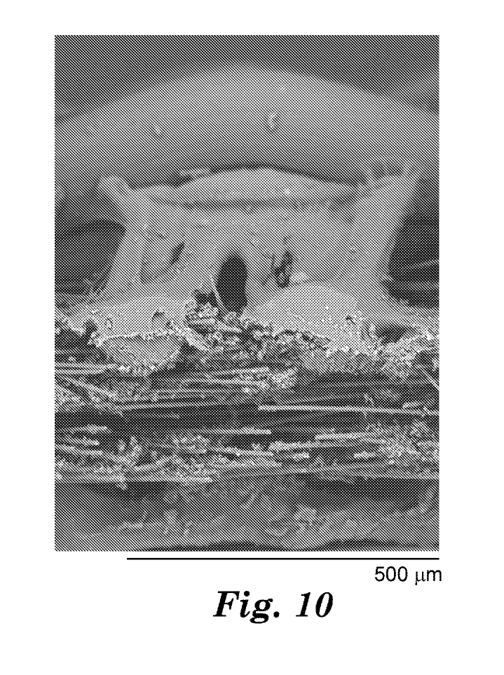

A 0.0091 inch (0.23 mm) wire diameter, 41% open area, 43×43 mesh size polypropylene woven mesh was obtained from McMaster Carr (Elmhurst, Ill.), part number 9275T39. The polypropylene woven was placed in an aluminum pan and covered with a second aluminum plan and then annealed in a Blue M Electric 146 Series Class A batch oven at 100 degree C. for 15 minutes. A Carver Laboratory Press Model M, serial #20506-106 (Fred S. Carver Inc, subsidiary of Sterling INC, Menomonee Falls, Wis.) was used to thermally bond the polypropylene woven mesh to GDL 35AA. The bottom platen in the Carver press was heated to 173 degree C., the top platen was not heated and was at a temperature of 35 degree C. at the time of bonding. On the bottom heated platen, an 8 inch (20 cm)×8 inch (20 cm)×0.85 mm thick polished steel sheet was placed. On top of that a 5 inch (13 cm)×5 inch (13 cm) piece GDL 35AA paper was placed, followed by a 3 inch (7.6 cm)×4 inch (10 cm) piece of the annealed polypropylene woven mesh. On top of the annealed woven mesh was another 8 inch (20 cm)×8 inch (20 cm)×0.85 mm thick polished steel sheet. The stack was compressed in the Carver Press at 1500 (680 kg) pounds for 1.5 minutes. The polished steel sheets with the carbon paper and polypropylene woven mesh between were removed and allowed to cool for 2 minutes. The steel sheets were then opened up, yielding the embedded polypropylene woven on the 35AA paper, thereby forming Example 6, an electrode assembly having a discontinuous transport protection layer. The interfacial region was identified by Scanning Electron Microscopy (SEM) procedure listed above. The resulting cross-sectional SEM image of the electrode assembly of Example 6 is shown in FIG. 10.

### Example 7: Embedded 4.3 mil Wire Diameter Polypropylene Woven Mesh

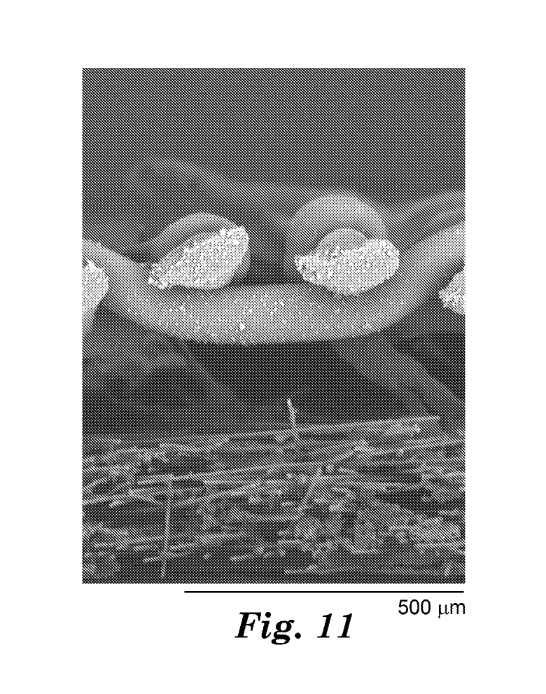

A 4.3 mil (0.11 mm) wire diameter, 8.0 mil (0.20 mm) thick, 34% open area, 98×98 mesh size polypropylene woven mesh was obtained from McMaster Carr (Elmhurst, Ill.), part number 9275T27. The polypropylene woven was bonded to GDL 35AA at points using a Weller WSD 81 Solder Iron set to 750° F. The solder iron tip was pressed down through the polypropylene woven to bond it to the GDL 35AA paper at spots spaced on average about 1 cm apart, thereby forming Example 7, an electrode assembly having a discontinuous transport protection layer. The interfacial region was identified by Scanning Electron Microscopy (SEM) procedure listed above. The resulting cross-sectional SEM image of the electrode assembly of Example 7 is shown in FIG. 11.

### Subgasketed Membrane Preparation

3M 8171 Optically clear adhesive (available from 3M, St. Paul, Minn.) with one liner removed was laminated with a hand roller to TEONEX Q83 PEN Film (Available from Dupont Teijin Films, Chester, Va.). Two pieces were die cut out of this lamination using a hand die from Mathias Die Company (St. Paul, Minn.). The die cut a 3 inch (7.6 cm)×3 inch (7.6 cm) square outer dimension and removed a 2.7 cm×2.7 cm inner square. One piece of 8171 adhesive/TEONEX Q83 PEN film, with the second liner removed, was laminated to a 20 micron 3M 825EW Supported PFSA Membrane, using a hand roller. The 3M 825EW Supported PFSA Membrane/8171/TONEX Q83 PEN Film laminate was trimmed to have an outer square dimension of 3 inches (7.6 cm) per side. The second 8171 adhesive/TEONEX Q83 PEN film (previously die cut to a 3 inch (7.6 cm)×3 inch (7.6 cm) square outer dimension and a 2.7 cm×2.7 cm inner square opening), with a liner removed, was laminated onto the 3M 825EW Supported PFSA Membrane/8171/TONEX Q83 PEN Film laminate in registration by using a hand roller to give a Subgasketed Membrane consisting of TEONEX Q83 PEN Film/8171/3M 825EW Supported PFSA Membrane/8171/TEONEX Q83 PEN Film.

### Example 8: Membrane Electrode Assembly Containing Embedded Polypropylene Nonwoven 24 gsm (Grams/Square Meter) with Perimeter Adhesive

Hand dies from Mathias Die Company (St. Paul, Minn.) were used to cut the following materials in the layup below. The dies contained 2 small holes for alignment pins, one on an opposite side from the other, outside the active area. The alignment holes were used to align the PTFE glass fiber composite gasket, Infiana 100 micron LDPE, and Subgasketed Membrane. Electrode and transport protection materials were aligned in the center cut out windows of the Subgasketed Membrane and Infiana 100 micron LDPE. The following layup was prepared:
6 inch (15.2 cm)×6 inch (15.2 cm)×⅛ inch (0.32 cm) steel sheet with alignment pins.
4 inch (10.2 cm)×4 inch (10.2 cm) polyimide sheet 2 mil (0.051 mm) DuPont Kapton HN (available from DuPont High Performance Films, Circleville, Ohio)) with alignment holes.
1 piece of 8.2 mil (0.21 mm) PTFE glass fiber composite gasket material (available from Nott Company, Arden Hills, Minn.) (outer dimension 3 inch (7.6 cm) square, inner dimension 2.7 cm×2.7 cm).
1 piece of Embedded Polypropylene Nonwoven 24 gsm in GDL 35AA (as described in Example 5) 2.7 cm×2.7 cm placed in the cut out center of the Subgasketed Membrane with the nonwoven facing the membrane.
1 piece of Infiana 100 micron LDPE (outer dimension 3 inch (7.6 cm) square, inner opening of 2.25 cm×2.25 cm).
1 Subgasketed Membrane.
1 piece of Infiana 100 micron LDPE (outer dimension 3 inch square, inner opening of 2.25 cm×2.25 cm).
1 piece of Embedded Polypropylene Nonwoven 24 gsm in GDL 35AA (as described in Example 5) 2.7 cm×2.7 cm placed in the cut out center of the gasket with the nonwoven facing the membrane.
1 piece of 8.2 mil (0.21 mm) PTFE glass fiber composite gasket material (available from Nott Company, Arden Hills, Minn.) (outer dimension 3 inch square (7.6 cm), inner dimension 2.7 cm×2.7 cm).
4 inch (10.2 cm)×4 inch (10.2 cm)×2.0 mil (0.051 mm) polyimide sheet with alignment holes.
6 inch (15.2 cm)×6 inch (15.2 cm)×⅛ inch (0.32 cm) steel sheet with alignment pins.

This layup was placed in a Carver Press Model 2518 (available from Fred S. Carver Inc, Wabash Ind.) at 240 degrees Fahrenheit (116 degrees centigrade). The layup was placed under 1500 lb (680 kg), which decayed to 600 lb (272 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling the steel plates, polyimide, and PTFE glass fiber composite gasket materials were removed from each side of the layup. This yielded the Membrane Electrode Assembly Containing Embedded Polypropylene Nonwoven 24 gsm (grams/square meter) with Perimeter Adhesive as an integral structure.

The sample was placed in a cell and tested as described by the Electrochemical Cell Test Procedure above except: The test cell was assembled as follows. The Membrane Electrode Assembly Containing Embedded Polypropylene Nonwoven 24 gsm (grams/square meter) with Perimeter Adhesive was placed on the graphite bipolar plates. The test cell was then placed between two aluminum end plates with current collectors and secured with a series of 8 bolts that are tightened to 110 lbf·in (12.4 N·m).

### Example 9: Membrane Electrode Assembly Containing Embedded Linear Polypropylene Strands with Perimeter Adhesive

The same layup described in Example 8 was used here with the following modification: the Embedded Linear Polypropylene Strands sample described in Example 1 was die cut to 2.7 cm×2.7 cm and replaced the 2.7 cm×2.7 cm Embedded Polypropylene Nonwoven 24 gsm in GDL 35AA. The Embedded Linear Polypropylene strands in GDL 35AA was placed in the layup on both sides of the membrane with the polypropylene strands facing the membrane.

This layup was placed in a Carver Press Model 2518 (available from Fred S. Carver Inc, Wabash Ind.) at 240 degrees Fahrenheit (116 degrees centigrade). The layup was placed under 1500 lb (680 N), which decayed to 600 lb (272 kg) during the 5 minute dwell time. After 5 minutes the sample was removed and placed between two 12 inch (30.5 cm)×18 inch (45.7 cm)×1 inch (2.5 cm) metal sheets at room temperature to cool for 2 minutes. After cooling the steel plates, polyimide, and PTFE glass fiber composite gasket materials were removed from each side of the layup. This yielded the Membrane Electrode Assembly Containing Embedded Linear Polypropylene Strands with Perimeter Adhesive as an integral structure.

### Comparative Example A (CE-A)

CE-A was GDL 35AA without a discontinuous transport protection layer.

### Comparative Example B (CE-B)

CE-B was a single layer GDL 35AA without a discontinuous transport protection layer. The Electrochemical Cell Test Procedure was used with the following modifications: in the cell assembly 1.9 mil (0.048 mm) and 5.2 mil (132 mm) (7.1 mil (0.180 mm) total thickness) thick pieces of PTFE glass fiber composite gasket material (available from Nott Company, Arden Hills, Minn.) were used on each side of the membrane. A single layer of GDL 35AA was used on each side of the membrane. The rest of the procedure remained the same yielding Cell Resistance Results in Table 1.

### Cell Resistance Results

The electrode assemblies of Examples 1-5, 7 and 8 were used to fabricate liquid flow electrochemical cells, per the Electrochemical Cell procedures described above (see exception for Example 8 and Comparative Example B). For Examples 1-5, 7, and CE-A a 50 micron 3M 825EW unsupported PFSA membrane was used. For Example 8 and CE-B a 20 micron 3M 825EW Supported PFSA Membrane was used. CE-B and Example 8 used 1 GDL 35AA per side of the membrane whereas Examples 1-5, 7, and CE-A use 2 GDL 35AA's per side of the membrane. Cell Resistance was measured as outlined in those same procedures and is presented in Table 1 below. For Example 1, the linear strands were oriented perpendicular to the serpentine flow fields, with the strands facing the membrane.

TABLE 1
Cell Resistance Results.

| | Total Cell Resistance |
|---|---|
| Sample | (Ohm-cm²) |
| CE-A | 0.679 |
| CE-B | 1.695 |
| Example 1 | 1.335 |
| Example 2 | 1.212 |
| Example 3 | 2.2425 |
| Example 4 | 0.898 |
| Example 5 | 0.754 |
| Example 7 | 0.898 |
| Example 8 | 2.000 |

Sample thickness, gaskets, compression, and short resistance are listed in Table 2 below for the Examples and Comparative Example. For Example 1, the linear strands were oriented perpendicular to the serpentine flow fields, with the strands facing the membrane. Ap values were determined as described in the test methods and are listed in Table 2.

TABLE 2
Short Resistance Results.

| | | Measured | Gasket | Com- | Short |
|---|---|---|---|---|---|
| | | Thickness | Thickness | pres- | Resistance |
| | | mil | mil | sion | (Ohm- |
| Sample | Ap | (mm) | (mm) | (%) | cm²) |
| CE-A | — | 9.8 (0.249) | 6.3 (0.160) | 35 | 129 |
| Example 1 | 0.176Ae | 11.4 (0.290) | 8.1 (0.206) | 29 | >50,000 |
| Example 2 | 0.419Ae | 11.4 (0.290) | 8.1 (0.206) | 29 | >50,000 |
| Example 3 | 0.416Ae | 12.3 (0.312) | 9.2 (0.234) | 25 | >50,000 |
| Example 4 | 0.041Ae | 9.8 (0.249) | 7.2 (0.183) | 27 | >50,000 |
| Example 5 | 0.043Ae | 10.8 (0.247) | 8.2 (0.208) | 24 | >50,000 |
| Example 7 | 0.66Ae | 16.9 (0.429) | 12.4 (0.315) | 27 | >50,000 |

1. An electrode assembly comprising:
a porous electrode having a first major surface with a first surface area, Ae, an opposed second major surface and a plurality of voids;
a discontinuous transport protection layer disposed on the first major surface and having a cross-sectional area, Ap, substantially parallel to the first major surface, wherein the discontinuous transport protection layer comprises a hydrophilic polymer, and wherein the discontinuous transport protection layer is non-electrically conductive; and
an interfacial region wherein the interfacial region includes a portion of the polymer embedded in at least a portion of the plurality of voids, a portion of the porous electrode embedded in a portion of the polymer, or a combination thereof;
wherein 0.02Ae≤Ap≤0.85Ae,
wherein the porous electrode and discontinuous transport protection layer form an integral structure; and
wherein the discontinuous transport protection layer has a thickness Tp, the interfacial region has a thickness Ti, and the ratio Ti/Tp is from about 0.005 to about 0.8.

2. The electrode assembly according to claim 1, wherein the plurality of voids enable fluid communication between at least a portion of the first major surface and opposed second major surface of the porous electrode.

3. (canceled)

4. The electrode assembly according to claim 1, wherein 0.02Ae≤Ap≤0.5Ae.

5. The electrode assembly according to claim 1, wherein 0.02Ae≤Ap≤0.3Ae.

6. (canceled)

7. The electrode assembly according to claim 1, wherein the discontinuous transport protection layer comprises at least one of a plurality of discrete structures, a mesh structure, a woven structure and a nonwoven structure.

8. The electrode assembly according to claim 1, wherein the discontinuous transport protection layer comprises a plurality of discrete structures.

9. The electrode assembly according to claim 8, wherein the plurality of discrete structures have a thickness from about 0.050 micron to about 3000 microns.

10. The electrode assembly according to claim 8, wherein the plurality of discrete structures are in a pattern.

11. The electrode assembly according to claim 8, wherein the plurality of discrete structures includes a plurality of non-intersecting, continuous lines.

12. The electrode assembly according to claim 11, wherein the plurality of non-intersecting, continuous lines are straight lines.

13. The electrode assembly according to claim 11, wherein the plurality of non-intersecting, continuous lines have a pitch from about 0.3 mm to about 11 mm.

14. The electrode assembly according to claim 11, wherein the plurality of non-intersecting, continuous lines have a width from about 0.01 mm to about 10 mm.

15. The electrode assembly according to claim 11, wherein the plurality of non-intersecting, continuous lines are substantially parallel over a length scale of from about 2 cm to about the length of the porous electrode.

16. The electrode assembly according to claim 8, wherein the plurality of discrete structures have a longest dimension from about 10 microns to about 5000 microns.

17. The electrode assembly according to claim 1, wherein the discontinuous transport protection layer comprises at least one of a mesh structure, woven structure and nonwoven structure.

18-24. (canceled)

25. The electrode assembly according to claim 1, wherein the discontinuous transport protection layer further comprises a hydrophilic coating.

26-38. (canceled)

39. A membrane-electrode assembly comprising:
a first electrode assembly according to claim 1; and
an ion permeable membrane, having a first surface and an opposed second surface, disposed adjacent to or on the major surface of the discontinuous transport protection layer opposite the interfacial region; and
wherein the first electrode assembly and the ion permeable membrane form an integral structure.

40. The membrane electrode assembly of claim 39, further comprising a first adhesive layer disposed between the ion permeable membrane and at least one of the porous electrode and the discontinuous transport protection layer of the first electrode assembly, wherein the first adhesive layer is disposed along the perimeter of the membrane-electrode assembly.

41. The membrane electrode assembly of claim 40, wherein the first adhesive layer is in the shape of an annulus or is two discrete adhesive lines on opposite sides of the membrane-electrode assembly perimeter.

42. The membrane-electrode assembly according to claim 40, wherein the first adhesive layer is in contact with the first surface of the ion permeable membrane and the discontinuous transport protection layer of the first electrode assembly.

43-53. (canceled)

54. An electrochemical cell comprising the electrode assembly of claim 1.

55-57. (canceled)
